(19) United States
(12) Patent Application Publication
(10) Pub. No.: US 2013/0162136 A1
(43) Pub. Date: Jun. 27, 2013

(54) ARC DEVICES AND MOVING ARC COUPLES

(71) Applicants: David A. Baldwin, Annandale, VA (US); Kevin L. Brown, Reston, VA (US); Carson R.L. Brown, Reston, VA (US)

(72) Inventors: David A. Baldwin, Annandale, VA (US); Kevin L. Brown, Reston, VA (US); Carson R.L. Brown, Reston, VA (US)

(21) Appl. No.: 13/655,373

(22) Filed: Oct. 18, 2012

Related U.S. Application Data
(60) Provisional application No. 61/548,455, filed on Oct. 18, 2011.
(60) Provisional application No. 61/577,977, filed on Dec. 20, 2011.

(51) Int. Cl. H01J 1/02

(52) U.S. Cl. CPC H01J 1/02
USPC 313/311

(57) ABSTRACT

An apparatus for a first electrode and a second electrode. The first and second electrode support an arc that conducts electric current between the first and second electrode. A shape of at least one of the first and second electrode, after an arc is established between the first and second electrode, expand at least one of an arc footprint of the arc on at least one of the first and second electrode and an arc column of the arc between the first and second electrode as the electric current between the first and second electrode increases.

### RELATED CASES

This application claims the benefit of U.S. Provisional Application No. 61/548,455, filed on 18 Oct. 2011, by Baldwin et al., entitled Metal Vapor Arc Switch and Moving Electrical Contact for Electrical Energy Transfer, and U.S. Provisional Application No. 61/577,977, filed on 20 Dec. 2011, by Baldwin et al., entitled Arc Conductors, Arc-Assisted and Arc-Mediated Switches and Switching, the contents of which are all incorporated by reference.

### BACKGROUND

The transfer of large amounts of, e.g., electrical energy, quickly may be desirable in a number of applications, for instance, as the technology for storage of large amounts of electrical energy improves. General non-limiting examples of applications may include, the transfer of electrical energy from one storage element (e.g., capacitor) to another, from a storage element to vehicle, from a storage element to a moving vehicle, from a storage element to a munition, from a storage element to a projectile launcher, from a storage element to a pulsed laser and from a storage element to other types of electromagnet, acoustic and mechanical transducers and actuators. Known devices, e.g., switches, such as high-current electrical switches, relays, contactors, circuit breakers and the like may be used, at least in part, to implement the above-noted applications. However, use of such devices may be problematic.

### SUMMARY OF DISCLOSURE

In at least one implementation, an apparatus comprises a first electrode and a second electrode. The first and second electrode are configured to support an arc that conducts electric current between the first and second electrode. A shape of at least one of the first and second electrode is configured to, after an arc is established between the first and second electrode, expand at least one of an arc footprint of the arc on at least one of the first and second electrode and an arc column of the arc between the first and second electrode as the electric current between the first and second electrode increases.

One or more of the following features may be included. The shape of at least one of the first and second electrode may be further configured to decrease a self-current magnetic constriction of the arc column. The shape of at least one of the first and second electrode may be further configured to change shape in one or more regions to modify a degree of the self-current magnetic constriction of the arc column. The shape of at least one of the first and second electrode may be further configured to contract the arc footprint of the arc and the arc column as the electric current between the first and second electrode decreases.

The shape of at least one of the first and second electrode, after the arc is established between the first and second electrode, may be further configured to provide a voltage between the first and second electrode of less than or equal to 50 volts, when time-averaged over a period of time. The voltage between the first and second electrode may be configured to decrease, at least in part, based upon a design parameter of at least one of the first and second electrode, wherein the design parameter of at least one of the first and second electrode may include an arc-enhancing material. The shape of least one of the first and second electrode may be further configured to define an arc gap, at least in part, as including a ratio of an area of at least one of the first and second electrode to an average arc gap distance.

The shape of at least one of the first and second electrode may be further configured to sustain continuously over a period of time, after the arc is established between the first and second electrode, the expansion of the arc footprint and arc column, wherein the expansion of the arc footprint and arc column may exclude at least one of pulsation to zero current, chopping, flicker to zero current, spark instability, plasma extinction and re-ignition, fluctuation to zero current and any time-domain instability of the arc involving the electrical current between the first and second electrode becoming zero. The shape of at least one of the first and second electrode may be further configured to sustain continuously over a period of time, after the arc is established between the first and second electrode, contraction of the arc footprint and arc column, wherein the contraction of the arc footprint and arc column may exclude at least one of pulsation to zero current, chopping, flicker to zero current, spark instability, plasma extinction and re-ignition, fluctuation to zero current and any time-domain instability of the arc involving the electrical current between the first and second electrode becoming zero.

The shape of at least one of the first and second electrode may be defined, at least in part, by an area of at least one of the first and second electrode upon which at least one of the first and second electrode supports the footprint of the arc column, wherein the area may determine a maximum arc current of the electric current between the first and second electrode that at least one of the first and second electrode supports, and wherein the maximum arc current may be determined, at least in part, by a ratio of the arc current to the area, wherein the ratio of the arc current to the area may include the arc current density Φ_{arc}. The value of Φ_{arc} may be adjusted by a design parameter of at least one of the first and second electrode, wherein the design parameter of at least one of the first and second electrode may include an arc-enhancing material.

The arc may include at least one of a non-thermionic cathode arc, a cold-cathode arc, a metal vapor arc, a cathodic arc, and an arc including at least 10% of atoms and ions originating from at least one of the first and second electrode. An arc gap between the first and second electrode may include a location at which a length of the arc gap is shortest. An arc gap between the first and second electrode may include the arc column, and the arc column may be at least one of completely-filled and densely-filled with plasma after the expansion of the arc footprint and the arc column. An arc gap between the first and second electrode may include the arc column, and the expanding arc footprint and arc column may move within the arc gap and may create one or more regions which formerly had plasma and then lack plasma, and within which the arc may no longer burn. The electric current between the first and second electrode may be configured to decrease towards zero in response to the moving arc column being expelled from the arc gap. An arc gap between the first and second electrode may be included, wherein a length of the arc gap may be shortest near a location of arc ignition and the length increases with lateral distance away from the location of arc ignition.

At least one of the first and second electrode may be further configured to move within a predetermined proximity relative to one another to conduct electric current. A position of at least one of the first and second electrode may be fixed. At least one of the first and second electrode may include an arc-enhancing material. The arc-enhancing material may be configured to burn one or more arc spots in one or more predetermined locations. The arc enhancing material may include at least one of Mg, Se, Zn, Cd, In, Sn, Sb, Sm, Yb, Pb, Bi, Li, Na, K, Rb, and Cs. The shape of at least one of the first and second electrode may be further configured to collect at least a first portion of the arc-enhancing material when vaporized, and may be further configured to re-apply at least a second portion of the arc-enhancing material back to at least one of the first and second electrode. At least one of an arc striker and an arc igniter may be included and configured to replenish the arc-enhancing material.

One or more structures may be included and configured to at least one of limit influence of atmospheric air upon the arc, capture an arc burning material when vaporized, retain heat from arc discharge, shield one or more surroundings of the arc from gases and radiation generated from the arc, reduce acoustic noise from the arc, and quench arc plasma in response to the expanding arc column when the expanding arc column expels from the arc gap. One or more design parameters may be included and configured to adjust a rate-of-rise of the electric current between the first and second electrode after the arc is established between the first and second electrode. The expansion may include at least one arc front of the arc column that propagates from a location of arc ignition in at least one direction into the arc gap and away from the location of arc ignition. The design parameter of at least one of the first and second electrode may include an arc-enhancing material.

The details of one or more implementations are set forth in the accompanying drawings and the description below. Other features and advantages will become apparent from the description, the drawings, and the claims.

### BRIEF DESCRIPTION OF THE DRAWINGS

FIG. 1 illustratively shows the various example regimes of electrical discharges according to one or more implementations of the present disclosure;

FIG. 2 illustratively shows surface and plasma features of cold cathode arc spots according to one or more implementations of the present disclosure;

FIG. 3 illustratively shows two photographs in side-view of cathodic arcing between two copper electrodes according to one or more implementations of the present disclosure;

FIG. 3A illustratively shows a lower arc current of 2000 amperes (A) according to one or more implementations of the present disclosure;

FIG. 3B illustratively shows a higher arc current of 4000 A according to one or more implementations of the present disclosure;

FIG. 4A illustratively shows a plot of calculated arc resistance and power consumed in an arc and in a solid-solid contact junction as a function of current transferred according to one or more implementations of the present disclosure;

FIG. 4B illustratively shows a plot of FIG. 4A with alternate scales on the plot axes according to one or more implementations of the present disclosure;

FIG. 5A illustratively shows a plot of maximum tolerable surge current and surge current duration for a semiconductor switch (sold state relay) according to one or more implementations of the present disclosure;

FIG. 5B illustratively shows a mechanical outline drawing of mechanical solid-solid contact switch components damaged by surge currents and contact sparking or arcing according to one or more implementations of the present disclosure;

FIG. 6A illustratively shows a conceptual diagram showing atomic particle transport processes in the near-cathode arc plasma column of a high-pressure arc with non-thermionic cathode according to one or more implementations of the present disclosure;

FIG. 6B illustratively shows a conceptual diagram showing general regions of and voltage variations within an arc plasma column of a high-pressure arc with non-thermionic cathode according to one or more implementations of the present disclosure;

FIG. 7 illustratively shows a plot of measured and calculated material cohesive energy and cold-cathode arc burning voltage for chemical elements of various atomic number Z according to one or more implementations of the present disclosure;

FIG. 8A illustratively shows a mechanical semi-perspective drawing of an arc conductor switch according to one or more implementations of the present disclosure;

FIG. 8B illustratively shows a conceptual illustration of arc plasma filling of the arc gap of the device of FIG. 8A according to one or more implementations of the present disclosure;

FIG. 9 illustratively shows a version of the switch of FIG. 8A in which another curvature of the electrodes has been introduced according to one or more implementations of the present disclosure;

FIG. 10A illustratively shows a version of the switch of FIG. 8A in which a plasma quenching baffle structure has been introduced according to one or more implementations of the present disclosure;

FIG. 10B illustratively shows a conceptual illustration of arc plasma moving in the arc gap of the device of FIG. 10A according to one or more implementations of the present disclosure;

FIG. 11A illustratively shows a perspective drawing of arc electrodes of an arc conductor according to one or more implementations of the present disclosure;

FIG. 11B illustratively shows a perspective drawing of arc electrodes of an arc conductor according to one or more implementations of the present disclosure;

FIGS. 12A, 12B and 12C illustratively show simplified section drawings of an arc conductor switch depicting a rotatable inner arc electrode assembly in three different angular positions according to one or more implementations of the present disclosure;

FIG. 13A illustratively shows a simplified section drawing, on a different plane, of the arc conductor switch of FIG. 12 depicting rotatable inner arc electrode assembly in one angular position and schematically depicting an electrical circuit of which the switch is a component according to one or more implementations of the present disclosure;

FIG. 13B illustratively shows a simplified section drawing, on a different plane, of a portion of the arc conductor switch of FIG. 13A;

FIG. 14 illustratively shows a mechanical cut-away drawing in perspective of the device of FIG. 12 and FIG. 13 according to one or more implementations of the present disclosure;

FIG. 15A illustratively shows a simplified section drawing of the arc conductor switch of FIGS. 12, 13 and 14 configured as a switch assistor according to one or more implementations of the present disclosure;

FIG. 15B illustratively shows a simplified section drawing of the arc conductor switch of FIGS. 12, 13 and 14 configured as a switch assistor according to one or more implementations of the present disclosure;

FIG. 16 illustratively shows a multi-part electrical schematic and mechanical symbolic drawing depicting several states and operational steps of the arc conductor switch of FIGS. 13, 14 and 15 according to one or more implementations of the present disclosure;

FIGS. 17A, 17B, and 17C illustratively show mechanical drawings depicting construction details of the variable resistor of the second arc conductor switch of FIGS. 13, 14, 15 and 16 according to one or more implementations of the present disclosure;

FIG. 18 illustratively shows a simplified conceptual electrical schematic diagram of charge transfer from one capacitor to another through two switches according to one or more implementations of the present disclosure;

FIG. 19 illustratively shows a mechanical semi-schematic diagram of an example implementation of a plurality of switches utilized to transfer charge from capacitors in a charging station to capacitors in a vehicle according to one or more implementations of the present disclosure;

FIG. 20 illustratively shows a detailed cross-section drawing of two of the switches shown in FIG. 19 according to one or more implementations of the present disclosure;

FIG. 21 illustratively shows a side-view cross-section drawing of one of the switches shown in FIG. 20 according to one or more implementations of the present disclosure;

FIG. 22 illustratively shows a detailed view of an arc initiator or striker according to one or more implementations of the present disclosure;

FIG. 23 illustratively shows a side view of a moving locomotive being charged while moving at high speed through a charging station using switches according to one or more implementations of the present disclosure;

FIG. 24 illustratively shows a detailed cross-section drawing of a high-current version of a switch according to one or more implementations of the present disclosure;

FIG. 25 illustratively shows a side-view of a moving automobile being charged while moving at high speed through a charging station using switches according to one or more implementations of the present disclosure;

FIG. 26 illustratively shows a detailed cross-section drawing of a pair of switches utilized in FIG. 25 according to one or more implementations of the present disclosure; and

FIG. 27 illustratively shows an electrical schematic and mechanical symbolic drawing depicting an arc conductor switch configured for use in alternating current (AC) circuits according to one or more implementations of the present disclosure.

Like reference symbols in the various drawings indicate like elements.

### DETAILED DESCRIPTION OF ONE OR MORE IMPLEMENTATIONS

### System Overview:

As noted above, the transfer of large amounts of, e.g., electrical energy, quickly may be desirable in a number of applications, for instance, as the technology for storage of large amounts of electrical energy improves. Example quantities of electrical energy may range from, e.g., ˜0.1 Joule [J] to 10 gigajoules [GJ] and higher. Example time scales for electrical energy transfer may range from, e.g., 10 seconds [s] to sub-microseconds [μs]. Capacitors may be fabricated that can store, e.g., 1 MJ to 1 GJ and larger amounts of electrical potential energy at, e.g., 1000 to 10,000 volts and higher across the plates of the capacitor and contain charge separations of, e.g., 10³, 10⁶ and higher coulombs [C] within capacitors that are small and light enough to be carried on board heavy wheeled vehicles, ships, trains and the like and also may be located at terrestrial stations. This scale of stored electrical energy may be used for propulsion of the above-noted vehicles over a time period of hours or days and for operational work. For the above-noted applications, it may be beneficial to charge or re-charge such energy-storage capacitors in the shortest time possible, preferably seconds or less than 1 second.

In some implementations, the present disclosure may be directed to rapid charging of energy-storage capacitors (the “target” capacitors) in vehicles and devices that may use the energy from a “source” capacitor, magnetically charged inductor, inertial flywheel/generator or other form of electrical energy storage element. In those examples, the quantity of electrical energy to be sent from the source storage element and the quantity of energy that may be received by the target capacitor may be limited, but large (e.g., MJ, GJ or larger). Though the energy may be limited, rather large electrical currents on the order of, e.g., kilo-amperes (kA) to mega-amperes (MA) and higher may be necessary to transfer the energy in the desired time periods. In the above-noted example applications, temporary electric current conductors, switches, contactors, moving electrical couples and the like may be used that can safely and controllably conduct kA, MA and larger electrical currents for short periods of time, for example, less than 10 seconds. Repetitive use of these temporary electric current conductors, switches, contactors, moving electrical couples over a long life may be desired.

As noted above, known switches such as high-current electrical switches, relays, contactors, circuit breakers and the like may be problematic as concerns contact arcing may occur between the switch contacts or movable make/break terminals of the device. Additionally, contact-arcing between switch contacts may be troublesome upon opening (e.g., breaking) or closing (e.g., making) of the switch contacts. As is sometimes used when generally discussing switches, the terms “arc” and “contact arc” are ill-defined and may erroneously refer to a spark, a flash of light, an audible click or snap, a very hot region, an ionized gas, and various forms of metal vapor plasmas.

A family of devices related to switches may involve sliding contacts for electrical current, particularly ones in which the contacts may be brought into and out of touching, mechanical contact as part of routine use. Sliding contacts may have components such as brushes, slip rings, commutators, wipers, shoes, rails, tracks, fingers, sliders, electrodes (e.g., one or more anodes and/or one or more cathodes) and the like. For example, sliding contacts used with electric trains and trolleys may have catenary wire, pantograph slider and third rail/shoe type components. Another example family of devices related to switches may involve rolling contacts for electrical current. In addition to circuit make/break arcs, sliding and rolling electrical contacts may experience inter-contact arcs due to, e.g., contact bounce, vibration, surface imperfections (e.g., roughness), contamination, wear dust/debris and other causes. Sliding and rolling contacts may be included when the term “switch” is used herein, unless suggested otherwise by context.

Temporary surge or in-rush currents may occur when electrical switches make contact between, e.g., a high-energy, low-internal-impedance electrical source, such as a capacitor, and a low-impedance load that may draw current from the source. In-rush currents may also be encountered with source and load circuit elements other than capacitors, such as, e.g., large inductors during field build-up or collapse, filaments or glow bars before heating to high temperature (and thus high electrical resistance), motors starting up, dumping of energy from inertial storage devices and so forth. In-rush current may be desired or acceptable in the circuit served by the switch but may damage the switch. Damage to a switch may also occur due, e.g., to high voltage transients during or related to switching. A frequent cause of high voltage transients may be a rapid change of current I through an inductor of inductance L. A voltage V_{induct}(t)=−L(dI/dt) may be superimposed upon any other voltage across the inductor and also be added to voltages at other nodes in the overall circuit. Thus, a switch in series with the inductor may experience a high reverse voltage when the switch is closing (dI/dt>0) or may experience a high forward voltage when the switch is opening (dI/dt<0). When the moving contacts of a switch are in partial contact but not fully engaged, as concerns mating surface area and/or contact force, a high resistance condition may exist while some or all of the current flowing across the contact junction is concentrated in a small cross-sectional area. This may cause localized heating on contact surfaces which may lead to evaporation or migration of contact material or coatings, plasma ignition, sparking, cold cathode arcing, high voltage arcing (arc flash), loss of temper of the contact metal and other damaging phenomena. Generally, contact arcs in switches and moving contacts may be considered detrimental and to be avoided or mitigated, if unavoidable. Contact arcs may be detrimental because, among other reasons, they may consume (waste) electrical energy, they may dump electrical energy as destructive heat, they may pit or roughen the surface of the contacts (e.g., leading to higher contact resistance), they may erode the contacts (e.g., shortening operational life), they may punch through a coating on the contacts, they may melt contact, rail or shoe surfaces, they may weld contacts together, they may generate contamination/debris, they may generate electromagnetic interference (EMI) or radio-frequency interference (RFI), and they may be a source of ignition. Contact arcs may more severe of a problem the higher the current to be forced through the switch or moving contact. Damage to the switch may be more severe if the circuit voltage across the open switch is high, such as, e.g., thousands or tens of thousands of volts or more. Such issues may go beyond the capability of practical, economical known switches in circuits allowing kilo-ampere (kA) to more than mega-ampere (MA) currents with high open-circuit voltages, such as thousands or tens of thousands of volts or more, where current surge or voltage spike conditions may persist for hundreds of microseconds to tens of seconds. In these cases, the total charge transferred in a pulse (=current×time duration) may range from, e.g., 0.1 to 1×10⁷ coulombs [C], while the total energy available in a pulse (=voltage×current×time duration) may range from, e.g., 100 to 1×10¹¹ joules [J]. While it may be beneficial to transfer this energy from source to load with as small as possible losses in the switch, even small fractions of such large magnitudes of energy dissipated in a switch may be destructive for most types of available, practical switches. Another issue, in addition to avoidance of destruction, may be providing for repetitive conduction of such pulses or surges over a long device or switch lifetime.

Some techniques may exist aimed at eliminating or mitigating contact-arcing in mechanical switchgear and in sliding/rolling contact couples. Some techniques may aim towards tolerating localized heating on contact surfaces and eliminating or mitigating contact arcs in mechanical switch gear. Switchgear with metallic contacts may be beneficial for high-current circuits having prolonged (e.g., >10 seconds) current-on durations, due to the low on-resistance achieved. Thus, previous techniques focus on the anti-arcing properties of metallic contacts. Contact materials may vary regarding their minimum voltage or current required to generate a contact arc, so choices may be made to keep circuit parameters below those values and avoid contact arcs altogether in some circumstances.

In some implementations, a snubber resistor-capacitor (R-C) network may be placed across the contacts of a switch. Upon opening the contacts, the capacitor may slow the voltage rise across separating contacts, thus limiting a rate of heating the contacts. Upon closing the switch, the charged-up capacitor may do only harm, increasing the current magnitude through the mating contacts, so a resistor may be added to limit this effect (which may also degrade the switch-opening benefit). While careful selection of contact material and snubber components may bring a marginal case within the non-arcing or mild-arcing range of available contact materials, thus giving a long-lifetime benefit, the present disclosure may in some implementations concern voltages and currents above such thresholds for known materials. Other fields may handle or prevent catastrophic, destructive electrical energy release, sometimes called “arcing” but actually a complex set of phenomena. Thus, arc-protection switches, vacuum interrupters, arc eliminators, shunts and so forth exist that may work in spite of such arcs inside the switches. Some techniques may use a high-speed moving slug or bullet to close the contacts of a shunt or crowbar switch. Most interrupter and shunt devices are intended for infrequent use (e.g., not for routine make/break cycling). Another known technique is to shunt a mechanical switch with a semiconductor device during making or breaking of the switch contacts. While such techniques may operate repetitively either making or breaking a circuit, typically a reasonably-sized semiconductor solid-state switch may not survive very high power switching, such as, e.g., MJ or GJ energy transfers, e.g., kilo-ampere (kA) to more than mega-ampere (MA) currents, depending upon the voltage at which the electrical energy is stored and the time duration of current flow.

For example, some of the above-noted devices may be designed for 350 volts or less. Higher voltage semiconductor switches may require higher on-resistance or forward-conducting voltage drop and may be undesirable for surge currents in the aforementioned range for all but the briefest pulses (e.g., <<1 s), so they may not transfer the quantities of energy desired. In the field of sliding contacts, some techniques may use a brush contact made of bundles of, e.g., 40 μm diameter cadmium bronze wires, the ends of which may rub along a solid ring or track counter-electrode. Such a device may eliminate contact arcs due to bounce, vibration or surface roughness during sliding, due to the multiplicity of small, spring-loaded points of contact, but may not provide sufficient current-carrying capacity upon gross making or breaking of an energized circuit. As another example, some techniques may use an electrically-conductive lubricant on sliding contacts. No contact arcs may be observed up to contact current densities of 200 A/cm² (2×10⁶ A/m²), but gross making/breaking of the energized circuit may not be attempted, and such current densities may imply large (e.g., ˜1 m×1 m) contact area for 1 MA currents. Other techniques may use liquid metals as the electrical contact medium in sliding contacts for, e.g., rail guns, but with keeping the liquid metal in place, it may give rise to repeatability and lifetime limitations.

Semiconductor and solid-state switching devices also may be damaged by high surge currents and high transient voltages during or related to connecting and disconnecting high-voltage, high-current sources to/from the types of loads mentioned above. In some implementations, the terms “switch”, “switch-gear” and similar may include semiconductor switching and regulating devices such as transistors, triacs, thyristors, solidtrons and the like, unless suggested otherwise by the context. Typically, a semiconductor junction may be in a state of partial conduction and with full circuit voltage across it during turn-on or turn-off, where large power may be dissipated transiently. Damage to semiconductor junctions may be due to, e.g., overheating, electromigration of dopants, breakdown of insulating layers and other mechanisms rather than contact arcs, but similar limitations to those encountered in mechanical switches may occur with semiconductor switching devices. Semiconductor junctions may not achieve as low values of on-resistance R as metallic contacts of mechanical switches, thereby exposing the semiconductor junction to damaging I² R (Joule) heating during current surges. Moreover, some high-current semiconductor switch modules may include several semiconductor junctions connected in electrically parallel configuration, intending that the junctions share the current substantially equally. However, the junctions may not have the same on-resistance or the same turn-on time or rate-of-rise of current, and the junction conducting the most current may present the lowest electrical resistance to the external circuit, thereby tending to draw more current. Therefore, especially during turn-on and turn-off, one junction may conduct an excessive portion of the total current and become damaged.

Another field of switching may use electrical discharges to conduct current within switches. Some techniques may exist in the fields of vacuum switches, thyratrons, pseudo-spark switches, spark-gaps and similar devices. Generally, these devices may stand off voltages on the order of, e.g., 1,000 volts, 10,000 volts and higher when not conducting, and they may conduct currents of kA, MA and higher when conducting. The devices may provide extremely rapid rise-time of the switched current, often in, e.g., nanoseconds or picoseconds to give current rise times of 10¹² A/s or higher. Thus, large, high-voltage versions of these devices may produce gigawatt or terawatt pulses, since the energy transferred may be delivered in a very short time period. However, such high-power pulses may be also typically of rather short duration, e.g., microseconds. A relatively robust spark gap switch, with intensive air and water cooling and an electromagnetically swept “arc”, may transfer only, e.g., ˜1 C of charge over a few tens of microseconds. For circuit voltages of, e.g., 1000 to 10,000 volts, the total amount of energy transferred (e.g., 1 to 10 kJ) may not be on the same order of magnitude as those listed above for, e.g., energy storage applications, though such a switch may provide multiple pulses per second. Trigger timing accuracy and jitter in pulse onset time may be important with these devices, however, such parameters may be of little concern for energy storage and energy transfer applications. A modern pseudo-spark device, for which the total amount of charge transferred in a lifetime of pulses might be on the order of 10⁶ coulombs, while by contrast, a switch required for the proposed energy storage and energy transfer applications (discussed in greater detail below) may transfer 10⁶ coulombs in a single switch conduction event, though the duration of such events may be usefully up to seconds rather than microseconds as in, e.g., vacuum switches, thyratrons, pseudo-spark switches, spark-gaps and similar devices. The above-noted techniques may not provide long conduction duration for large energy transfer as defined above.

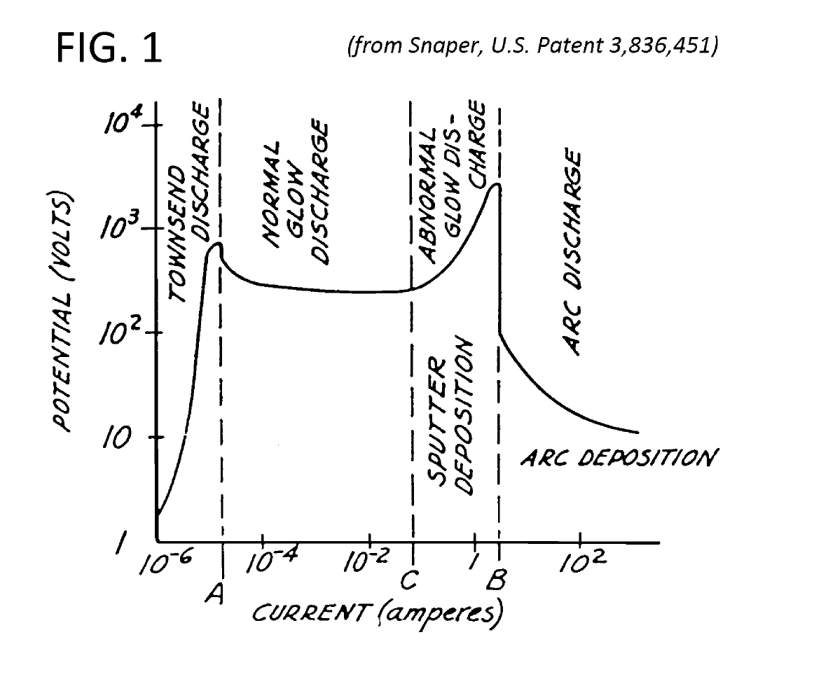

Some techniques may involve replacing sliding or rolling contacts with an electrical discharge conduction medium. For example, use of cold cathode field emission mode atmospheric-gas plasmas to conduct electrical current between non-mechanically-contacting electrodes, which may be stationary or moving one with respect to the other. The moving electrode is generally associated with a train, trolley or similar vehicle, and may be intended to avoid more intense erosive “arcs”, which might involve vaporization and/or ionization of the electrode material. The technique may avoid arcs by, e.g., laterally dithering the electrodes to prevent hot spots, regulating the distance of separation of the electrodes and limiting the current drawn. Other similar techniques may add low-ionization-potential materials to one or both electrodes and to pump special gases into the plasma discharge region, to enhance the current-carrying capability of the plasma. These techniques may include a two-mode operation, with sliding solid-solid contact at zero or low vehicle speeds and plasma conduction taking over at higher speeds. The solid contact mode may be useful for high start-up currents drawn by the vehicle. The plasma conduction mode may be inadequate to conduct the large currents needed for rapid transfer of large amounts of stored energy as defined above. This may be seen with reference to FIG. 1, though similar data are well known. The cold cathode field emission mode plasmas may fall into the “normal glow discharge” or the “abnormal glow discharge” regimes of FIG. 1, which may conduct current of about, e.g., 10 to 60 A. At higher currents, some form of arc may occur, which may be avoided in the aforementioned techniques; therefore, may be unlikely to have exceeded 100 A and may likely be about one order of magnitude less.

Further, with regard at least to glow discharge modes, especially at atmospheric pressure, there is a disadvantage of a substantial voltage drop (e.g., >350 v) that the FIG. 1 data show occurs across the discharge plasma, which wastes electrical power equal to the discharge voltage multiplied by the plasma (conducted) current. In some techniques, an electrical discharge in a gap with ionized gases may be used to conduct electrical current between non-mechanically-contacting electrodes in order to power a vehicle.

With other example techniques, the design of high-current and/or high-voltage switchgear may be dominated by considerations of, e.g., surge currents, transient high voltages, and contact arcs. In many applications, the normal running conditions may be much less severe and less potentially damaging than these surge or contact arc conditions. The practical result may be that switchgear is often sized much heavier, larger, costlier and inefficient than it could be if designed only for the normal running loads and conditions. For example, voltage drop and heating at contacts may be reduced if gold plating or other high quality contact material could be used, as may be possible if, e.g., only nominal running conditions are encountered, but these contact materials may not endure switch closing and opening arcs for long lifetimes. Therefore, if current surges, voltage spikes and contact arcs may be avoided or mitigated, especially during vulnerable periods of switch closing and opening, then smaller, cheaper, more efficient and longer-lasting switchgear may be deployed resulting in significant economic benefit.

Thus, some example issues may include the non-availability of simple, practical high-energy electrical transfer devices and of damage to known types of switchgear during making and breaking of high-voltage, high-current live circuits. While some techniques may include partial solutions, such as over-sizing the switchgear or frequently replacing switch components, they are inefficient, expensive, bulky, complex and/or labor-intensive. In some implementations, at least some of these issues may be addressed using an electrical current coupling device to connect, conduct and disconnect, e.g., kilo-ampere, mega-ampere or larger currents in circuits for transferring megajoule to gigajoule or larger quantities of electrical energy within a timescale of, e.g., seconds to sub-seconds. As will be discussed in greater detail below, in some implementations, the device may be configured to transfer this electric energy during relative motion of the objects sending and receiving the transferred energy. As will also be discussed in greater detail below, in some implementations, the device may include, e.g., substantial non-contact of electrical terminals, absence of impact forces, momentum transfer, rubbing friction and the like associated with mechanical contact during making/breaking of circuits and relative motion of the terminals of the device. As will also be discussed in greater detail below, in some implementations, the device may be configured to exhibit good operation without need of, e.g., intentionally added lubricants, conductive fluids, special gaseous media or shielding gases and the like. As will also be discussed in greater detail below, in some implementations, the device may be configured to operate at approximately, e.g., one atmosphere pressure. As will be discussed in greater detail below, in some implementations, the device may be configured to exhibit good operation in spite of the presence of unintentional environmental contaminants such as, e.g., dust, humid air, moving air (wind), incidental debris, oil mist and thin grease films. As will also be discussed in greater detail below, in some implementations, the device may be configured to exhibit good operation in spite of the presence of, e.g., unintentional environmental contaminants such as fog, rain, snow, ice, minor insect presence and the like encountered in outdoor use. As will also be discussed in greater detail below, in some implementations, the device may be configured to allow effective electrical energy transfer while tolerating relatively imprecise alignment and control of the relative position and distance between the electrodes, such as variations of, e.g., 1 to 10 mm.

In some implementations, the above-noted example issues of, e.g., a lack of high-energy electrical transfer devices and of switchgear being too easily damaged by contact arcs and energy dissipation during switching of electrical sources and loads that may engender high-energy surge currents at high voltages may be addressed, at least in part, by, e.g., providing switchgear in which a true arc is the switchable conducting element. Arc conductors provided by the disclosure may satisfy the object of transferring large amounts of electrical energy quickly and may absorb, with little or no damage, byproduct or wasted energy from circuits being switched.

In some implementations, the above-noted example issues of, e.g., switches, such as vacuum switches, thyratrons, pseudo-spark switches, spark-gaps, ignitrons and the like, which rely upon electrical discharges as the conductor, providing only low total energy transfer and brief pulses may be addressed, at least in part, by using unique arcing geometries, arcing materials and arc propagation principles to provide a low-voltage arc as an electrical conductor or switch.

In some implementations, the above-noted example issues of, e.g., high-energy, high-power true arcs that cannot be controlled and may be destructive, may be addressed, at least in part, by, e.g., the use of cold-cathode metal-vapor arcs, low-voltage arcs, broad area arcs and avoidance of self-current magnetic constriction of the arc, among others.

In some implementations, a mode of arcing between electrodes that are initially near room temperature, 25° C., and up to at least 500° C., may be mediated by the phenomenon of, e.g., cathode spots upon the cathode or negatively-charged electrode. For non-refractory metal cathodes, cathode-spot-arcs and derivatives may be the most likely kind of arcs to occur, because, e.g., the metal may not reach efficient thermionic emission temperatures (typically >3000K) before boiling. Such arcs may be referred to as, e.g., non-thermionic cathode arcs, cold-cathode arcs, metal vapor arcs and cathodic arcs. In general, almost all of the atoms and ions that may make up the arc plasma column may originate from the electrodes, but in any case no less than, e.g., 10% so originate. For historical reasons, such arcs may sometimes be referred to as vacuum arcs, though this term is widely understood to be a misnomer and mainly assures that the arcing vapor originates from the arcing electrodes. Vacuum environments have been used to study and utilize cathodic arcs for a number of reasons. For example, partial vacua (10⁻⁵ to 10⁻² atm) may enable study of the transition from a gas glow discharge mode to a metal arcing mode, as in FIG. 1.

In some implementations, when at least the surface of arcing electrodes become hotter (than, e.g., ˜500° C.), various other atomic mechanisms and modes of metal vapor arcing, such as anodic arcing, may further feed a metal vapor arc plasma and hence further enable arc conduction. An arc voltage may also be reduced if the mode of vaporization of metal atoms substantially changes over from cold-cathode arcing to metal vapor arcing in which a temperature of the electrodes (for example, the temperature of an outer layer) thermally vaporizes solid atoms. An arc may broadly be described as, e.g., a dense plasma discharge in which electrons are the primary charge transport species, due to their low mass and high mobility, and in which positive ions provide at least a space charge neutralization function for electron transport, where the discharge voltage (e.g., arc burning voltage V_{arc}) may be near the ionization potential of whatever atoms provide the positive ions, such as, e.g., 2 to 20 eV, which may result in a similar V_{arc}=3 to 30 volts, without limitation. Such arc voltages near the ionization potential of the atoms that may include the vapor sustaining the arc may be near the theoretical minimum voltage for any discharge or arc. An arc may persist over time at a low discharge voltage, where by contrast, a spark or flash may be transient and at higher discharge voltage. Arcs typically require at least a minimum or threshold arc voltage V_{arc,min} and arc current I_{arc,min} to sustain themselves burning and may further require somewhat higher parameters to start or initiate. In a metal vapor arc, the atoms that may become ionized to positive ions may originate from the metal of the arc electrodes. Dense metal vapor plasma arcs may burn in an ambient atmosphere or medium, such as in air or under water, with predictable effects but still substantially as metal plasmas.

In some implementations, the above-noted cathode arcs may be used intentionally as, e.g., conductors, switches and control elements in electrical circuits and may carry large currents, e.g., 10ⁿ amperes where n=1 to 9 or more, with relatively small losses and practically desirable device characteristics. Such a circuit may include an electric power source, an arc conductor in series with an electrical load and a return current path from a second terminal of the load back to a second terminal of the source. In some implementations, types of arcs for which the electrical resistance of the arc as a circuit element decreases as arc current increases may be used. There may exist the potential for these types of arcs to go opposite to the trend of most other electrical devices, which is to degrade their usable properties as conducted current increases. Rather, desirable arcs according to some implementations may scale up gracefully to extremely high conducted currents while consuming or liberating unexpectedly low I²R waste power. In some implementations, the disclosure may be used practically in scaling to high currents in desirable devices.

In some implementations, cold cathodic arcs may provide: the ability to burn in a variety of ambient media, nearly instantaneous (e.g., sub-microsecond) ignition, operation at both low and high electrode temperatures, the ability to burn on a wide variety of electrode materials and the general robustness regarding electrode spacing, contamination, external fields and means of ignition. Cold cathodic arcs may be configured to be substantially metal vapor arcs, where at least a portion of an inter-electrode arc plasma may either include or may be modified by metal atoms or ions originating from a cathode electrode. In some implementations, an electrode serving as an anode may be configured in the present disclosure to participate in an anodic arc, where at least a portion of an inter-electrode arc plasma may either include or may be modified by metal atoms or ions originating from an anode electrode. In some implementations, metal vapor for the arc may be supplied by a non-electrode body or source such as an arc ignition means. These and other aspects of the disclosure may dramatically increase an ability to initiate and sustain conduction of very large currents across high electric potential differences, and the ability to do so repeatedly and with repeatable parameters over long device lifetimes.

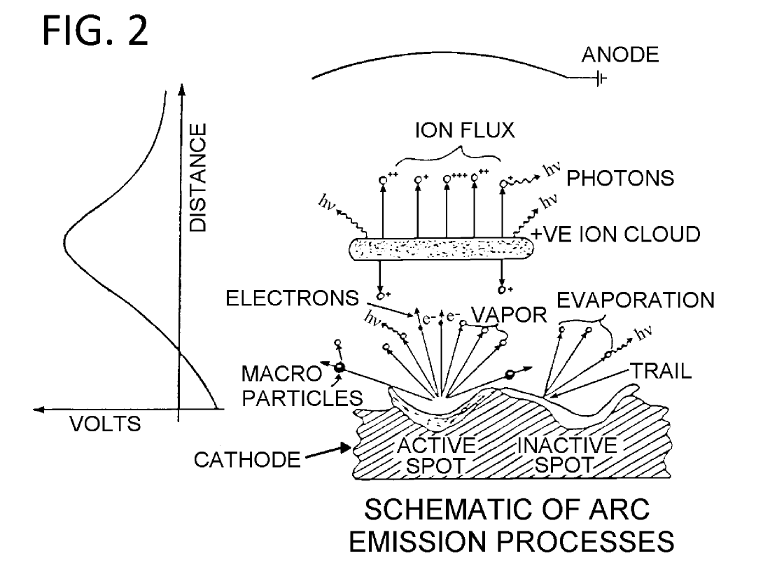

In some implementations using arcing mediated by cathode spots on the cathode, and referring to FIG. 2, cold-cathode arc discharges or plasmas may be created by and fed with, e.g., electrons, neutral atomic vapor and ionized atoms from the cathode electrode material. Plasma jets may be propelled at high velocity away from the cathode surface by small (e.g., ˜10 μm diameter), intensely hot cathode spots. Although emission of electrons from the cathode may dominate all phenomena, creation of positive ions from the cathode material may enable space-charge-neutralizing of the electron charge density in the inter-electrode region and permit large electron currents to flow. Some of the positive ions may form a highly positive-potential space-charge region (e.g., sheath or pre-sheath) which promotes a modified type of field-emission of electrons. Some positive ions from the cathode, typically multiply-charged, may arrive at the anode with high translational kinetic energy, often tens of electron volts (eV). Positive ions generally may be decelerated by the cathode-to-anode potential, which may repel positive ions from the anode, meaning that these ions may have had an even higher translational energy to start. As shown in FIG. 2, a positive-plasma-potential “hump”, may be located somewhere in front of the cathode, having a potential much more positive than the anode and being a region of ionization to form the positive ions. The ions may be accelerated in the metal vapor jets leaving the cathode spots and/or may be ionized from neutral atoms that had been previously accelerated. Positive ions returning to the cathode may be a primary means of heating the cathode surface at cathode spots. Cathode spots may move on the surface of the cathode at speeds of, e.g., 1 to 10,000 m/s. Visible (e.g., larger) cathode spots may include several associated sub-spots, microspots or emission centers. The apparent motion of visible cathode spots may be due to disappearance of sub-spots and generation of new emission centers at nearby displaced locations. Generation of new emission centers is thought to involve an explosive emission phenomenon, which may disrupt the conditions necessary for continued existence of the emission center. At the microscopic level of individual emission centers, it may be possible to predict where a next displaced explosive emission center may form or occur. Larger, visible cathode spots may have a certain minimum, threshold arc current that may be needed in order to exist, as well as an ill-defined maximum current above which spots tend to split and/or multiply in number. Many properties of cathode spots, as well as the voltage at which the arc burns, may depend at least in part upon the properties of the cathode material, such as the cohesive potential energy of the atoms in the cathode solid. Cold-cathode spots are described as non-stationary (e.g., non-steady-state), which at least means that they may be frequently extinguishing and new spots forming elsewhere. Cathode spot phenomena may be to some degree stochastic in nature (e.g., “random arcs”), and their spatial as well as time-domain patterns may have been described by fractal physics. Arc spots may be influenced at least in part both by cathode surface details (e.g., surface roughness, contamination, native oxides, grain size of the metal, etc.) and by inter-electrode plasma and anode condition details (gases present, wall effects, radiative losses, etc.). The cathode spots and the inter-electrode plasma may be strongly influenced by magnetic fields. Cathode spots may normally produce ejecta material of larger-than-atomic size, such as molten droplets and solid fragments of the cathode, which may be collectively known as macroparticles.

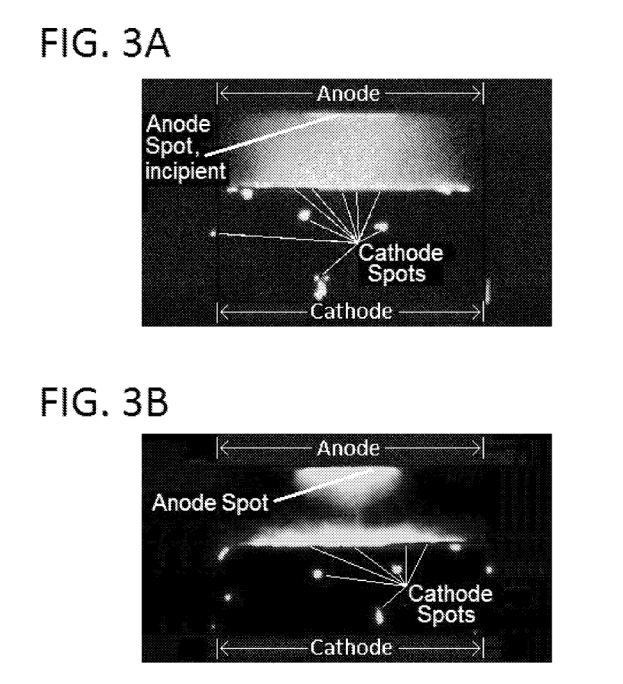

In some implementations, neutral metal vapor and ions of metal atoms from the cathode material may normally depart the cathode and make a coating of cathode material on all surfaces near or within line of sight of the cathode. In some implementations, there may be no upper limit to the electrical current cathode arcs may conduct, since dozens, hundreds or more cathode spots may exist simultaneously on the cathode surface, but electrode melting or erosion may become limiting. The anode side of the arc discharge may exist in several modes (e.g., diffuse-attachment, diffuse-spot, etc.) depending upon, e.g., the current density and anode temperature. FIG. 3A is an example photograph showing many of the above-described phenomena at a medium arc current of 2 kilo-amperes (kA) between 25 mm diameter copper electrodes separated by 10 mm, a current density of ≈4 mega-amperes per square meter (MA/m²), during a pulse of several milliseconds; many cathode spots are observed, including a few on the sides of the cathode shaft, and an indication of a single, diffuse anode spot is seen.

FIG. 3B is an example photograph of the same set-up at 4 kA arc current, twice the current density, taken about 1 millisecond after FIG. 3A during the same pulse; the cathode spots are so numerous as to appear merged together in the time-exposure of the camera, and the single, diffuse anode spot has become well defined and has its own plume contribution to the inter-electrode plasma. At these higher arc currents, and after a certain duration (e.g., ˜2 ms) of arc burning, the surface of the anode has reached the atmospheric-pressure boiling point (b.p.) of the copper anode material, e.g., ˜3200K, (which may still be insufficient to cause enough thermionic electron emission to sustain the entire arc current). The efficiency and intensity of anode heating even on a very thermally-conductive metal anode such as, e.g., copper may be beneficial. The inter-electrode plasma in FIG. 3B may be equally or more dense than in FIG. 3A, but the camera has reduced its exposure due to the very bright electrode-attached glows and/or more of the plasma optical emissions are in the ultraviolet spectrum. At higher arc currents, the inter-electrode plasma column diameter may be decreased due to the self-current magnetic field of the net arc current, which may trap electrons from escaping to the sides. The arc current densities given herein for FIGS. 3A and 3B are lower limits because, as seen on the left side of FIG. 3B, the outer rim of the cathode is rounded over and does not participate in the main arc discharge.

In some implementations, an arc conductor, an arc switch or a moving arc couple may be closed or “made” by, e.g., moving two electrodes, an anode and a cathode in a direct-current (DC) circuit, into predetermined proximity to and orientation with each other and striking a cold cathode arc between them. The switch may be “broken” or opened by a self-extinguishing of the arc when the anode and cathode come to approximately the same electrical potential or when the anode and cathode are moved a sufficient distance away from each other. The arc may be struck or ignited by, e.g., transient mechanical touching of the anode and cathode. Other methods to ignite the arc may also be used, such as a spark plug, laser pulse, electron beam pulse, radionuclide emitter of α-particles or β-particles, chemical explosive detonation and the like without departing from the scope of the disclosure.

In some implementations using arc-striking, within the type of transient mechanical touching of the anode and cathode, a striker rod or wire fabricated of a conductive material may be placed so as to short-circuit the anode to cathode. At least one of the anode and cathode may be moving into or fixed in an arcing position and the striker rod or wire inserted or fed into the anode-cathode gap at any desired time by any suitable actuator or feed mechanism. When electrical contact is made from anode to cathode through the striker rod or wire, current may flow through the striker rod or wire. The diameter, cross-section and/or mass of the striker rod or wire may be selected so that the current flowing through it may cause it to melt or even vaporize. The breaking of electrical contact by the destruction of the rod or wire may cause a “drawn” arc, which may provide, e.g., atomic vapor, ions and electrons to “trigger” or initiate a larger, general arc between cathode and anode. The vapor, ions and any unmelted length of material of the striker rod or wire may remain in the anode-cathode gap, become further heated and vaporized and become part of the arc discharge.

In some implementations, an arc conductor may be configured to expand from an initial spark or localized drawn arc into a broader-area arc column or arc channel within at least two electrodes of an arc gap. At least two steps may be recognized, a first ignition of, or breakdown of, the arc gap followed by establishment of an arc comprising at least one arc column. A subsequent phase may involve expansion of the already-established arc column. In some implementations, it may be beneficial to provide large lateral area or width of the electrodes, lateral being generally defined as substantially perpendicular to the short direction of a mechanical gap in which the arc burns. The distance in this short direction of the gap is known as an arc length l_{arc} of the arc gap. A large arc gap aspect ratio may be defined as a width of an electrode(s) divided by a length of the arc gap which may be equal to the arc length l_{arc}. For example, a large arc gap aspect ratio of the disclosure may be, e.g., 1, 10, 100 or more. As implied above, here the term “width” may generally stand in for an electrode area having two lateral dimensions so that the electrode area is on the order of, e.g., (width)².

In some implementations, the use of the physics of cathode spots may provide orderly expansion and contraction of the arc column and its footprint on the electrodes, a resistance (or impedance) of the arc that may decrease with increasing arc current and the distribution of heat generated by the arc. As arc current increases, a larger number of arc spots may be accommodated by a desired lateral expansion of the arc column. This may be used to estimate a resistance of the arc as a circuit element and the power or energy dissipated from an external circuit into the arc.

In some implementations, broad lateral expansion of an arc column, with its increased number of cathode arc spots, may create a multiplicity of electrically-parallel charged particle emitters and collectors conducting electrical current between anode and cathode, some or all which may be operative simultaneously. A resistance Rₛₚₒₜ may be assigned to one or more (or each) arc spots and its conductive plasma column, for each spot 1, 2, 3, . . . i, . . . Nₛₚₒₜ. Thus, the overall resistance of a broadly-attached arc column, R_{arc,column}=R_{arc}, may have a property of parallel additivity by inverses similar to that of commonplace resistors in an ordinary electric circuit, that is,

$$\frac{1}{{R}_{arc}} = {\sum }_{i}^{{N}_{spots}} \frac{1}{{R}_{spot , i}} , \qquad 1 )$$

though such resistances may be due to a plasma conductivity, which may be unstable or stochastic due to the nature of arc spots creating the plasma. The greater the number of cathode arc spots, the lower may the overall resistance or impedance of the arc column be. By way of example only, for a typical arc spot, Vₛₚₒₜ≈V_{arc} may be 10 volts and Iₛₚₒₜ may be 20 amperes, so by Ohm's Law, R_{spot,i} may be ˜0.5Ω. Making an approximation that, over a time and population average, all of the arc spots are identical and have the same resistance Rₛₚₒₜ and the same contribution Iₛₚₒₜ per spot to the overall current conducted by the broad arc plasma column, then Eqn. 1 reduces to

R_{arc}⁻¹=Nₛₚₒₜₛ/Rₛₚₒₜ. 2)

With the aforementioned discussion that arc spots each provide, on average, a characteristic current Iₛₚₒₜ, a value for Nₛₚₒₜₛ can be estimated as

Nₛₚₒₜₛ=I_{arc}/Iₛₚₒₜ 3)

In some implementations, if an arc gap is conducting 1 MA, then 50,000 spots may be required, so Nₛₚₒₜ=50,000, and by Eqn. 2, R_{arc,column}=R_{arc}=10 μΩ (micro-ohms). This may be an extremely small contact resistance for, as an example, million-ampere metallic contacts pressed together. In some implementations, million-ampere metallic contacts may be bulky or complex, while a million-ampere arc conductor couple may be, e.g., ˜0.1 m², about 1 square foot (for Φ_{arc} of 10 MA/m², which is relatively low) and may include substantially planar, cylindrical or spherical-section plates, which are of desirably small size and simple form. A general approximate scaling rule, most valid at high arc currents over a time-average, for the decrease in arc resistance with increasing arc current is obtained if we invert Eqn. 2 and insert Eqn. 3 for Nₛₚₒₜₛ:

R_{arc}=Rₛₚₒₜ/Nₛₚₒₜₛ=Rₛₚₒₜ·Iₛₚₒₜ/I_{arc}=k·I_{arc}⁻¹. 4)

Thus, arc resistance may be inversely proportional to arc current with a proportionality constant k=Rₛₚₒₜ·Iₛₚₒₜ, which may be assigned k=Vₛₚₒₜ≈V_{arc,min}, since k has the units and dimensions of a voltage. The assignment of V_{arc,min} for the constant k may be based upon the experimental observation that V_{arc} does not increase substantially as I_{arc} is driven higher, within certain limits. The constancy of a V_{arc} value near V_{arc,min} may hold when lateral expansion of the arc column footprint upon the arc electrodes is unimpeded. Both Vₛₚₒₜ and V_{arc}, for arcs containing only a few spots may be poorly defined, unstable over time and highly dependent upon the impedances of external circuits in communication with the arc (which may include current loops and magnetic fluxes not in galvanic contact with the arc). This behavior of V_{arc} at low arc currents may be due to the stochastic or chaotic phenomena including arc spots. In some implementations, arc resistance may be inversely proportional to arc current for high-current arc conductors to allow, e.g., kA to MA or higher currents to be conducted efficiently. Ease of arc attachments at the electrodes expanding into one or more broad, lateral, large cross-section arc column(s) may be provided and broad-area attachment may be used for achieving an arc impedance inversely proportional to the arc current. Thus, at high arc currents,

R_{arc}≈V_{arc,min}·I_{arc}⁻¹, where V_{arc,min} constant. 5)

As mentioned above, however, there is a certain minimum arc current I_{arc,min} below which the arc may not continue to burn, so R_{arc} may be treated as infinite below that threshold current. As a somewhat more general scaling rule than Eqn. 5, but still approximate:

R_{arc}≈V_{arc,min}/(I_{arc}−I_{arc,min}), for I_{arc}>I_{arc,min}. 6)

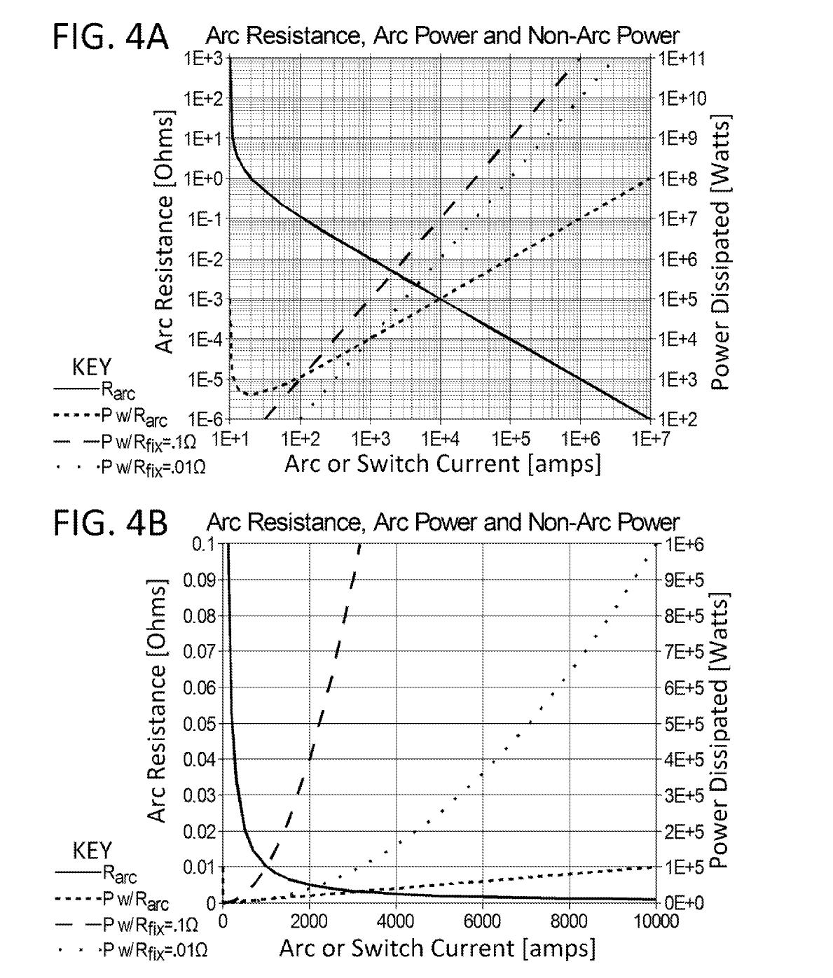

Arc impedance as a function of arc current calculated from Eqn. 6 with V_{arc,min}=10 v and I_{arc,min}=10 A is shown in FIG. 4A.

Power dissipated in or by an arc conductor of the disclosure is also shown in FIG. 4A, on the right vertical axis, calculated using the R_{arc} value given by Eqn. 6 with constant V_{arc}=V_{arc,min}=10 v and I_{arc,min}=10 A in the usual formula for Joule heating:

P_{arc}=I_{arc}²·R_{arc}. 7)

Eqn. 6 says R_{arc} decreases inversely with increase in I_{arc} at large I_{arc}, which is equivalent to inserting Eqn. 4 for R_{arc} into Eqn. 7 to give

P_{arc}=I_{arc}²·k·I_{arc}⁻¹=k·I_{arc}=V_{arc}·I_{arc}, (I_{arc}>>I_{arc,min} and V_{arc}≈constant) 8)

where V_{arc} is close to V_{arc,min} and identified with constant “k” as discussed after Eqn. 4. Eqn. 8 shows that, for an arc burning in a particular mode, the disclosure may provide P_{arc}∝I_{arc}, rather than P_{arc}∝I_{arc}², as Eqn. 7 may imply. By contrast, a normal metallic conductor and, presumably, a metallic solid-solid contact junction of a relay or contactor, may have a power dissipation as given in Eqn. 7 but with a fixed resistance R_{fixed} in place of R_{arc}. A fixed contact resistance may give P_{contact}∝I_{contact}², and two typical cases like this are also plotted in FIG. 4A for comparison. Values of 10 and 100 milli-ohms were chosen for R_{fixed} in FIG. 4A. R_{fixed} may approximate a contact resistance in a commercial off-the-shelf (COTS) switch or contactor. In some implementations, the values of, e.g., 10 and 100 mΩ chosen may be valid during current surges, and the value may increase during a surge due to dissipated heat combined with a positive temperature coefficient of resistance. FIG. 4A is a log-log plot from which it may be difficult to discern the difference between the linear Eqn. 8 using R_{arc} and the non-linear, quadratic Eqn. 7 using a fixed resistance R_{fixed} in place of R_{arc}; FIG. 4B shows the same data plotted on linear axes, in a relevant range of variables. From FIG. 4B, it may be seen that the trend for arc conduction over solid conduction may be clear as conducted current becomes higher (e.g., increases).

In some implementations, a lower V_{arc} may be seen as arc current increases, which may be indicative that the arc has expanded or moved to vaporize and ionize other materials that are more arc-enhancing than the materials upon which the arc was initially burning. V_{arc} may increase with I_{arc}, as well, which may be due to arc ingress to more arc-limiting materials. Other interpretations are possible. For example, V_{arc} may decrease with increased I_{arc} if, e.g., the arc also moves to cooler metal, which may have lower resistance due to the positive temperature coefficient of resistivity of most metals. This temperature effect may be operative as a means of urging expansion (e.g., broadening) of the arc footprint on the arc electrodes shortly after establishment of the arc. In some implementations, it may be desirable to use a tendency of an arc footprint to move to cooler metal, but not allow the arc to stop burning on the hotter metal from whence it came. Thus, a tendency for the arc to move becomes a tendency for the arc to expand. Among other ways, the arc may be prevented from extinguishing at or moving away from already-hot electrode areas by, e.g., providing a shorter arc gap length there, as described below.

In some implementations, if an external electrical power source may provide large current at high driving voltages, the mode of arc expansion by cathode spots described above and its consequent reduction in arc impedance as current increases may lead to “runaway conduction” or “runaway current draw”. Proper selection of arcing conditions may provide a low arc voltage, so relatively little energy may be dumped into the arc or electrodes, if there were a proper load in series with the arc across which the dominant fraction of circuit voltage may appear (and into which the majority of energy may be dumped). Runaway increase of arc current may be desirable when arc ignition and establishment is used as the closing of a switch or to transfer energy quickly. It may be acceptable and beneficial to allow arc current to increase rapidly and without arc-self-limit, so long as an electrical source or load of an external circuit may limit the current at some value, and this current value and its attendant energy dissipated in the arc was within the capacity of the arc apparatus to absorb.

In some implementations, there may be a “feed-forward” increase of arc current based upon, at least in part, a principle of expansion of a width or a cross-sectional area of an arc column to conduct rapidly increasing arc current while always maintaining low arc voltage. In one or more implementations, a type of arc that includes cathode spots may provide feed-forward increase of arc current while allowing a voltage across the arc electrodes to remain low, such as, e.g., 2 to 10 volts but usually (and not always) less than 50 volts. At such arc voltages V_{arc}, an acceptably low amount of energy (as generally defined below) may be dissipated in the arc apparatus. By “feed-forward” it is meant positive reinforcement, and a mode of arc expansion may be provided where an initial increment of energy may be taken from the external circuit to vaporize and ionize material in the arc gap, which in turn may allow more current and energy to be drawn from the external circuit, which in turn vaporizes and ionizes more material in the arc gap, which in turn may allow more energy to be drawn from the external circuit, and so forth on and on. In one or more implementations, cathode arc spots may facilitate the expansion. The runaway feed-forward increase of arc current may be conducted by, e.g., an arc plasma column or channel characterized by at least one “arc front” or arc ignition front propagating in an orderly pattern from a first arc ignition location throughout a broad-area electrode gap.

Generally, arcs are avoided because a) runaway current conduction at b) modest or high circuit voltages is thought to cause c) great release of electrical energy and consequent destruction of apparatus. However, in some implementations, arcs may be used as switches or temporary conductors, with no current limit and no ballast, to quickly transfer as much electric charge (e.g., current) to a load as the electrical source could deliver or the load could accept. Such loads may be, e.g., rail guns, high-voltage capacitors, pulsed lasers, plasma-chemical propellants, electromagnetic beacons and others. In some implementations, there may be beneficially rapid, unfettered, free-propagating feed-forward increase of arc current and of the size of an arc. In some implementations, a rate-of-rise of conducted current of such free-propagating arcs may be modified over a wide range (e.g., 0.1 to 100 kA/μs), which is beneficial for control in some of the above-noted applications. Those skilled in the art will appreciate that principles of the disclosure may also give scaling rules for arc conductor apparatus, such that not only extremely large energy and power may be transferred but also smaller energy and power in the neighborhood of, e.g., 100 joules and 100 watts may be beneficially transferred, thereby enabling use for replacing, augmenting and protecting more conventional switchgear.

In some implementations, in a low-voltage, runaway mode of arc expansion, it may be advantageous in one or more implementations that the arc electrode area not be over-filled with plasma before the source-to-load circuit current increases to a peak value and begins to decrease. According to one or more implementations, a quantity of heat energy released as electrical power in the arc plasma multiplied by the duration of the conduction event may be less than or equal to an amount that can be safely absorbed by the arc apparatus.

In some implementations, using rate of pressure rise and other parameters, arc expansion may be controlled for rate of arc front propagation, rate of plasma density growth and other parameters. A rate-of-rise of current through an arc conductor may be tailored via control of arc front propagation speed, electrode shape, arc column expansion rate, properties of the arcing materials and other principles and aspects of the disclosure. In one or more implementations, a rate-of-rise of arc current may be determined as a fixed design parameter, varied from one conduction event to another and/or varied within one conduction event.

In some implementations, the impedance of the arc column and of the arc gap as a circuit element may start relatively high immediately after first arc ignition, decreases to values in the 10, 1 to fractional ohms level as a first metal-vapor arcing mode is established and further decreases to milli-ohms (mΩ) to micro-ohms (μΩ) as lateral expansion of the arc column creates a multiplicity of electrically-parallel charged particle emitters and collectors operative simultaneously. See Eqn. 1 above. Because of this plurality of substantially independent charged particle emitters and collectors, a laterally spread-out, broadened or expanded arc channel or column may include multiple smaller-width arc channels or columns connecting cathode to anode, but these may be desirably merged together into one column and may be referred to in the singular herein. The speed at which the breadth of the arc column can expand may depend at least upon a mobility of cathode arc spots, a speed of sound in the ambient medium of the arc gap or a speed of sound in the arc plasma within the arc gap, each of which may be on the order of tens to hundreds of meters per second. Because the impedance of the arc plasma column may decrease with increasing current conducted by the arc, due to the broadening and mass-parallel emitter effect of the arc column with increasing current, the voltage across the arc gap in a desired conducting mode may stay near 10 volts, but usually between 2 to 50 volts, at all conducted currents from less than ˜100 A to greater than ˜10⁷ A or more. The remaining voltage of an external circuit not appearing across the arc gap appears across the load. Thus, an arc conductor may be provided that can increase its conducted current rapidly (sub-μs to ms) and controllably from near zero to extremely high currents (MA and higher) while achieving on the order of μΩ “contact” resistances at the higher currents without damage to the arc gap.

Saturable inductors may be employed to control a rate-of-rise of current and prevent erosion damage to vacuum switch electrodes, but such inductors may be undesirably heavy when sized for the higher current and energy transfers of the present disclosure and may be unnecessary. Design parameters of the arc conductor or switch may adjust a rate of expansion of a width or a cross-sectional area of the arc plasma column(s), which in turn may adjust a rate-of-rise of current increase upon switch closure and also control the lateral area on the electrodes into which an amount of waste heat due to the arc resistance is deposited into the electrodes. When a current flow through the arc conductor or switch decreases due to circumstances in the external circuitry served by the arc conductor or switch, a width or a cross-sectional area of the arc plasma column may contract in an orderly fashion to maintain a voltage near, e.g., 10 volts, but usually between 2 to 50 volts, across the arc gap, which in turn maintains proper burning conditions for the arc until the arc current reaches a low value such as <100 A, <50 A, <20 A or lower at which time the arc may self-extinguish. The switch may then be in an open state.

In some implementations, an arc gap for the expanding plasma may include one or more arc electrodes providing a shorter arc gap length l_{arc} at a location of first arc ignition and smoothly increasing gap length in regions of the gap into which the broadening arc plasma subsequently expands. For example purposes only, a set of scaling laws or principles are disclosed whereby a pattern or rate of increase of gap length l_{arc}(r) with respect to lateral distance “r” from a location of first arc ignition may be selected or configured. In one or more implementations, the passing arc front leaves behind a time-sustained, low-voltage-burning arc plasma column conducting 1, 10 to 100 or more mega-amperes per square meter (MA/m²) of electrode area arc current density Φ_{arc}. Values of Φ_{arc} up to 1000 MA/m² are provided within the disclosure. In one or more implementations, the arc column is substantially spatially continuous, i.e., laterally space-filling with arc plasma within the arc gap behind the arc front. In this sense, “behind” means opposite the direction of motion of the expanding arc front and back towards the location of first arc ignition.

In some implementations, an arc conductor or switch may be sized or configured for a circuit and its maximum surge current pulse parameters, such as peak current and duration. Scaling laws may concern a mass and a heat capacity of the arc apparatus materials sized to heat dissipated in the arc apparatus by arc conduction. In another aspect, the scaling laws concern an area of the arc electrodes available to sustain an arc in the arc gap sized to a current to be conducted by the arc apparatus (e.g., the maximum current) and a current density Φ_{arc} [A/m2] that may be conducted by the arc plasma. The scaling laws may concern a material of the arc electrodes, an arc striker and/or an arcing additive, where the material(s) may configure an arc gap to conduct at a certain current density Φ_{arc}, which may be used in another scaling law for electrode area. Using additional aspects of the disclosure including arc-enhancing materials, a lower power and energy end of a useful range for arc conductors may be extended to approximately, e.g., 100 watts and 100 joules. There appear to be no upper limits. According to the aforesaid scaling laws, many implementations of the arc conductors may be beneficially small, lightweight, inexpensive and rugged. Increasing a mass of the arc conductor apparatus or adding explicit cooling for the electrodes and/or arc gap components may permit higher duty cycle of repetitive switch use.

In some implementations, using other aspects of the disclosure may achieve arcs with a desired degree of electrical energy absorption out of the circuit it is serving by optionally choosing or varying one or more of: a shape of arc electrodes (which may, without limitation, give a non-uniform arc gap length), an area of the arcing surface of an electrode, selected arcing electrode materials, spacing of arc electrodes, selected arcing media between the arcing electrodes, chemical reactions between arcing electrodes and species within the arcing medium (for example, air), a thermal mass of one or more arc electrodes (which may affect a temperature rise during a conduction event) and arc-induced transfer of material from one electrode to another electrode, among others.

In some implementations, an arc conductor, arc switch and moving arc couple may use cathodic arcs to conduct electric current between non-mechanically-contacting cathode and anode electrodes. The anode and cathode portions of the switch may be moved relative to each other along an approximate expected path during desired portions of a switch closing, conduction and/or opening event. In some implementations, the path may be linear or circular though not limited to such.

In some implementations, the cathode may be fabricated from a metal with relatively difficult arcing properties and may be provided with a coating or surface layer comprising of at least one arc-enhancing material. The arc-enhancing material may be chosen to promote good arcing given the pressure of the environment and the quantity of energy to be transferred. The cathode's arc-enhancing material also serves as a means of promoting cathode arc spots to burn preferentially at desired locations within the switch. The cathode's arc-enhancing material may be sacrificial, in the sense of being vaporized and eroded by the arc, but means are provided to replenish the arc-enhancing material. For example, the anode may be fabricated of selected materials with a shape to not only efficiently collect electrons but also to collect vaporized cathode arc-enhancing material and re-vaporize it back to the cathode. A wire-feed or rod-feed arc striker or trigger may be provided, the vaporized material from which replenishes the cathode arc-enhancing material. The switch and moving electrical contact may be used repetitively. A set of baffles or shield structures may be provided to limit the influence of atmospheric air upon the burning arc, to capture cathode arc-enhancing material vapor for recovery and re-use, to retain heat from the arc discharge, to shield the surroundings from hot gases and radiation from the arc and to reduce acoustic noise from the arc escaping to the surroundings.

In some implementations, arc switches and conductors may produce quantities of waste heat lower than current technologies for pulsing or switching equivalent amounts of electrical energy. Arc conductors may be matched to and selected for a circuit they serve at least according to a thermal limit of the arc conductor apparatus. A thermal limit, or maximum temperature rise, may exist for any particular arc conductor apparatus, and the energy (heat) dissipated in the apparatus by a conduction event ought not cause this temperature to be exceeded. As mentioned, arc conductors may be used for short duration conduction of high currents. Referring again to FIGS. 4A and 4B, the power dissipated by an arc, even though possibly orders-of-magnitude smaller than may be dissipated by a solid-solid contact junction of conventional switches, and may still be large. For example, when conducting 1 MA current used for example in a previous paragraph relating to area of arc electrodes, a power of 10 MW may be dissipated in the arc, its electrodes or the surroundings. The power generated over time is an energy loss,

E_{loss,arc}=P_{arc}·Δtₚᵤₗₛₑ, 9)

where Δtₚᵤₗₛₑ is the time duration of the arc conduction event or current pulse. Substituting the alternate formula besides Eqn. 7 for electric power loss, P_{arc}−I_{arc}·V_{arc}, into Eqn. 9 gives

E_{loss,arc}=V_{arc}·I_{arc}·Δtₚᵤₗₛₑ=V_{arc}·Q_{xfr}, 10)

where Q_{xfr} is the total charge in Coulombs transferred, since the integral over the interval Δtₚᵤₗₛₑ of I_{arc}(t)dt=Q_{xfr}. This form from Eqn. 10 is appropriate because the current value during a surge or in-rush event may rarely be constant over time. E_{loss,arc} may normally end up as heat Eₕₑₐₜ dissipated in the arc apparatus. With arc conductors of the disclosure, such heat may simply and advantageously be dissipated in the mass of the arc electrodes or other structures of the arc gap apparatus. The arc apparatus may be designed to absorb the heat dissipated by any given circuit conduction event. The formula ΔTₐₚₚₐᵣₐₜᵤₛ=Eₕₑₐₜ/(Cₚ·m), where Cₚ is the heat capacity and m is the mass of the electrode material or arc gap apparatus, gives the temperature rise ΔT for any given energy Eₕₑₐₜ dissipated. From FIG. 4A, the 1 MA current liberating 10 MW power for 0.1 second generates 1 MJ of heat that may be dissipated. If the arc gap apparatus includes 10 kg of copper, the temperature rise is ˜260° C. If the arc gap started at near room temperature, the final temperature may still be <300° C., which may allow the arc gap apparatus to be in close proximity to properly selected organic polymers or other construction materials. The 10 kg of copper in such an apparatus may be a cube about 104 mm (˜4 inches) edge length, though the cube shape is not limiting and is merely for illustration purposes. Such a mass and volume of arc conduction apparatus and its material is advantageously compact for the magnitude of electrical energy prospectively transferred. For example, if a V_{circuit}=1000 v circuit conducts 1 MA through an arc conductor in series with a load for 0.1 s, the load receives a power of

P_{load}=V_{load}·I_{load}=(V_{circuit}−V_{arc})·I_{load}=(1000 v−10 v)·1×10⁶ A=990 MW, 11)

and the energy=power×time provided to the load during the 0.1 s may be 99 MJ. The current transferred by the arc through the load may, however, vary during the conduction event as I_{arc}(t)=I_{load}(t) due to the nature of a load or source (for example, a capacitor becoming charged or discharged) or due to a change of arc conduction. V_{load}(t) may change for similar reasons. Therefore, the equation for energy transferred to the load is more generally written

E_{load}(t)=∫ₜ₌₀^{t}V_{load}(t)I_{arc}(t)dt 12)

Within the approximation of a simple square-wave pulse of current at constant voltage, the arc conductor may consume, divert or dissipate ˜10 MW power for 0.1 second and generates ˜1 MJ of heat, which is only ˜1% of the energy and power prospectively transferred to the load. Eqns. 11 and 12 indicate that the higher V_{circuit}, the smaller the percentage losses may be to an arc conductor of the present disclosure. (See Eqn. 13 below.)

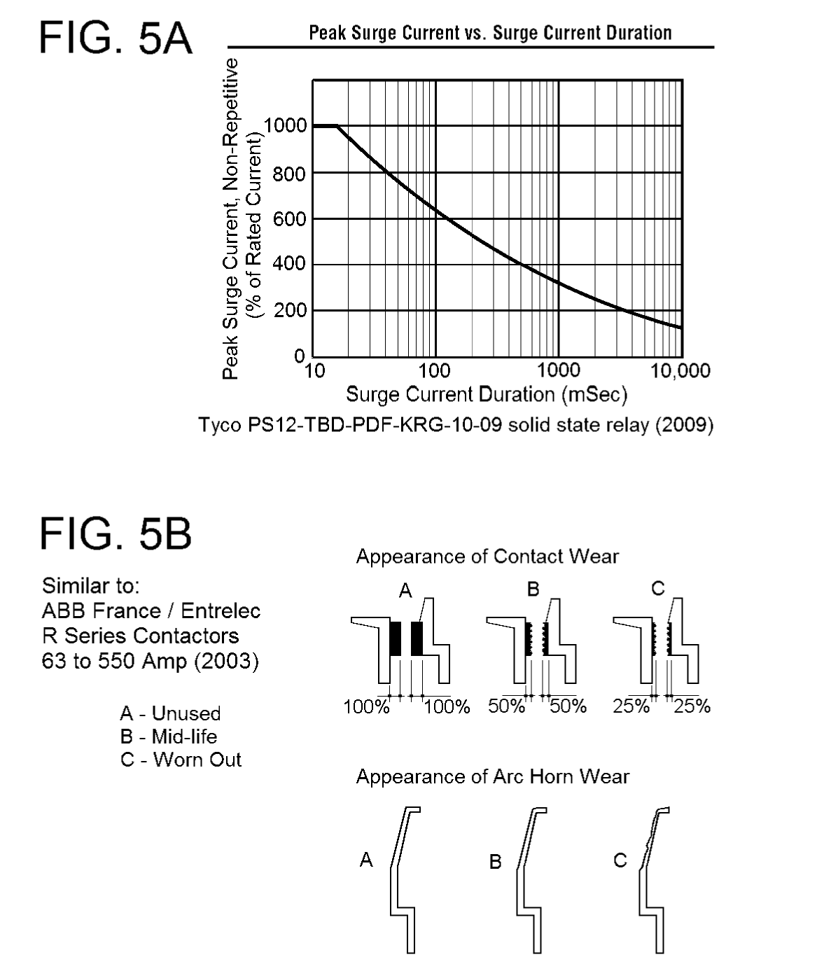

In some implementations, a switch or arc conductor of the disclosure may be constrained by design details of its particular implementation to a certain maximum energy (heat) dissipated, beyond which, damage, such as melting, may occur to the arc conductor apparatus. This maximum quantity of energy may typically be expressed as an electrical current over a certain time duration or a power multiplied by the time during which that power is dissipated. For example, FIG. 5A shows a published chart of peak surge current versus surge current duration for a COTS solid-state (semiconductor) switch. This switch, with a continuous rated current of 10 A, may only conduct 6000 A for 0.1 sec before device destruction. With the stated 1.2 to 1.5 volts forward conduction voltage drop V_{fwd-drop} of this device, the power dissipated in the device, P_{device}=I_{circuit}·V_{fwd-drop}, at I_{circuit}=6000 A may be 7200 to 9000 watts, which over 0.1 s results in 720 to 900 J of heat dissipated in the device. This device is only usable for V_{circuit}≦250 v circuit voltage, but at the high end of that voltage range its losses are approximately V_{fwd-drop}/V_{circuit}, which may be ≦1.5 v/250 v=0.6% of the energy and power prospectively transferred to a load. Note that these usefully transferred energies and powers associated with the semiconductor device are three orders-of-magnitude less than those provided by the arc device example used above. There is a good analogy between the forward conduction voltage drop V_{fwd-drop} of a semiconducting junction device and the minimum arc burning voltage V_{arc,min} of an arc conductor device. In both cases, the device losses of energy and power prospectively transferred to a load have the same form:

% Loss in Switch Device≈100·V_{fwd-drop}/V_{circuit}=100·V_{arc,min}/V_{circuit}. 13)

Thus, at V_{arc,min}=10 v and in a V_{circuit}=250 v circuit, an arc conductor may have ˜4% losses. At V_{circuit}=1667 v, an arc conductor may have the same ˜0.6% losses as the cited semiconductor switch has at V_{circuit}=250 v, assuming V_{arc,min}=10 v. It may be explained below that V_{arc,min}=10 v is merely a typical value and that both lower and higher values are readily accessible within the disclosure. Generally, the minimum arc voltage V_{arc,min} may not be as low as the one or two “diode drops” V_{fwd-drop} typical of a simple semiconductor junction, because of the different physics involved, so it may seem advantageous to always use semiconductor junctions over arc conductors, to minimize wasted power. Some types of semiconductor junctions may even exhibit an apparent reduction in junction resistance as junction current increases, analogous to Eqns. 5 and 6 for arcs, albeit due to different underlying physics. However, arc conductors scale up very easily in both circuit current and voltage as is made clear herein, whereas solid-state semiconductors may be troublesome to scale up in either circuit current or voltage, much less both simultaneously. To scale up in current, multiple parallel semiconductor junctions are often necessary, but these must be carefully trimmed or elaborately controlled to share current equally especially during turn-on and turn-off. Otherwise one of the junctions may “hoard” circuit current due to its apparent reduction in junction resistance as current increases. To scale up in voltage, special thick semiconductor junctions must be grown, and these have both higher V_{fwd-drop} and reduced ability to conduct away dissipated heat. By contrast, a single arc gap configured according to the disclosure easily scales up in current, both within a single arc conductor device during a single current pulse and within separate arc conductor devices intended for different magnitudes of conducted currents. To scale an arc conductor up to higher voltage may be as simple as increasing the length of the arc gap. Therefore, considering ease of scale-up to high circuit current and voltage combined with relatively low losses at high circuit current and voltage, arc-conductor-based switching devices prove very desirable, especially during turn-on, turn-off and surge current conduction.

In some implementations, the arc conductor may be configured to operate in a pressurized medium, such as atmospheric-pressure air, initially residing in the arc gap. This is desirable for ease of deployment and cost, but may also play a beneficial role as fluid-mechanical resistance to arc front propagation, thereby urging the arc front into a more dense, unified, well-ordered structure. The medium may play little to no role in sustaining a burning of the arc and is mostly forced out of the gap by the expanding arc plasma.

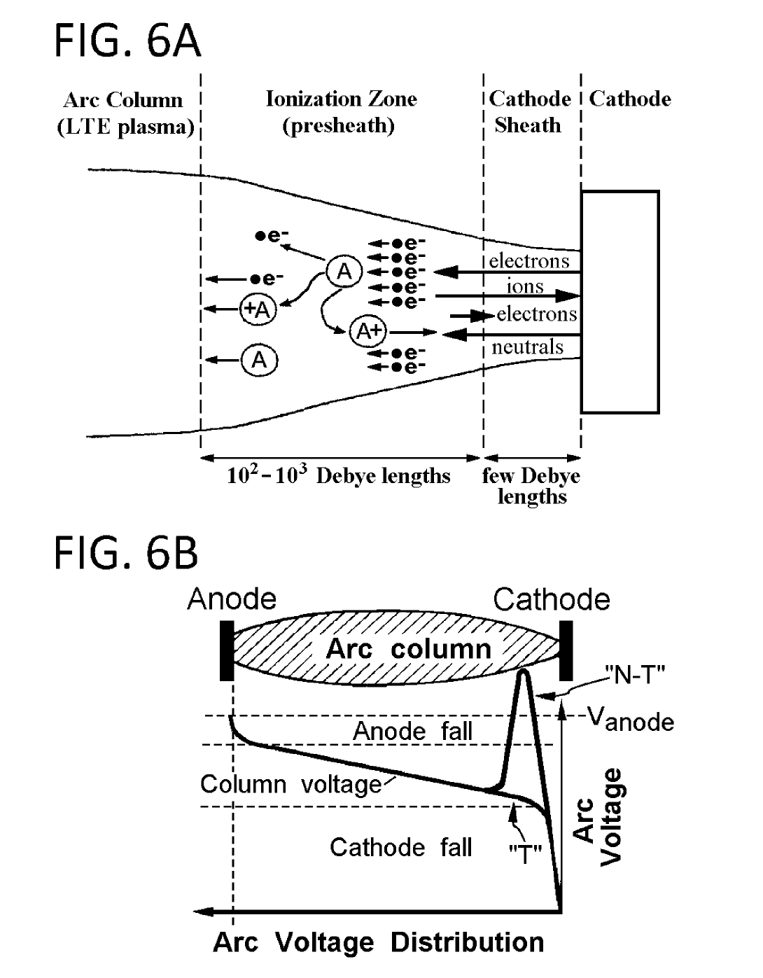

A combination of aspects of arcing geometry, electrode materials and arc energy are provided to enable reliable, stable burning of an arc at near atmospheric pressure. An arc of the present disclosure may be a metal vapor arc derived from cathode-spot-like phenomena on non-refractory cathode materials. Such cathode materials may not sustain thermionic emission temperatures so as to emit electrons and thereby ionize the gaseous constituents of the atmosphere which anyway may be of insufficient number density and improper location to sustain the arc. Generally, the intense heat, electron flux and vapor pressure of the arc-volatilized cathode material displaces the air and maintains an ionized-metal-vapor plasma column through the high-pressure dielectric medium (air) through which a net electrical current may flow. FIG. 6A and FIG. 6B are associated with high-pressure arcs but augment FIG. 2 from the field of vacuum arcs. FIG. 6B illustrates a potential curve “N-T” for non-thermionic electron emission to contrast with a “T” curve for regular thermionic emission. This “N-T” curve refers to the above-noted “potential hump” hypothesis of cold cathode ionization/acceleration (see similar hump in FIG. 2).

There exist several examples of high-pressure arcs, such as gas-tungsten arc welding (GTAW), underwater wet welding and thermal arc plasma spray coating. In these examples, which may rely on either thermionic or non-thermionic electron emission from the cathode, and where in the present disclosure, which may rely on non-thermionic emission, an ionized-metal-vapor column is a kind of inter-electrode plasma of the arc. In order for this plasma column to be stable, it may be necessary that the outward pressure P_{chan} is greater than or equal to the inward pressure of the atmosphere or dielectric environment, Pₑₙᵥᵢᵣ. This inter-electrode plasma column pressure is not to be confused with the arc plasma pressure close to the cathode spots, which is thought to range from 10 to 100 atmospheres even when the arc is operating in a vacuum. Also note that, in certain fields of atmospheric arcs, for example GTAW, certain practitioners in related fields may use the term “cathode spot” to indicate the region of plasma column attachment to the cathode even when the cathode is known to be operating in the high-temperature thermionic emission mode. This usage is opposite of the meaning predominant in all other fields involving vacuum arcs or cold-cathode arcs, wherein the term “cathode spot” is synonymous with non-thermionic emission from cathodes that cannot sustain thermionic temperatures without melting or vaporizing. This latter usage and meaning is used consistently herein.

Due to the stochastic nature of most arcing phenomena, the pressure exerted by the inter-electrode plasma in the ionized metal-vapor-column or channel is time-dependent, so

P_{chan}(t)_{avg}≧Pₑₙᵥᵢᵣ, 14)

where the time-average is over a critical interval t_{collapse} which is related to the speed of sound c in the air (or other medium) and a characteristic width d_{chan} of the arc column or channel, roughly the time after which the column may collapse in the absence of the arc. Thus

t_{collapse}d_{chan}/c. 15)

In some implementations, for uninterrupted arc operation in the high-pressure medium, the time-scale of arc current fluctuation in the inter-electrode plasma (the ionized-metal-vapor column) may be much shorter than t_{collapse} or that the amplitude of the current fluctuations may be small relative to the arc current in the column or channel I_{chan}. Generally it may be the case that

d_{chan}∝[I_{chan}]ⁿ, 16)

where the exponent n may vary with conditions and may not be an integer. The width of the ionized-metal-vapor column may increase with arc current, which may desirably increase t_{collapse} according to Eqn. 15. An example explanation for the relationship Eqn. 16 is that additional arc current may heat the arc plasma column and tend to increase the pressure inside it (Gay-Lussac's Law), but, when Pₑₙᵥᵢᵣ is approximately constant, the width of the arc column may tend to expand (Charle's Law) to render Eqn. 14 an equality. Of course, the ionized arc plasma column is not an ideal gas at all, and the fluctuating nature of cathode spots introduce a time dynamic. The cathode spot phenomena occur at 1 to 10 μs time-scales, the arc plasma column heating phenomena react more slowly and the environment or media reacts still more slowly. At any one location, the P-V-T responses may be out of phase (not at equilibrium, hence Charle's and Gay-Lussac's laws are not exact but still indicate trends), but the arc column as a whole may (or may not) be in an apparent steady-state condition with respect to its interaction with the environmental medium.

In some implementations, with broad, substantially flat cathode and anode electrodes, as in FIG. 3, the total arc current may split between several ionized-metal-vapor plasma columns through the dielectric fluid (air, atmosphere, environment, water and the like media), each with its own I_{chan}. These columns may move laterally, change in number and merge again over time, which may be 1 second or longer in the present disclosure, a period much longer than the microsecond or millisecond time-scale characteristic of the phenomena associated with the arc spots themselves. Electrodes which have broad-area and arc durations of >>milliseconds are provided within the present switch of the disclosure, as among the objects are to conduct kA to MA currents to transfer MJ to GJ quantities of energy and to allow the anode and cathode to move relative to each other during current flow. In general, electrodes of the present disclosure may have curved shapes configured to promote broadening (e.g., expanding) of an arc plasma column and an arc footprint on the electrodes, though in at least one direction, such as a direction of relative motion of the electrodes, these electrodes may be substantially flat.

In some implementations, the required electrode area needed to accommodate a certain maximum arc conductor or switch current may be estimated with the assistance of Eqn. 3. Cathode arc spots may tend to avoid each other and maintain a certain distance of closest approach, d_{spot,min}. Thus [d_{spot,min}]⁻² gives an estimate of the maximum number of cathode spots per unit area of cathode surface achievable. From this and Eqn. 3 one can estimate the required cathode electrode size. However, at extremely high switch currents or longer conduction event durations (>10 ms, >100 ms, >1 s or longer), the near-surface heating of the cathode may achieve a temperature at which cathode arc attachment becomes dominated by physical phenomena other than cold-cathode spot attachment.

The arc length l_{arc} is of equal concern as the characteristic width d_{chan} of the arc column, for stability of one or more ionized-metal-vapor plasma columns through a high-pressure (˜1 atm) dielectric medium. The arc length is generally identified as the cathode-anode electrode spacing. Defining a coordinate system with the z-direction pointing from cathode to anode, there may be cooling of the plasma in the arc column by losses to the dielectric medium and recombination of charged particles in the column plasma also assisted by contact with the medium. This may tend to reduce P_{chan}(z) as z increases but instead d_{chan}(z) may decrease (Charle's Law) to keep Eqn. 14 an approximate equality. If d_{chan}(z) decreases too much before z=l_{arc}, that is, before attachment of the arc plasma column to the anode, a high-voltage spark instability may develop. The “tendril” of highly conductive metal plasma, if truncated close to the anode but not electrically attached to it, may behave like a needle or sharp point and may enable a spark between it and the anode by a combination of field-emission and dielectric breakdown of the medium at high field. This assumes that the electric potential between cathode and anode can rise to high voltage (100s or 1000s of volts or more) in the absence of a low-impedance arc nearly short-circuiting the cathode and anode. This may be the case in one or more applications of the present disclosure, since there may be a transfer of large quantities of electrical energy between high-voltage capacitors. An effect of such a spark may be to re-heat the arc plasma column and re-establish a low-impedance arc column between anode and cathode. A spark may also have the effect of blowing apart the metal vapor plasma of the arc column thus destroying it permanently. A high-voltage spark may also vaporize and ionize some electrode material and thus re-strike an arc. Note that this scenario of a low-impedance arc plasma column deteriorating into a spark may only happen if the cathode-to-anode voltage is not otherwise “clamped” to low voltages (the 2 to 50 volts considered advantageous in the present disclosure). The cathode-to-anode voltage may indeed be clamped if there are multiple arc plasma columns connecting the cathode and anode, as was mentioned above. In that case, if one arc column develops too small a d_{chan} size, it may simply die out rather than give rise to a spark. If there is only one metal vapor plasma column forming the arc contact between cathode and anode, there may exist a set of criteria for stability of that column. Whether one or many arc columns exist, an arc length l_{arc} may be selected according to the above criteria, and others such as may become recognized, in order to desirably avoid spark instabilities and to promote a continuously-burning, low-voltage and low-impedance arc discharge.

There may be a certain ratio f_{low} of an arc plasma column characteristic width d_{chan} to an arc length l_{arc} above which the arc column may be stable in a high-pressure medium (˜1 atm) and may have high conductivity and low impedance.

d_{chan}/l_{arc}≧f_{low} 17)

From Eqn. 16, whether for a single arc column or in the aggregate for multiple arc columns, the total time-averaged cross-sectional area A_{chan} of arc column, where approximately A_{chan}∝[d_{chan}]², may increase as total arc current increases. A similar expression as Eqn. 17 for arc column stability could be developed substituting A_{chan} in place of d_{chan}. Therefore another condition for arc stability at low electrical impedance in a high-pressure medium is

l_{arc,maximum}∝[I_{arc}]ⁿ, 18)

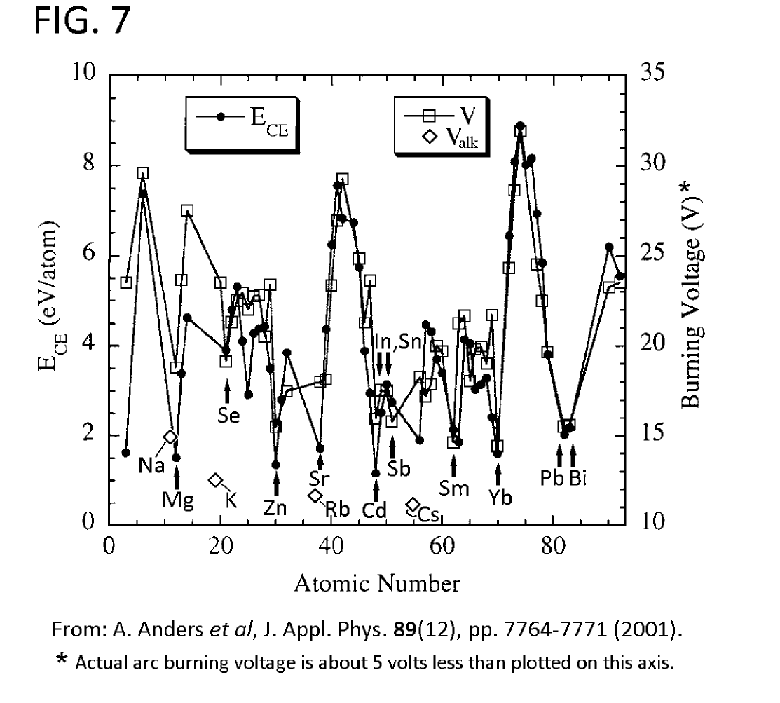

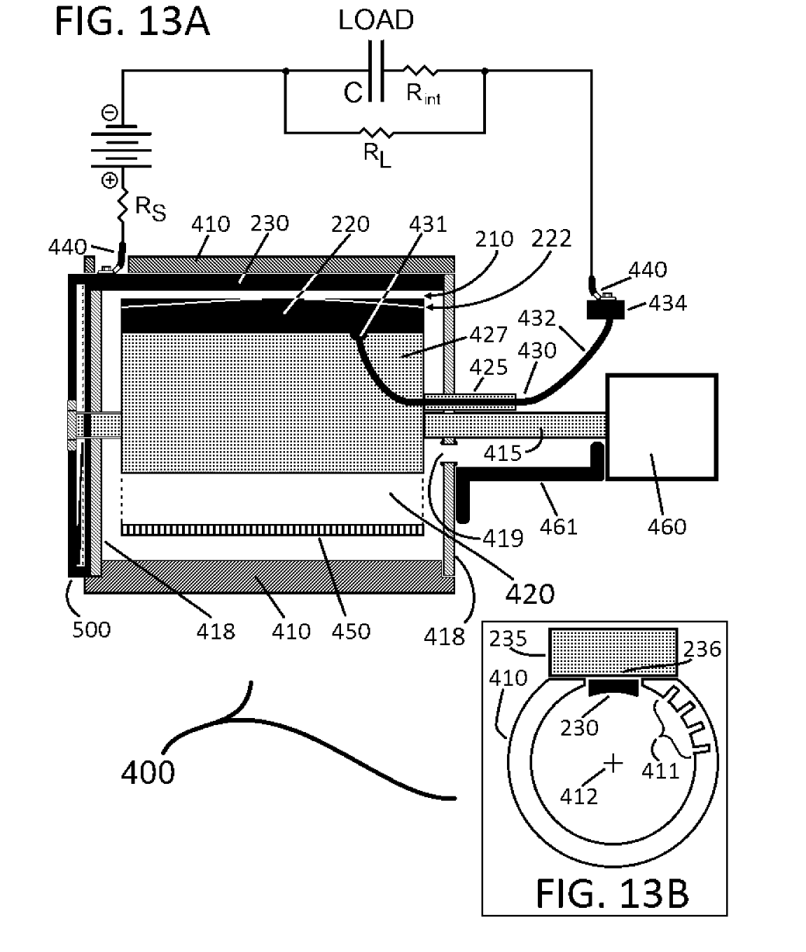

in view of Eqn. 16, that is, the maximum stable arc length increases with arc current. There appears to be no loss of stability if arc length is shorter, provided that, e.g., the sheath, pre-sheath, plasma jets and initial arc column structures shown in FIGS. 2, 6A and 6B are not mechanically infringed (and the electrodes do not actually touch). Note that a single value of exponent n and the functional form of Eqn. 18, may not be valid over the entire range of possible arc lengths and arc currents, due to different physical phenomena becoming dominant under different electrode separations (gap length) and other conditions. Eqn. 18 is an indication of qualitative trends. An example from the field of GTAW is the work of R. Sarrafi and R. Kovacevic, “Cathodic cleaning of oxides from aluminum surface by variable-polarity arc”, Welding J. Research Supplement 89, pp. 1s-10s (January 2010). Arc currents from 90 to 180 amperes (A) were used in DCEP (direct current, electrode positive polarity) mode, meaning that the cathode (welding workpiece) may be broad and substantially flat, as proposed in the present disclosure. From Sarrafi's FIGS. 7 and 13, d_{chan} for the central, hottest portion of the arc column may be 3 to 5 mm, and l_{arc} was 3 mm. Therefore f_{low} from Eqn. 17 was ≦1 since an actual ratio d_{chan}/l_{arc}=1 was achieved with good stability. A useful indicator to compare with Eqns. 16, 17 and 18 is the arc current density in the column, which is Φ_{arc,chan}=I_{arc}/A_{chan}.

In some implementations, arc-enhancing materials may be used. An arc enhancing material may be favorable for sustaining, e.g., cold cathode arc spots. This means that cathode spots may exist with lower arc current per spot and at lower arc voltage overall. A material having these arc-enhancing properties has, among other characteristics, a low cohesive energy of the atoms in the solid, low ionization energy and large cross-section for electron-impact ionization of the free atoms in the vapor phase. The low cohesive energy may (or may not) be accompanied by a low melting temperature, low boiling temperature and a high vapor pressure of the arcing solid. The resulting arc plasma channel (or column) connecting cathode spots to an anode is characterized by high plasma density, low electron temperature, high current-conducting capacity and low plasma impedance. Together, arc spots burning on arc-enhancing materials and the plasma columns they produce tend to provide an arc conductor with low arc burning voltage, as presented to the external circuit being served by the arc conductor. This low arc burning voltage is a desired, though not limiting, mode of arcing for practicing the disclosure. For an example of the opposite, some aspects of some implementations of the disclosure make use of materials that cause a higher arc burning voltage, which may be called arc-limiting materials. An arc may preferentially burn on an electrode comprising arc-enhancing material rather than on a surface comprising arc-limiting material. As used herein, an arc-limiting material may either be a) a perfectly good electrical conductor that is readily able to sustain an arc, just at a few volts higher arc voltage than an arc-enhancing material, or b) an insulator or other surface unsuitable for arcing except under extreme conditions (undesirably high arc voltage of 100s or 1000s of volts). The tendency for an arc to preferentially burn on an arc enhancing material means that, unless otherwise prevented, an arc burning on an arc-limiting material may “jump” to burn on nearby arc-enhancing material(s). This arc jumping or “transfer” phenomenon may be mediated or influenced by an arc propensity contrast between arc-enhancing materials and arc-limiting materials and may be used in certain aspects and implementations of the disclosure.

Turning now to an explanation of arc-enhancing and arc-limiting materials, most of the pure elements have been surveyed and found that cohesive energy E_{CE} of the solid correlates well with arc burning voltage V_{arc} or V_{arc,min}. By “solid” is meant generally a cathode electrode material upon which an arc is sustained at less than thermionic electron emission temperatures via cold-cathode arcing. FIG. 7 summarizes those results. According to principles of the disclosure, we define an arc-enhancing material as one that lies (or may lie if it were measured and included) generally lower on the vertical axes of the plot of FIG. 7. We define an arc-limiting material as one that lies (or may lie if it were measured and included) generally higher on the vertical axes of the plot of FIG. 7. There may be some substances that lie in between these extremes, so an arc propensity property that may vary among materials is contemplated. Moreover, E_{CE} may not always correlate perfectly with V_{arc}, even among the pure elements. An arc enhancing material is specifically favorable for sustaining cathode arc spots. Cathode spots may exist with lower arc current per spot and a lower arc voltage overall. A material having arc-sustaining properties may have, among other characteristics, a high tendency to vaporize atoms off of or out of the solid, low atomic ionization energy and large cross-section for electron-impact ionization of the free atoms in the vapor phase. A high number density of positive metal ions is readily produced. Generally, less electrical power per cathode spot is required to sustain arc burning. Microscopic arc jets of metal vapor from arc spots may have lower jet velocity, though may be supersonic. A resulting arc plasma channel (or column) electrically connecting cathode spots to an anode may be characterized by high plasma density, low electron temperature, high current-conducting capability and low plasma resistance. We classify as arc-enhancing, without limitation, at least the elements Mg, Se, Sr, Zn, Cd, In, Sn, Sb, Sm, Yb, Pb and Bi, their alloys, alloys of these with other elements and selected composites, aggregates and special forms incorporating them. This list is not limiting for the purposes of the present disclosure, since there are other elements having values close to those listed and since various alloys of the listed metals (for example Woods metal, various low-temperature solder and eutectic compositions) and alloys with elements not listed, even non-metals, may have favorable arcing properties. A special class of super arc-enhancing materials is the alkali metals (Li), Na, K, Rb and Cs. The last four of these have been added to the plot of FIG. 7, as open diamond-shaped symbols (⋄). Note that actual arc burning voltages are about 5 volts less than plotted in FIG. 7, so 5 volts may be added to the V_{arc} values for Na, K, Rb and Cs for the sake of comparability with other elements on the chart. The true cold-cathodic V_{arc} values for Na, K, Rb and Cs are approximately 10.0, 7.4, 6.8 and 6.2 volts, respectively. Although the alkali metals are difficult to handle because extreme chemical reactivity and even combustion in air, a variety of alkali-metal compounds may be excellent arc enhancing materials. These compounds include at least alloys/composites of the alkali metals with the other arc-enhancing metals listed above, alkali-metal hydrides (XH) and alkali-metal oxides (X₂O, XO₂ and X₂O₂, where X=Li, Na, K, Rb or Cs). These alkali-metal compounds may decompose under the action of an arc, liberating free alkali metal atoms which then participate as super-arc-enhancing atoms. Such free alkali metal atoms may vaporize, participate in the arc plasma, re-condense on an electrode surface, re-vaporize and so forth repeatedly, thus being “recycled” in the arc gap and reused with an effectiveness far in excess of the actual population or mass of material present. Even though an alkali metal atom may deposit on the anode, an anode typically becomes hot enough to vaporize the atom again, which may lead to its deposition on the cathode, where it may perform an arc-enhancing function again. Even sub-monolayer to few monolayer quantities of adsorbates such as alkali metals and oxides on electrodes may strongly affect arc propagation and burning behavior through properties such as arc spot migration speed, change of local work function, charge trapping or polarization, change of a surface energy, modification of a sputtering yield, modification of a secondary electron coefficient and other effects. After completion of an arc conduction event, highly chemically reactive species, such as the alkali metals and several of the other arc-enhancing materials, may be reacted with oxygen from the air ambient and immobilized as solid oxides in the arc gap. Such oxides are then readily decomposed by the next arc or plasma conduction event, thereby liberating the alkali metal or other arc-enhancing atoms to once again be used in propagation and burning of an arc. In example cases in which an electrode may be fabricated of a solid body or thick layer of arc-enhancing material, and this material is oxygen-reactive, generally the oxide growth is self-limiting in thickness and stoichiometry so that the oxide does not become a good electrical insulator and therefore does not interfere with arcing.

Arc-enhancing materials may promote efficient and rapid expansion or spreading of a width or area of an arc column during propagation of an arc to fill an arc gap. The low arc current per spot for arc-enhancing materials may lead to proliferation of many spots, which gives an opportunity for spot mobility and spreading out, since spots repel each other to a certain degree due to mutual interaction of their self-current magnetic fields. Also, arc jets from arc-enhancing materials may produce copious quantities of metal vapor having relatively low ionization potential and high ionization cross-section, at least for the higher-Z atoms. The large production of metal vapor helps displace air or other medium in the arc gap, which generally may not be as readily ionized as metal vapor.

In some implementations, Arc-limiting materials may include, e.g., Be, C, Si, Nb, Mo, Hf, Ta and W, their alloys and compounds. Many of the common structural metals, their alloys and many of the solid-solid contact metals, such as Al, Ti, Fe, Ni, Cu, Zr, Ag and Au, are also arc-limiting compared to the basic group of arc-enhancing materials: Mg, Se, Sr, Zn, Cd, In, Sn, Sb, Sm, Yb, Pb and Bi. The arc propensity contrast between these three groups is substantial. Approximately 5 volts difference in V_{arc} and >2 eV/atom difference in E_{CE} separates each group from its nearest other group. Since arcs comprise 10² to 10⁹ or more amperes, a 5 volt difference in V_{arc} translates into a 500 watt to 5 GW (giga-watt) difference in electrical power expended in the arc. At I_{arc} between 10⁸ to 10⁹ A, each second I_{arc}/e≈N_{Avogadro} of vaporized atoms and ions may be involved in the arc, which at an E_{CE} difference of 2 eV/atom translates into ≈0.2 MJ difference in electrical energy required merely to extract atoms from the arc electrodes. Here e is the electronic charge and N_{Avogadro} is Avogadro's number. Some implementations of the disclosure may use this effect to transfer a spark between arc-limiting Ni, Ag, Au or other solid-solid contact metals into an arc in an arc gap comprised of arc-enhancing Zn, Sn, Bi or other materials.

TABLE 1

| | | | |
|---|---|---|---|
| | | Enthalpy of | Cohesive |
| Chemical | | Formation | Energy |
| Formula | m.p. [° C.] | [kJ/mol] | [kJ/mol] |

Oxides of Arc-Enhancing Metals, Low Cohesive Energy

| | | |
|---|---|---|
| PbO | 888 | −219.41 |
| PbO2 | 290 | −274.47 |
| Pb2O3 | 530 | |
| Pb3O4 | 830 | −718.69 |
| SnO | 1080 | −280.71 |
| SnO2 | 1630 | −577.63 |
| ZnO | 1800 | −350.46 |
| ZnO2 | 150 | |
| MgO | 2830 | 601.24 |
| MgO2 | 100 | |
| Bi2O3 | 817 | |
| SeO2 | 340 | |
| SeO3 | 118 | |
| CdO | 1500 | −258.35 |
| CdO2 | 200 | |
| InO | | |
| In2O3 | 1913 | |
| Sb2O3 | 655 | |
| Sb2O5 | 380 | |
| Sm2O3 | 2335 | |
| Yb2O3 | 2435 | |

Refractory oxides

| | | |
|---|---|---|
| Al2O3 | 2054 | −1675.70 |
| TiO2 | 1800 | −944.00 |
| Ta2O5 | 1880 | −2045.98 |
| SiO2 | 1710 | −910.86 |
| ZrO2 | 2677 | −1097.46 |
| HfO2 | 2774 | |

Structural materials

| | | |
|---|---|---|
| Cu | 1084.62 | |
| CuO | 1336 | −156.06 |
| Cu2O | 1230 | −170.71 |
| Ni | 1455 | |
| NiO | 1960 | |
| Ni2O3 | 600 | |

In some implementations, arc-enhancing materials may play an additional role within the present disclosure. In a metal-vapor arc operating at near 1 atm pressure in air, chemical reactions of metal with oxygen in the air may be inevitable. These are of little concern during actual burning of intense arcs because most oxide reaction products may not be stable at arcing temperatures, and air is mostly excluded by the arc so such reactions are a minority process anyway. However, as an arc is extinguished, air may return and bring oxygen which may react with hot electrode surfaces and fresh metal-vapor deposits. Oxide layers may form which may make striking an arc difficult the next time the switch is used. A related concern is longer-term, ambient-temperature weathering and corrosion of the electrode materials. For both concerns, arc-enhancing materials may be selected that tend to form electrically conductive or semi-conductive oxide layers. These oxide layers may be self-limiting in thickness of their growth, also called “passivating”. Among the elements useful for arc-enhancing materials having low cohesive energy, Mg, Se, Zn, Cd, In, Sn, Sb, Sm, Yb, Pb and Bi, almost all may have modestly conducting or semi-conducting oxides, especially when a) the O-content is lower than in the stoichiometry of the most fully-oxidized compound, b) the atomic structure is amorphous or nanocrystalline, c) the morphology is thin-film or polycrystalline with significant grain boundary disorder or d) the electronic band structure is non-ideal due to impurities, alloying elements, dopants, vacancies, lone-pair electrons and the like. Exactly these sorts of non-ideal oxides do form under the circumstances prevalent in the switch of the present disclosure. Some oxides formed by these low cohesive energy arc-enhancing elements may be relatively unstable, that is, they themselves have one or more of the following properties: low heats of formation, low melting/decomposition temperatures or low cohesive energies. Low stability may mean that high temperatures, electron bombardment, ion sputtering, ultra-violet irradiation and/or other effects associated with exposure to arc plasma may easily decompose these oxides and render them ineffective in inhibiting plasma conduction. Table 1 data shows that indeed oxides of the low-cohesive-energy arc-enhancing elements (metals) have indicators of lower stability than the examples of refractory oxides included; in the cases of ZnO, MgO, In₂O₃, Sm₂O₃ and Yb₂O₃ the oxide melting points are quite high, but it is considered unlikely that any oxide may be fully-formed, so stability may still be low. Experience with two of these, Mg and Bi, has shown that striking of arcs after prior running of arcs and long exposure to air may be easier and these principles may hold not only for the elements listed above but other elements, alloys and compounds with identifiably similar oxidation and oxide characteristics. It is an aspect of the present disclosure that arc-enhancing material is constructed onto the cathode electrode surface but may be distributed to all arcing surfaces, especially including the anode, by plasma jet, thermal evaporation and other arc spot mechanisms, by the action of the arc itself, and thus provide environmental protection for the switch and ease of striking arcs.

In some implementations, another example role of arc-enhancing materials in the present disclosure may be as a striker material. The conductive striker material that short-circuits the anode and cathode to initiate the arc may become vaporized, incorporated into the general inter-electrode metal-vapor plasma and deposited as a metal film on various surfaces of the switch when the arc is extinguished. Initial vaporization of the striker material may be due to Joule heating from anode-to-cathode high current flowing through it. Subsequent heating of striker material may be due to contact with the intensely hot metal vapor of the arc column plasma. Even if unmelted pieces of striker material fall onto the anode or cathode surface, those may become melted, vaporized and incorporated into the general inter-electrode plasma. Even if unmelted pieces of striker material that fell onto the anode or cathode surface do not become fully vaporized during one operational cycle of the switch, they may fuse to the surface and form bumps or protrusions which may attract arc activity in subsequent operational cycles of the switch and may eventually be vaporized and distributed.

The mechanical form, size, diameter, length, mass, cross-section, material resistivity, material heat capacity and so forth of the striker material used to initially strike the arc may be chosen such that the striker may vaporize to a satisfactory degree given the open-circuit voltages, arc power levels, arc duration, arc energies and the like that a particular switch is designed to handle or conduct. It is a convenience feature that a relatively minor, consumable element of the switch, the striker wire or rod, may be swapped out to allow one electrode geometry to work successfully with a wide range of arc power and energy levels.

Vaporized striker material may be used to replenish arc-enhancing material within the switch that may likely be lost to the open sides or edges of the arc gap during repeated use of the switch. A variety of methods of the present disclosure may be used to assure that an adequate quantity of arc-enhancing material is provided to the interior of the switch. Without limitation, some of the methods are multiple strikers, continuous feed of striker material even after the gap arc is fully running and selection of a diameter and mass of the striker component.

In some implementations, an overall curvature of the arc electrodes and their corresponding gap may be provided, where a self-current magnetic constriction of the arc column decreases. This curvature may also include the increasing pattern of gap length l_{arc}(r) with respect to lateral distance r from a location of first arc ignition.

A possible limitation upon scaling up electric current carried by arc conductors and arc apparatus in general may be the self-current magnetic field of arcs. At large arc-conducted currents, e.g., above ˜1 to 10 kA, self-current magnetic constriction of the arc column may occur. Photographs of arc constriction are shown as FIGS. 3A and 3B. Magnetic constriction opposes achieving low arcing voltage by providing large arc footprint on the electrodes and large cross-section arc plasma column(s). Magnetic constriction of any particular arc conductor or arc plasma column may, at high arc currents, lead to high-voltage instabilities and possible splitting of arc columns into concentrated, dense and potentially destructive arc structures. This type of constriction may be one cause of arc flash. This effect may be caused by the magnetic flux produced by a moving charged particle, such as an electron or ion moving generally perpendicular to an electrode across an arc gap. At any point r near a charge q moving at velocity v, the magnetic field (flux density vector field) vector B produced is

B=(μ₀/4π)·(q/r²)·v×r, 19)

where μ₀ is the permeability of vacuum (1.257×10⁻⁶ kg m C⁻² or μ for a non-vacuum medium) and r=|r|, the distance from the charge. Because of the vector cross product, the resultant lines of flux form circles around the direction of motion v with the plane of the circles perpendicular to it. If a multiplicity of charged particles move in a time sequence along a path through a plasma, this is an electrical current, and lines of magnetic flux form similar circles around and perpendicular to that current path. One might say the successive flux circles around a current path form a flux tube, but the flux direction is perpendicular to the long-direction of the path. When two or more current paths lie near each other, neighboring flux circles sum-and-cancel according to their local direction at overlap. The resultant or net field is the origin of the self-current magnetic field of arcs, and it operates all the way from the individual arc spot scale up to the largest scales. In a typical flat, planar arc gap, most of these current paths are parallel to each other. The flux circles around these paths mostly cancel interior to the arc column, and the resultant field looks like a big flux circle (or flux tube) around the whole arc column, the plane of said circle being perpendicular to the direction of flow of charges in the arc gap. Because of this net self-current magnetic field, individual moving charges near the edge of the arc column experience an additional force F substantially equal to the magnetic term of the Lorentz force

F=q·v×B. 20)

This force accelerates electrons in the arc plasma much more strongly than heavy ions, and the average effect is to oppose electron motion laterally out of the arc column and urge motion laterally toward the center of the arc column. Because of space-charge effects, positive ions may not migrate where electrons cannot accompany them, so the arc plasma may not expand laterally. At still higher arc electric currents the arc column actually gets narrower, and this is the origin of the magnetic constriction of arcs at high arc current. As mentioned, such lateral constriction of an arc column may not be preferred for cases in which very rapid expansion of an arc column is desired, but it may be used to good effect in several ways, if due care is exercised to avoid excessive constriction of the arc with possible subsequent high-voltage arc instabilities. Arc constriction due to self-current magnetic fields may be counteracted within the disclosure by several methods. For example, segmented electrodes of opposite-polarity tiles may be used where these self-fields cancel laterally. Additionally/alternatively, the use of a bucking or counter-wound electromagnet coil(s) energized by the current through the arc conductor may be beneficial. In some implementations, at least one of the arc electrodes may be curved and thus curving the paths of charged particle motion and current flow between electrodes such that their magnetic fields do not sum-and-cancel to form resultant magnetic fields which are detrimental to broadening of arc column area or expansion of arc footprint on an electrode(s). Those skilled in the art will appreciate that other methods may also exist and are contemplated.

Another example role of arc-enhancing materials may be as damage-mitigating, anti-seize/weld and arc re-striking layers on the electrodes in case the electrodes touch each other while electrically energized or very hot. Some arc-enhancing materials listed above and in FIG. 7 having low cohesive energy are Mg, Se, Zn, Cd, In, Sn, Sb, Sm, Yb, Pb and Bi. This list is not limiting. These materials, by fact of having low cohesive energy, are relatively weak and malleable. A possible exception is Mg, which may be hard and brittle due to impurities and metallurgical tendencies. As a byproduct of switch operation, portions of the arc electrodes of the switch may become coated with vapor-deposited layers of a chosen arc-enhancing material. The arc electrodes may be configured to move or translate relative to each other in close but non-contacting proximity. While a particular path may be desired, significant deviation from the ideal translation path may be tolerated while still permitting excellent functioning of the switch. In such cases, the electrodes may momentarily collide or rub together at substantial speed. Relatively soft and slippery arc-enhancing material layers existing on the electrode surfaces that are closest together, the surfaces most likely to touch, provide at least the following benefits. They do not transfer severe mechanical shock forces to structural components of the switch or the devices the switch serves. They may partially fuse or weld together but the bond is easily broken and does not substantially impede relative motion of the electrodes. The touching of electrodes may quench the arc in the switch, but the subsequent separation of the electrodes creates a drawn arc which readily re-ignites the main current-conducting and energy-transferring arc in the switch. Another form of electrode damage may be pitting or the like due to high-voltage sparks occurring during arc ignition or fault conditions; the continual redistribution of arc-enhancing material within the switch tends to make the electrodes “self-healing” or self-repairing.

Many known conventional, prior art means of initiating an arc and of extinguishing the arc may be used with an arc conductor of the disclosure. For example, a pair of parabolically-curved electrodes between which an arc is ignited (e.g., struck) by insertion of a conductive gap-breakdown material. As another example, a hollow cylindrical outer arc electrode and an off-center rotatable inner arc electrode having a spring-loaded lobe which strikes the inside of the outer electrode, thus drawing and initiating an arc. Regarding extinguishing arcs, an example application circuit may include either an electrical power source or an electrical load with an arc conductor in series between them with source or load configured such that the arc is self-extinguishing after circuit-making or breaking surge currents or high voltage transients subside. An arc conductor of the disclosure may self-extinguish if the circuit voltage across the arc gap decreases below about 10 volts or a current drawn by the external circuit decreases below about 10 A, by way of example and not limitation. A charged capacitor is an example of an electrical power source and a discharged capacitor is an example of an electrical load from/to which only a fixed amount of charge may be transferred, so that the arc is self-extinguishing. Further regarding extinguishing arcs, various implementations of the disclosure may be advantageously combined, such as electrode separation, arc chutes, magnetic deflection and quenching due to the arc medium. These are examples only and not meant to limit the scope of the disclosure.

Some implementations may be used as arc assistors, to protect switches known to be susceptible to high current surges, high voltage transients, high dissipated power or heat and other limitations described above. Surge or in-rush currents and high voltage transients in electrical circuits may be conducted or shunted by electric arcs. Switchgear embodying the principles of the disclosure use arc conductors which are substantially undamaged by arc-conduction of current surges and voltage transients associated with the making and breaking of a circuit. Arc conduction according to the disclosure may also be used to protect other circuit components besides switchgear, such as semiconductors, connectors, sliding contacts, batteries, lamps, resistors, and so forth, without limitation, by shunting high current around such components or clamping high voltage transients to substantially equal the arc burning voltage. Additionally, current surges or voltage transients may be conducted by arcs according to the disclosure whether the surges or transients originate from circuit switching or from another cause, such as, without limitation, change in the electrical supply, change in the electrical load, magnetic induction or electromagnetic pulses (EMP).

In some implementations, an arc conductor of the disclosure may serve as substantially the only conductor in a switch. In one or more other implementations, an arc conductor of the disclosure may serve as the principal conductor of a switch substantially during making and/or breaking of a circuit while other contact or conduction means serve as the conductor during long-term closure of the circuit. For this type of implementation, an example is given of an arc conductor of the disclosure residing in a separate device, a switch assistor, which serves a commercial off-the-shelf (COTS) switch by acting as the principal conductor substantially during making and/or breaking of a circuit while the COTS switch serves as the conductor during long-term closure of the circuit. In this implementation, an arc conductor of the disclosure shunts or bypasses, and thus protects, the switch from surge or in-rush currents and high voltage transients that may occur during or related to switching. Both mechanical-contact switches and semiconductor (solid-state) switches may used with an arc conductor (switch assistor) of the disclosure. In combination with known high-current semiconductor switches, which may often be parallel-connected gangs of semiconductor junctions, the shunt or bypass function of the disclosure may protect from unequal sharing of current among the several junctions during turn-on and turn-off. Runaway conduction by one of the parallel-connected junctions, which may result in its failure, formerly may have required careful matching of the junctions or elaborate control circuitry, which now may be eliminated in part or in whole because of arc shunting during turn-on and/or turn-off.

In some implementations where an arc gap is in electrical parallel relation to a closed and conducting prior art switch, and it is desired to protect the switch with an arc conductor while opening the switch, further aspects of the disclosure may include one ore more apparatus and/or methods to initiate an arc across an arc gap which is short-circuited to nearly zero voltage by the closed switch. One example implementation may employs a variable resistor to increase the voltage across an arc gap so that an arc can be struck (e.g., ignited) and established. A two-valued variable resistor that may include a helical spiral-wound sheet metal strip and/or accordion-folds of sheet metal may optionally form the resistor and be mechanically coupled to a drawn-arc ignition mechanism. In this way an arc may be already burning before beginning to open the switch. In another example implementation, the conventional switch may be a semiconductor device such as a transistor, where the voltage across the arc gap may be increased by putting the semiconductor junction into a state of partial conduction, after which an arc may be ignited in the arc gap, and after which the semiconductor switch may be opened.

In one or more implementations, the ruggedness, damage resistance, robust operational characteristics, simple construction and ease of scaling to large size of arc conductor components are advantageous and beneficial characteristics. The phenomena of arc spots on an arc cathode, ion bombardment, electron bombardment and intense heating, among others, are indeed “destructive” of at least an outer layer of material on arc electrodes. These lead to pitting of an electrode surface, ion sputtering, erosion of material, vaporization of material and thermal annealing or breakdown of material structures and chemistries, among other possible end effects. However, these are not substantially destructive of the function of arc electrodes or an arc gap. For example, pitting and roughening of arc electrodes are not a problem since a) locally flat electrode surfaces are not used for any function (such as solid-solid current conduction), b) the roughened surface may actually encourage arc activity and c) the roughening is self-limiting because the protruding asperities on electrode surfaces attract arc activity thus becoming eroded or melted flatter. As another example, erosion, vaporization, macroparticle ejection and “arc jetting” of material away from arc electrodes do ultimately restrict a usable lifetime of an electrode, but, according to optional aspects of the disclosure, this loss of material is drastically slowed by exchange of material back-and-forth between large-area, closely-spaced electrodes and may actually be used to disperse arc-enhancing materials over desired arcing surfaces. Also, eroded electrodes may be readily replenished by addition of material (which gets dispersed, as said) and by easy replacement of arc electrode inserts. In an open arc, that is, a vacuum arc in which the cathode and anode are far separated, cathode vaporization has been reported to be on the order of 10 μg/C, as measured by weight loss, but as mentioned this may be significantly reduced by “recycling” material within the relatively closed arc gaps of the disclosure. Generally, arc electrodes and their arcing surfaces comprise relatively simple bulk shapes of well-behaved, rugged solid materials. The function of arc gaps comprising such electrodes is not particularly sensitive to variations, distortions or other changes in the geometry or spacing of such electrodes; e.g., +/−1 mm changes of dimensions may normally be insignificant. Hence the operation of an arc gap is robust and tolerant of aging and wear of electrodes. For these reasons and because of the intense energies liberated in an arc gap, minor (e.g., <1 mm thick) contamination by dust, water, grease/oil and other incidental environmental debris may normally not permanently affect arc operation, but rather the foreign matter may be destroyed or burned away. Scaling up of an arc gap is often as simple as enlarging a plate or pipe section. Due attention may be paid to transport of electrical current and heat to/from an electrode and its mechanical support structure. Likewise, cooling of electrodes may be designed, and this may involve considerations of thermal conductivity and conductive cross-sections of electrodes and supports. Arc hardware may be robust and tolerant of modest under-design or operational overloads, even to the extent of partially melting or gravitational slumping of heat-softened electrodes; in such a case, the arc conductor may continue to work and even repair itself via redistribution of arcing material within the arc gap. As those skilled in the art of arcing may appreciate, the above list of characteristics of arcs and arc apparatus is not exhaustive but intended to be indicative of the relative ease by which arc conductors may be made rugged, damage resistant, operationally robust, simple and scaled to large size. By contrast, currently known switches in which arcing is an unwanted phenomenon on solid-solid conductor contacts, may have a very difficult effort to maintain good switch contact properties in the presence of arcs. FIG. 5B illustrates arc damage on 63 to 550 A contacts and an arc horn of a large contactor in which many such contact pairs operating in unison are required make, conduct and break, e.g., 1000 to 5000 A currents in 1000 to 2000 volt circuits. Clearly arcs, even though transferred by arc horns to arc chutes away from the contacts, do extensive damage to the solid-solid conductive junction and require frequent expensive human maintenance intervention. If scaled to mega-ampere currents in 10,000 v and higher circuits, such known devices may most likely become prohibitively bulky, complex and expensive.

Arc conductors may include arcs burning over broad surface areas of arc electrodes (e.g., the arc attachment footprint) with concomitantly broad arc plasma columns. For non-thermionic cathodes, the terms broad arc attachment area and broad arc footprint area may be described generally to include the entire macroscopic region of the cathode surface having significant numbers of cathode spots persisting over many spot lifetimes, not the cathode attachment at a microscopic cathode spot nor even the sum of the areas of all such microscopic spots. Broad-burning arcs may conduct large circuit currents via mechanisms such as explained relative to Eqn. 1, among possibly other mechanisms. Broad-burning arcs may provide low arc burning voltage and hence low power loss or energy waste in the arc conductor. High arc current and low arc voltage is consistent with a low arc impedance or resistance.

In some implementations, the time-domain dynamics of arc conductors may be managed. The shape of the arc electrodes, at least in part, may promote both lateral spatial expansion of an area of an arc footprint on an electrode, along with the area of its associated arc plasma column, and time-domain stabilization of an arc in an arc gap. Both of these desirable, promoted properties may work within a single current pulse or conduction event of an arc gap. That is, an arc may be initiated at one or more small, localized positions on an arc electrode or in an arc gap, then grow or expand to more fully fill the arc gap. Also, once burning over a broad area, an arc is desirably time-stable with respect to low average arc voltage and high average current density conducting capability. Similarly, when the arc current driven by the external circuit is decreasing, the arc column and arc footprint may contract without time-instability, on-average, while maintaining low average arc voltage and high average current density. Note the term “average” is used to denote a time-average in explicit recognition of the often-observed phenomenon that many features of arcs may be relatively unstable on a short time scale, such as sub-microseconds to tens of milliseconds or more, without limitation. By “time-stable”, it is meant sustained properties substantially as described over periods of, e.g., 10 μs to 10 s. Thus, a provided voltage between the first and second electrode may be less than or equal to 50 volts, when time-averaged as described.

By contrast, the opposite case may be undesirable. If the external circuit being served by an arc conductor is capable of sustained high voltages and comprises large stored energy or high electrical generating power, then the absence of some or all of the attributes discussed above may result in very damaging conditions for the arc conductor and possibly surrounding areas. An absence of these attributes may imply, at least, a concentrated arc footprint area and/or arc column area and a high arcing voltage. The absence may also imply time-transient (shorter that time-sustained) impulses of current which do not, among other things, deposit sufficient heat into broad electrode surface areas to vaporize metal atoms or allow sufficient time for required arc plasma column structures (e.g., cathode spot jets, a cathode plasma sheath, a pre-sheath ionization zone and an anode plasma column) to become established and facilitate low-voltage arc burning. If under these undesirable conditions, high electrical currents are forced through the arc gap, then large electrical power and high quantities of electrical energy may be undesirably deposited in the arc conductor apparatus, as opposed to being desirably deposited in the circuit load or desirably cut off altogether (e.g., disconnected). Such undesirable and potentially destructive arcing modes may be of several types, but at least one likely mode is an “arc flash”.

In some implementations, the present disclosure may provide arc conductors which avoid any type of arc flash or destructive arcing mode, but possible occurrence of fault conditions or equipment misuse may suggest that arc conductor equipment implementations of the present disclosure may be evaluated therefore. Thus, after the arc is established between the first and second electrode, the arc conductor may sustain continuously over time, as long as the arc current is increasing, an expansion of the arc footprint and arc column, wherein the expansion of the arc footprint and arc column may exclude pulsation to zero current, chopping, flicker to zero current, spark instability, plasma extinction and re-ignition, fluctuation to zero current and any time-domain instability of the arc involving the arc current becoming zero. Likewise, after the arc is established between the first and second electrode, the arc conductor may sustain continuously over time, as long as the arc current is decreasing, a contraction of the arc footprint and arc column, wherein the contraction of the arc footprint and arc column may exclude pulsation to zero current, chopping, flicker to zero current, spark instability, plasma extinction and re-ignition, fluctuation to zero current and any time-domain instability of the arc involving the arc current becoming zero.

Broad-burning low-voltage arcs and desirable spatial and time-domain dynamics of an arc in an arc conductor may be promoted. However, not all aspects are and no single aspect is necessary in any one desirable implementation. One specific aspect is the already-explained action of arc-enhancing electrode materials concerning low arc voltage. The basic process of arc column broadening consists of energy from the external circuit deposited or absorbed at a localized first arc ignition location(s) in the arc gap being used to vaporize electrode material which is, in turn, ionized, heated and spread throughout the arc gap, thereby both expanding the burning arc and displacing or pushing out the former medium in the arc gap, usually air. The process is in some sense a feed-forward or positive-reinforcement process, because the newly ionized metal vapor and burning arc zones conduct even more current and absorb even more energy from the external circuit, thereby vaporizing increasingly more electrode material and creating yet more intra-gap plasma. This may happen very quickly (e.g., <<1 s), because, with cold-cathode arcs, there is no delay while waiting for bulk electrodes to heat up. This rapid feed-forward lateral expansion of the arc may be desired. Indeed, it cannot, or at least may not, be stopped, because there is risk of dielectric breakdown, sparks or high voltage flashes, if high circuit potentials could exist across the gap of the arc conductor. Such localized high voltage breakdowns are disfavored because they may be transient and/or may have mobile localized or filamentary electrode attachments. Arc modes such as these may not deposit enough sustained and broad-area power on the electrodes to vaporize sufficient electrode material to create or sustain a broad-area, quiescent, stable arc of arbitrarily-long time duration.

In some implementations, the arc may be anchored at a fixed location or region on the electrodes, as described below. This arc anchor location may also be the location of first ignition of the arc and ideally stays within the footprint of the arc column as it broadens. A number of example principles and aspects of the disclosure are enumerated below regarding rapid feed-forward lateral expansion of an arc in an arc conductor, along with means of controlling a rate of expansion. The feed-forward lateral expansion of the arc may stop when the external circuit can no longer provide more current, though in one or more implementations a rate of arc expansion may be controlled, modified or carefully limited. This means that an impedance of either the external circuit's source or load may limit the current through the arc conductor. In some implementations of the disclosure, the impedance of the arc conductor may be negligibly small compared to the impedances of the external circuit. However, during a surge of current after an arc is established between the electrodes, the arc gap may be the limiting impedance, and this impedance is adjustable according to principles of the disclosure. Principally, the impedance of the arc gap is determined by a lateral extent or a cross-sectional area (the already-achieved degree of expansion) of the arc column and/or arc footprint upon the electrodes within the gap. Examining Eqn. 1, an arc of smaller footprint may have a smaller value of Nₛₚₒₜₛ which may result in a larger R_{arc}, and conversely an arc of larger footprint may have a larger value of Nₛₚₒₜₛ and may present a smaller R_{arc} to the external circuit. Moreover, at any given footprint area, both the absolute arc resistance and also a rate of change of this arc resistance are adjustable, within a range. An absolute resistance of an arc in an arc gap may be adjustable by selecting a burning voltage of the arc, among possibly other means. This voltage may be influenced by parameters such as the length of the arc gap (e.g., arc length), several properties of the medium in the arc gap (e.g., such as electron affinity and heat capacity), external magnetic fields imposed in or near the arc gap, and, as described above, selection of electrode materials as arc-enhancing or arc-limiting. A rate of change of arc resistance may be adjustable by selecting a rate of expansion of the burning arc within the arc gap, among possibly other means. This rate of expansion may be influenced by the same parameters as affect arc resistance, plus others. This rate of expansion may also be influenced by surface chemical reactions and compounds at electrode surfaces, a variation in a length of the arc gap across an arc electrode, other properties of the medium in the arc gap (such as tendency to chemically react with electrode surfaces) and placement or injection of temporary modifiers to arc-enhancing or arc-limiting properties of the arc gap, among possibly other means. In general, these additional influences upon rate of expansion of the burning arc may have little or no effect on the absolute resistance of the arc after full expansion of the arc column has occurred. It may be desirable to extend a desired mode of arcing to a desired range of arc conductor operational parameters.

In some implementations, how cold-cathode arcs expand in intensity (e.g., arc column area) or increase in arc current over time may be envisioned as: 1) an arc gap completely filling its electrode area with arc plasma “instantly” at a low current density Φ_{arc,low} [MA/m²], then Φ_{arc}(t) increases everywhere over time; and 2) an arc gap starts with a small patch of its electrode area filled with arc plasma at a characteristic, nearly maximum current density Φ_{arc,char}, then the size of the patch expands over time to fill all the electrode area. Regarding 2) above, this mode of expansion may be urged by providing an arc gap having broad-area electrodes, varying arc gap lengths as a function of lateral location within that broad gap area, a location of minimum gap length, smoothly increasing gap length as a function of lateral position away from the location of minimum gap length and an first arc ignition location substantially the same as the location of minimum gap. An impedance of an arc may be lower when gap length is shorter, and an arc may burn preferentially at this location of shorter gap. If there is adequate driving potential and supply of electric charge, the arc may increase in plasma density or charge carrier mobility until Φ_{arc} reaches some value, Φ_{arc,expand}, at which it may be energetically “cheaper” (that is, provides a lower impedance current path) to expand a breadth or area of the patch of burning arc rather than increasing Φ_{arc} still higher.

A direction of lateral expansion of a patch of burning arc may be controlled, or at least urged, by gap lengths. The arc patch may first expand in a direction of least slope of increase in gap length. As an example of an arc propagation or expansion calculation by which an arc conductor may be matched to a given external circuit in its rate-of-rise of conducted current after arc establishment, consider a case in which the slope of increase of gap length is the same for 360° around the first arc ignition location; that is, the arc patch may expand as a circle. Assuming for example purposes only the arc is driven by a high-energy (high-voltage) circuit that could supply current with unlimitedly high dI_{source}/dt, then a dI_{arc}/dt may be limited by some arc propagation speed, c_{arc-prop}. A speed of arc propagation may be modulated or controlled as, or at least likened to, a plasma “front” moving into the un-ionized medium that filled the arc gap before arc ignition. The speed of movement of such plasma front, c_{arc-prop}, may be limited by a speed of sound, by a cathode spot migration speed or by other parameters, such as ambipolar electron and ion diffusion constants, Dₑ and Dᵢ. Given the likely violent and energetic nature of an initial dielectric breakdown of a high-voltage arc gap, a diffusive model is considered unlikely, and models for fluid or material transport from detonation or explosion theory may give more relevant speeds. As a benchmark or reference datum, the speed of sound in air, c_{arc-prop}=303 m/s may be used. A cold-cathode arc's footprint on the cathode may be envisioned to be an expanding circle whose radius is expanding at a rate of c_{arc-prop}. The expanding-radius circle may have an area A_{arc}(t) giving an arc current of I_{arc}(t)=A_{chan}(t)·Φ_{arc,expand}, where Φ_{arc,expand}, is a characteristic current density [MA/m²] conducted through the arc plasma. Note that Φ_{arc,expand} may not be a maximum current density sustainable in the arc gap but rather the density at which it is more energetically favorable to expand the area of the arc column rather than increase Φ_{arc} further, as explained above. Starting at t=0 with a current of I_{arc,min}, which implies a radius r₀=SQRT(I_{arc,min}/(π·Φ_{arc,expand})) and an arc column area of A₀=π·r₀², an exact expression, given the physics assumptions, is:

I_{arc}(t)=I_{arc,min}+Φ_{arc,expand}·[2π·SQRT(I_{arc,min}/(π·Φ_{arc,expand}))·c_{arc-prop}·t+π·c_{arc-prop}²·t²]. 21)

Eqn. 21 is dominated by the t² term and the two constants Φ_{arc,expand} and c_{arc-prop}. Neglecting the term linear in t, using I_{arc,min}=10 A, c_{arc-prop}=303 m/s (speed of sound in air) and Φ_{arc,expand}=10 MA/m² (which is believed to be easily attainable even without arc-enhancing materials), a representative rate-of-rise of I_{arc}(t) is given in

TABLE 2

| t [ms] after ignition | A_{arc} [m2] | I_{arc} [kA] |
|---|---|---|
| 0.0001 | 2.88 × 10⁻⁹ | 0.010 |
| 0.001 | 2.88 × 10⁻⁷ | 0.013 |
| 0.01 | 2.88 × 10⁻⁵ | 0.298 |
| 0.1 | 2.88 × 10⁻³ | 28.9 |
| 1.0 | 2.88 × 10⁻¹ | 2,880 |
| 10.0 | 2.88 × 10⁺¹ | 288,000 |

From TABLE 2 it can be seen that after 1 millisecond, the arc plasma may be conducting 2.8 MA and filling an electrode area of ˜0.5 meter×0.5 meter, if square. This electrode size may be undesirably large for some applications, but expansion of plasma column area may be stopped at any size, if the external circuit's source and/or load provide/require less peak current. The above calculation assumed an unlimited source and load. Also, as pointed out, Φ_{arc,expand} may be much less than any maximum limit of Φ_{arc}. This means that, if the arc plasma fills the electrode gap with plasma at Φ_{arc,expand} current density and the external circuit forces still more current, Φ_{arc} can then increase further to accommodate the higher I_{arc} without further increase in A_{arc}, albeit probably at slightly higher V_{arc}. Arc-enhancing materials may provide higher Φ_{arc} in the range of, e.g., 50 to 1000 MA/m², without limitation, which may dramatically reduce the electrode area required, and concomitantly may produce a faster rate-of-rise for I_{arc}(t).

Arc propagation speed, c_{arc-prop}, may be directly manipulated by factors under the designers or end-user's control. Different arc-enhancing (or limiting) materials, different surface chemical reactions and other factors may strongly affect arc propagation and burning behavior through properties such as arc spot migration speed, change of local work function, charge trapping or polarization, change of a surface energy, modification of a sputtering yield, modification of a secondary electron coefficient and other effects.

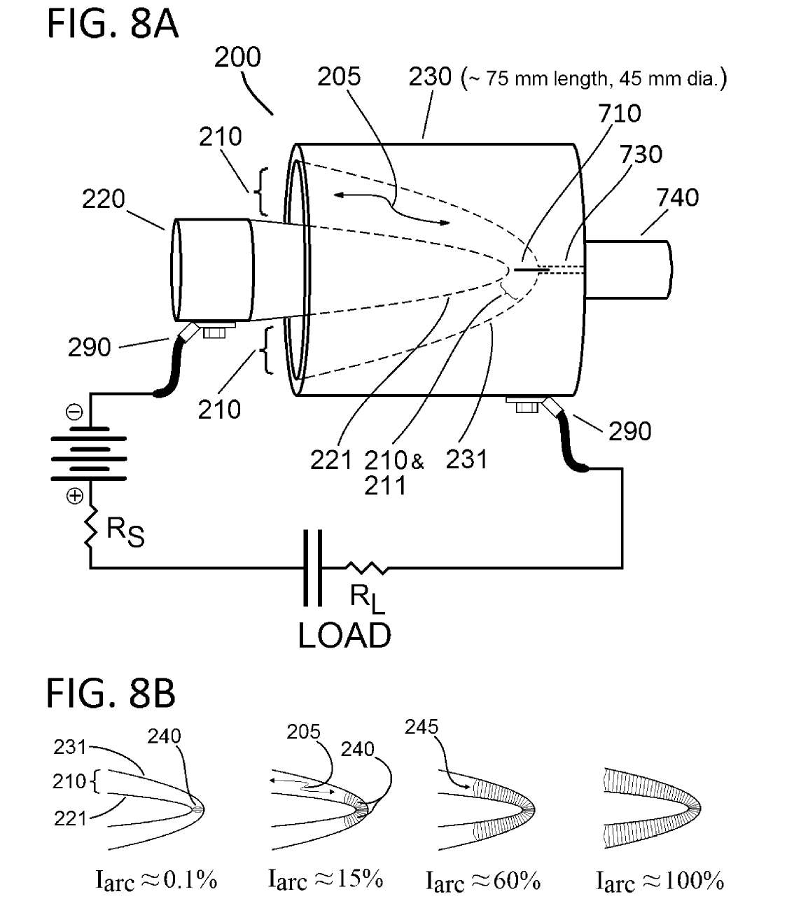

FIG. 8A shows an example implementation of an arc conductor switch 200 of the disclosure. The two arc gap components could be fabricated on a numerically-controlled lathe from copper in less than one hour. Several dimensions are given to roughly indicate the size of the apparatus, about 125 mm long and 50 mm diameter (˜5 inches long and 2 inches in diameter). The total mass, if constructed mostly of copper, may be <0.7 kg. The dimensions, mass and materials depicted are not limiting.

The apparatus of FIG. 8A comprises an inner arc electrode 220 and an outer arc electrode 230. Both electrodes comprise 3-dimensional parabolic arcing surfaces, 221 and 231, respectively, as exemplary but not limiting. The parabolic “nose” of 220 is inserted into a parabolic cavity of 230. The axes of the two parabolic shapes coincide, though this is optional, and their apexes are “nested” together in the orientation depicted. The equations for surfaces 221 and 231 are r=a·z²+b, in (r, θ, z) cylindrical-polar coordinates, with r and z in units of millimeters and z=0 at the apex of 231. For outer surface 231, a=0.2 mm⁻¹ and b=0 mm, and for inner surface 221, a=1.0 mm⁻¹ and b=8 mm, for all θ. It is understood that the cylindrically-symmetric parabolic functional form and the values of “a” and “b” are by way of example and are not limiting. Electrically-insulating support means for electrodes 220 and 230 are routine and omitted for clarity. Electrodes 220 and 230 may also be cooled by standard means, not shown. An arc gap 210 is formed between the two electrodes. The arc gap may be filled with a medium 205 such as air at sea-level pressure. According to a principle of the disclosure, arc gap 210 has variable length or lengths 211 between the electrodes at different locations. Lengths 211 may be measured as the distance of closest approach from either electrode to the other electrode that is roughly perpendicular to a tangent to the surface of either electrode, at any particular location on either electrode arcing surfaces 221 and 231.

A first arc ignition location may be provided at a location of minimum gap length between the electrodes. The location of minimum gap length and first arc ignition location coincides with the nested apexes of parabolic arcing surfaces 221 and 231 in FIG. 8A, though other features of parabolic or other shapes of electrodes may be selected as the location of minimum gap length. The first arc ignition location is indicated by arc striker rod 710, which moves to make a short circuit between electrodes 220 and 230 near their apexes. Striker 710 is depicted partially inserted, almost making contact. From the location of combined minimum gap length, first arc ignition location and the nested apexes, the arc gap length increases smoothly toward the left of the apparatus, which is the open edge or end of the arc gap, as depicted. The minimum of gap lengths 211 is 8 mm, at the apexes, and this distance is selected to accommodate the open-circuit (non-conducting gap) voltage which the arc-conductive switch may be able to stand off. The switch apparatus of FIG. 8A is nominally sized to stand off 10,000 volts. Air as the gap dielectric has a dielectric breakdown strength (field) of between ˜1 kV/mm to ˜3 kV/mm, as used by practitioners in various fields. The theoretical maximum stand-off of 24,000 V for an 8 mm gap is unlikely to be met in practice for an arc switch because a) the switch may be hot from previous use, b) air in the gap may be contaminated with traces of metal and metal oxide vapors or fumes from previous use and c) electrode surfaces 221 and 231 may be roughened by arcing from previous use. In spite of the microscopic or mesoscopic surface roughening typical upon arc electrode surfaces, smoothly-varying curved electrode shapes, such as parabolas, circles, ellipses and so forth, may be beneficially used, because they do not produce high electric fields (at asperities, steps, and so forth) which may reduce a breakdown voltage of the gap, thus allowing the electrode gap length to be shorter than it otherwise could.

In some implementations, the gap length may be minimized so as to maximize a ratio of arc channel or column width d_{chan} or area A_{chan} divided by an arc length l_{arc}. Arc length may be generally the same as arc gap length and measured in the same direction, but variants of the disclosure allow an arcing plasma column, or portions of it, to be tilted in the gap and thereby allow l_{arc} to t exceed l_{gap}. Generally, a high value of this ratio is favored so as to conduct large arc currents or high arc current densities at low arc voltage while simultaneously reducing a tendency for high-voltage plasma instabilities to form.

For operation, the arc conductor apparatus 200 detailed in FIG. 8A is shown connected schematically to an external electrical circuit via terminals 290. An electrical source, depicted as a battery to represent virtually any power source, charges a capacitor load through the arc switch when the arc switch is made conductive. The capacitor load assures that an arc in the switch may self-extinguish when the electric potentials of electrodes 220 and 230 equilibrate to within a few volts. Series resistances R_{S} and R_{L} are internal or inherent to the source and load, respectively, and are not explicitly added components. First arc ignition (e.g., noted above) may be accomplished by any means, such as a spark plug, laser pulse, electron beam pulse, ablative plasma gun, radionuclide emitter of α-particles or β-particles, chemical explosive detonation and the like, known in the art. However, first arc ignition may be accomplished by wire or rod feed mechanism 740 through feed hole 730 to supply lengths of conductive rod or wire 710 to short circuit electrodes 220 and 230 as an arc striker. Elements 710, 730 and 740, and any of their internal components may be at substantially the same potential as electrode 230. A diameter, mass, heat capacity, electrical resistivity and melting temperature of wire segment 710 is chosen so that it melts and vaporizes quickly after making electrical contact between electrodes 220 and 230. In cases with a high voltage source, vaporization and subsequent plasma ignition may be similar to exploding wire techniques. In cases with a lower voltage source, a spark drawn at initial contact of 710 to 220 draws an arc between 220 and 230 which subsequently melts and vaporizes 710. It is a desired but optional practice of the disclosure that vapor from 710 participates in arcing, as explained in detail below. Once an arc is initiated near the apexes of the electrodes, the disclosure provides that a low-voltage, cold-cathodic arc column or channel forms substantially between the apexes and subsequently expands or broadens to more fully fill arc gap 210. FIG. 8B depicts arc expansion in arc gap 210 between parabolic electrode surfaces 221 and 231, in much simplified manner, with the presence of arc plasma 240 indicated by fine lines roughly indicating current paths due to average or net motion of ions and electrons in the plasma. For clarity, labels for some features are omitted in some panels of the drawing, but corresponding features are understood to be present in all panels. Note that terms are used such as “broadening” of the arc “column” and/or its “footprint”, and the concept of an arc “channel”, which may originate from a one-dimensional rod-electrode or a two-dimensional, flat-electrode conception of arc apparatus, even though in the apparatus of FIG. 8A/B the arc gap curves almost 90° and is three-dimensional. Though curved in three dimensions, a cross-sectional area of an arc footprint or column may still be defined and refer to an equivalent “width” d_{chan} of such an arc column. Once a low-voltage, dense arc is established in the gap, the degree of lateral gap filling is, to zeroth order, determined by the arc current. One of the zeroth order approximations is that arc areal current density Φ_{arc} [A/m²] is constant as arc current increases. This is supported for arcs burning in atmospheric pressure media by observation of arc column diameter d_{chan}∝I_{arc}ⁿ where n≈0.5. Thus I_{arc}(t)=A_{chan}(t)·Φ_{arc}, where the cross-sectional area A_{chan}(t) of the arc column is changing and Φ_{arc} is a constant. Therefore, the four panels of FIG. 8B depict four extents of plasma filling of the arc gap as A_{chan}(t) increases at four magnitudes of arc current, from minimum on the left to maximum on the right, as drawn. The magnitudes of arc current are given as percentages of a maximum, since the particular value of arc current depends upon current density Φ_{arc}, which is adjustable as a design parameter, by selection of arc electrode materials and other means. Φ_{arc} is adjustable over a range of 1 to 1000 MA/m², without limitation, for types of arcs desirable for practicing the disclosure. Generally, medium 205 (such as air) that had occupied the arc gap in its non-conductive state is substantially displaced by arc propagation front 245 as the gap fills with dense metal plasma 240. Likewise, medium 205 may fill back into the gap when arc front 245 is receding due to arc current decreasing.

In some implementations, an orderly expansion of a cross-sectional area or a broadening of the arc column may be provided, and an orderly contracting of the area of the arc column, as arc current increases and decreases, respectively. By orderly it is meant, among other aspects, that the arc patch on the electrode(s) stays unitary and does not split or fragment into hot spots or tendrils of plasma. In other aspects, the arc front retraces its expansion path during recession and the arc footprint always includes, and may be centered upon, the first arc ignition location, though these aspects are optional. In yet other aspects, arc attachment at electrode surfaces is mobile, facile and exhibits current density which is substantially uniform or smoothly-varying with distance along the surface of an electrode, except near front 245. Orderly management of the arc footprint may discourage high-voltage plasma instabilities of the arc and thus extends an operational range of switch 200. As an example of desirable order of arc expansion and contraction in the apparatus of FIG. 8, if a pulse I_{arc}(t) had a symmetrical triangular waveform over time, rising from a low value (0.1%) to a high value (100%) and back to a low value (0.1%), then the time profile of the arc plasma 240 filling of the gap may progress as depicted from the left to right and back to the left again in the panels of FIG. 8B. For the triangle wave, 100% of may occur half way (50%) in time through the pulse. Such an orderly expansion and contraction of an arc footprint is encouraged by the arc gap 210 having a variable distance (gap length) between the electrodes at different locations. More specifically, the arc may burn at lowest arc current (and all higher arc currents) where gap 210 has a shortest length, and the arc column and the arc footprint may expand into regions with increasingly longer gap lengths to burn at increasingly higher arc currents. Likewise, as arc current decreases, the arc column and the arc footprint may contract from regions with longer gap length to regions having shorter gap length. The behavior of the arc to burn where gap 210 has a shortest length is urged at least by a) the ability of the arc plasma to form a lower impedance conductive channel (arc column) through medium 205 at a location of shorter electrode gap length and b) back-pressure of medium 205 tending to compress and minimize the volume occupied by the burning arc. The behavior of the arc expanding laterally as arc current increases to regions of longer gap length and against the pressure of medium 205, is urged by possibly near-explosive build up of heat and metal vapor pressure, as well as acceleration of electrons and ions, in the gap volume containing the burning arc.

In another aspect of orderly and free expansion of arc cross-section and footprint, the switch or arc conductor of FIG. 8 overcomes magnetic constriction of the arc column due to the summing of self-current magnetic fields B (or H) of moving charges in the arc column. In one or more implementations, the shape of at least one of the first and second electrode may be configured to decrease a self-current magnetic constriction of the arc column. Self-current magnetic constriction of the arc column can take effect in conventional arc electrode geometries when I_{arc} exceeds 1,000 A to 10,000 A, and TABLE 3 below shows that the implementation of FIG. 8 can achieve much higher currents than these values. Magnetic constriction of an arc column may be incompatible with the inventive broadening of the arc column cross-sectional area A_{chan} for some ranges of I_{arc} and Φ_{arc}. A preferred method of overcoming magnetic constriction is electrode shaping. The parabolic shape of the arc gap 210 of FIG. 8 bends almost 90°, so the self-current magnetic fields do not vector sum in the same plane. At high arc currents and high plasma filling factors, say 40% and greater, the arc expansion regions (propagation of front 245) are almost exclusively in the ring-shaped annulus or “dough-nut” portion of gap 210. In this region, B fields of individual charges (Eqn. 19) following the current paths sketched in FIG. 8B sum-and-cancel to create a net solenoidal field whose axis is substantially parallel to the axes of the parabolas of the arcing surfaces of the electrodes. Such a field does not inhibit charges from moving further to the left (or right), as drawn, so propagation of front 245 to the left to increase arc footprint is unrestricted. Moreover, the slight widening of the gap and the increase in the overall diameter of the gap with distance further to the left, as drawn, means in general that the resultant B fields are weaker to the left of than they are to the right of any point in the plasma. Such a divergent magnetic field tends to impart a drift of electron velocities from regions of dense B fields to regions of less dense fields. This effect also promotes propagation of front 245 to the left, as drawn, and promotes increase of arc footprint area. Because the widening of the gap and the increase in the overall diameter of the gap with distance further to the left is only slight, this effect does not overly restrict recession of arc front 245 to the right when I_{arc} is decreasing; external pressure from medium 205 is easily able to overcome this effect. Thus, for overcoming self-current magnetic constriction of the arc column, a degree of electrode curvature and/or a distance along, for example, the z-axis (see FIG. 8A) before electrode curvature must become effective, as indicated above, may be determined by a practitioner as follows. An approximate area of an arc electrode, A_{constrict}, is calculated according to a formula substantially comprising or including a term such as A_{constrict}=I_{arc,constrict}/Φ_{arc}. At approximately this area A_{constrict} of arc footprint broadening, constriction of the arc column may become important, and a desired significant degree of electrode curvature is preferably encountered. A location such as “z” in the example of FIG. 8 whereat curvature needs to be effective may be calculated or measured on one or the other arc electrodes using the formula for the electrode shape, such as r=a·z²+b for the electrodes of FIG. 8A, or other geometric description or measurement of electrode shape. As may be appreciated by those skilled in the art, there is considerable natural variability and/or design flexibility in A_{constrict}. It depends in part upon I_{arc,constrict} which as mentioned above may occur when I_{arc} exceeds 1,000 A to 10,000 A, without limitation. I_{arc,constrict} in turn depends upon, at least some plasma parameters such a nₑ, Tₑ, average ion mass, average ion charge and so forth, as well as the arc gap length or arc length l_{arc}. Arc current density Φ_{arc} is also directly contributory to determining A_{constrict}, and Φ_{arc} may be influenced by at least a choice of arc enhancing material, if any, or electrode material.

The shape of at least one of the first and second electrode may be configured in one or more regions to modify a degree of the self-current magnetic constriction of the arc column. In one or more implementations, the disclosure provides controlled self-current magnetic constriction of the arc column, or, more precisely, provides for controlled “urging” or forces on the arc column using the self-current magnetic fields. A degree of self-current magnetic field urging may be designed for and implemented to provide containment forces upon the expanding arc column, even if said forces do not entirely cease or reverse the expansion of the arc column. Moderate anti-expansion forces on the expanding arc column may be desirable for keeping the arc column or its plasma continuous, dense, well-defined and/or localized, as the column expands in cross-sectional area. When the current conducted between the arc electrodes decreases, the presence of moderate self-current magnetic forces may urge and assist the arc column and the arc foot print to contract in an orderly fashion, as defined above, and its plasma remain continuous and dense. The preference in the disclosure for a continuous, dense plasma column hinges on the principle that formation of new arc spots requires both a certain minimum level of energy input to the cathode surface [J/m²] and a dense plasma and plasma sheath close to the cathode surface; unstable gaps in plasma column risk losing one or both of these. These same forces may also be used to conform or confine the arc footprint to a certain shape of arc electrodes, to which the arc may not otherwise or naturally conform. In general, the strength of the magnetic urging forces is controlled by varying the shape of the electrodes, such as by varying the parameter “a” in r=a·z²+b for the electrodes of FIG. 8A, for example.

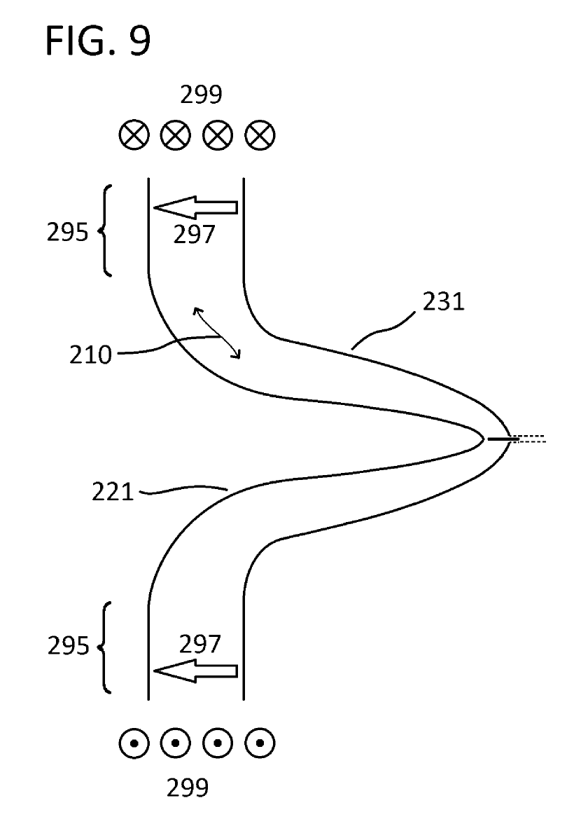

The shape of at least one of the first and second electrode may be configured to change shape in one or more regions to modify (e.g., increase) strongly the degree of the self-current magnetic constriction of the arc column. In one or more implementations, an example of which is depicted in FIG. 9, a version of the switch of FIG. 8A is provided in which a further curvature of the electrodes has been introduced so as to allow self-current magnetic constriction of the arc column to become operative in a region of the arc gap which may only become filled with plasma after the arc column has almost fully expanded. As in FIG. 8A, the apparatus of FIG. 9 is cylindrically symmetric about the axis of the parabola-shaped electrodes, though a simple 2-dimensional cut of the apparatus is shown for clarity. Thus the arc column may expand as depicted in FIG. 8B up until gap filling has reached a zone 295 of the added curved regions of the electrodes of FIG. 9. As arc current is urged to increase by the external circuit (as in FIG. 8A, for example), the arc column may expand into zone 295. In this zone, the direction of electric current flow through the arc plasma is indicated by arrows 297. Current flow in this direction, all around the cylindrical zone 295, may induce magnetically constricting B-fields. Those B-fields are indicated by their lines of flux 299. Lines of magnetic flux 299 which may induce magnetically constricting B-fields are circular in a band indicated by arrows 299, which are depicted as arrow tips for lines rising out of the plane of the page and arrow tails for lines descending into the plane of the page. This shape of B-field may affect the arc column via the magnetic Lorentz force and may restrict expansion of the arc column edges so that they are not expelled out of the arc gap 210 at the edge of zone 295. This effect may be useful to limit an overflow of arc plasma out from the open ends or edges of the arc electrodes. Moreover, in some implementations, this magnetic constriction may allow a smaller arc conductor or switch to carry larger current. This arises because, as explained herein, an arc gap and arc electrodes providing very facile expansion of the arc column may fill quickly with arc plasma conducting only a lower arc current density Φ_{arc,expand}. A higher arc current density, Φ_{arc,max}, may be sustained by the arc electrodes if the expansion of the arc column is halted while yet more electric current is forced through the arc gap by the external circuit (see FIG. 8A, for example). The use of self-current magnetic fields may allow utilization of all arc current densities from Φ_{arc,expand} to Φₘₐₓ, inclusive. Thus at higher Φ_{arc}, an arc conductor of a given size may conduct a larger peak current without arc plasma overflow of the electrodes.

The arc switch 200 implementation of FIG. 8 illustrates how various arc ignition means and arc-enhancing materials may be employed. These may be related because, according to one aspect of the disclosure, some arc ignition means can also be used to supply arc-enhancing material to the arc gap, thus replenishing it and providing beneficially long lifetime for the switch. As stated above, an example arc initiator may use wire or rod feed mechanism 740 through feed hole 730 to supply lengths of conductive rod or wire 710 to short circuit electrodes 220 and 230 as an arc striker. Striker rod 710 may include, in whole or in part, arc-enhancing material. Then, as the material of rod 710 becomes vaporized and involved in the arc plasma, it may be transported to various locations on surfaces 221 and 231 of the arc electrodes. Arc-enhancing materials for use in/as striker 710 are listed herein earlier, but exemplary materials for the apparatus of FIG. 8 may be tin (Sn), zinc (Zn) and bismuth (Bi), without limitation, due to low cost and desirable chemical and arcing properties of their oxides. It may be possible to fabricate electrodes 220 and 230 entirely of such arc-enhancing materials. In that case, addition of further arc-enhancing material using striker rod 710 may be desirable to replace lost electrode material as the switch wears from arcing use. Some metal vapor originating from the electrodes may escape open ends/edges of arc gap 210 during or related to arc conduction events.

An appropriate baffle or trap (not shown) to capture such escaped vapor is disclosed elsewhere herein. Such baffle may also serve other functions, such as adjusting a back-pressure of medium 205, reducing acoustic emissions from switch 200 or filtering dust or other contaminants, among others. Notwithstanding the possibility of using electrodes made of thick-section arc-enhancing material, the implementation of FIG. 8 exemplarily uses copper for the bulk of electrodes 220 and 230. Copper exhibits high melting point (m.p.=1083° C.), high thermal conductivity (λ=385 W/m-K), large heat capacity (C_{P}=0.385 J/g-° C.) and low electrical resistivity (ρ=1.70 μohm-cm). By contrast, tin (m.p.=232° C., λ=63.2 W/m-K, C_{P}=0.213 J/g-° C., ρ=11.5 μohm-cm), zinc (m.p.=419° C., λ=112.2 W/m-K, C_{P}=0.3898 J/g-° C., ρ=5.916 μohm-cm) and bismuth (m.p.=271° C., λ=10.0 W/m-K, C_{P}=0.122 J/g-° C., ρ=105.0 μohm-cm) have less desirable properties as high-temperature, high-power structural conductors. However, copper is not an arc-enhancing material as defined herein and preferred for practicing the disclosure. Thus a best mode of practicing the disclosure is to add a thin layer of arc-enhancing material to the surfaces 221 and/or 231 of electrodes 220 and/or 230 which, themselves, may predominantly comprise copper. This may be done during fabrication of the electrode(s) by electroplating, electroless plating, sputtering and several other methods. Alternatively, bare copper may be coated with arc-enhancing material from striker 710 by repeatedly striking arcs of low power in the switch to “season in” the surfaces of the switch before use at higher, design-rated switch power. A thickness of 10 to 100 μm of arc-enhancing material is considered sufficient for most locations on electrode surfaces 221 and 231, but greater thicknesses of ˜1 mm may be preferred near the arc-ignition region. In cases in which a coating of arc-enhancing material is used for the electrodes, it may be even more desirable to refresh a quantity of arc-enhancing material on surfaces 221 and 231 using striker 710 and 740. In this regard, other methods of initiating the arc using arc-enhancing materials may alternatively be used, including any known method of inducing dielectric breakdown of gap 210/205 by insertion or injection of materials. For example, metallic powder, whiskers, particles, dust, aerosols, fumes or other finely-divided arc-enhancing material may be blown into gap 210 at the apexes of the parabolas by a jet of air or other gas. A liquid may be injected by any known means, such liquids broadly including dissolved salt solutions, molten metals, “ink” formulations suitable for jet spraying, metal precursor chemicals, slurries, pastes, suspensions, colloids and other fluid matter. Generally in cases of liquids, the initial dielectric breakdown (spark) or subsequent modes of electrical discharge leading toward arcing may be used to vaporize, activate or transform the injected fluid into a desired physical state or chemical make-up; byproducts may be further decomposed thermally or in the arc plasma, then simply exhausted as gases from open end of gap 210. Certain gases may either cause breakdown and/or transport arc-enhancing atoms and may be simply admitted into gap 210. In all these cases of supplying particulate, fluid or gaseous arc-ignition substances, exemplary rod feed mechanism 740 of FIG. 8A may be changed or adapted to manipulate the alternative substance appropriately. Feed tube 730 may be changed or adapted for example to also comprise a valve, heater, ionizer, electrostatic accelerator, nozzle, atomizer, ultrasonic transducer, co-injection port or other device for manipulating the alternate arc ignition material 710, as appropriate.

Arc ignition substance 710 may have other than the rod form depicted in FIG. 8A. Many of these alternate forms of arc ignition substances, as well as the exemplary rod feed arc striker, may comprise arc-enhancing materials in encapsulated, coated, chemically-bound, hermetically sealed, passivated, precursor, mixture, alloy, chelated, entrained, diluted, dispersed, inert-blanketed, oxidized and other forms. Such derivative and related forms of arc-enhancing materials may be easier to handle, transport, store, inject or supply than forms directly usable for arc discharge. These forms may be especially enabling for using the super-arc-enhancing alkali metals, Na, K, Rb and Cs. For an example, potassium rods 710 may be jacketed or encapsulated with a tin, bismuth or other outer layer, thus rendering the potassium substantially inert to air. Once an encapsulant rod or wire 710 is melted and vaporized in arc gap 210, the alkali metal may be freed in substantially pure metallic vapor form. Likewise, particulate or fluid forms may encapsulate alkali metals or other arc-enhancing substances, to similar effect. For another example, alkali-metal hydrides and alkali-metal oxides (XH, X₂O, XO₂ and X₂O₂, where X═Li, Na, K, Rb or Cs) may be sufficiently inert to be manipulated in feed mechanism 740 and yet may decompose under the action of an arc, liberating free alkali metal atoms which then participate as super-arc-enhancing atoms. Hydrogen or oxygen collaterally liberated by such a process may escape as H₂ or O₂ gas from open end of arc gap 210, while the alkali metal itself may linger within gap 210 through many switch conduction events. For all forms of injected materials or substances used to cause dielectric breakdown of an arc gap, a further purpose may be to inhibit high-voltage modes of sparks, arcs, arc flashes, and the like, as well as to inhibit time-instabilities of arcing which may permit high-voltage transient events. To these ends, injected substances or additives may beneficially reduce a rate-of-rise of I_{arc}(t), reduce an initial arc current density, reduce a speed of vapor, charged particle or shock wave propagation, reduce an initial pressure or temperature rise and the like, to modulate or control violent or energetic breakdown of a high-voltage arc gap. For example, an electronegative or high-electron-affinity species may reduce or reduce a rate of increase of electron density in the plasma. Too-rapid of a release of energy during first arc ignition may produce explosive events detrimental to establishment of desirable low-voltage, broad-area, sustained arcs, and injected arc striker or initiator materials may beneficially control against this.

Electrical switching performance of a switch of substantially the size, design pattern and material content as the FIG. 8A implementation of an arc conductor switch 200 may be calculated as follows. In broad concepts, a surface area of the arc cathode determines the maximum current I_{arc} the switch can carry, while a mass of the anode determines the maximum thermal power the switch can quickly absorb, which in turn determines a length of time Δtₚᵤₗₛₑ the switch can conduct a particular current. It is believed that no known means of anode cooling may be sufficiently fast to make a difference to heat removal during a conduction event, though this is in no way defining or limiting of the disclosure. Along with the arcing area of the cathode, a design-selectable value of areal current density Φ_{arc} [A/m²] fixes a nominal maximum arc current. Along with the mass of the anode, its heat capacity and melting temperature determine how much energy from the arc E_{arc,loss} it can absorb as heat Eₕₑₐₜ before melting or sagging. As explained relative to Eqns. 9 and 10, Eₕₑₐₜ≈E_{arc,loss}=P_{arc}·Δtₚᵤₗₛₑ=V_{arc}·I_{arc.}·Δtₚᵤₗₛₑ, so a length of time Δtₚᵤₗₛₑ the switch can conduct a particular current before destruction can be calculated. The power P_{arc} consumed by the arc from the external circuit and liberated (lost) in switch 200 is explained relative to Eqns. 7 and 8. Arc voltage V_{arc} is nominally constant and independent of both time and I_{arc}, after a low-voltage cold-cathodic arcing mode has been established in gap 210. Note, however, according to FIG. 8A, the full voltage of the power source (battery) of the external circuit may appear across arc gap 210 when switch 200 is in a non-conductive state. As mentioned, the designed stand-off voltage V_{gap} is 10,000 v. As an arc is ignited and established in gap 210, V_{gap} reduces toward low values of V_{arc} via a spark-to-arc transition thought to occur in less than a few hundred nanoseconds (ns). The details of this transition are a subject of current research and depend upon many parameters, including critical ones belonging to the external circuit's power source and load, and a full discussion is not considered germane to the disclosure. Generally, the voltage that formerly appeared as V_{gap} across gap 210 quickly appears across the external load as V_{load}, since the gap resistance goes to near short-circuit values due to the arc (see Eqns. 1 through 6). As the arc footprint expands on surfaces 221 and 231 and I_{arc} increases, V_{arc} may settle and stay near 10 volts, but usually between 2 to 50 volts for all I_{arc} values>I_{arc,min}. It is desired to reduce V_{arc} below 10 volts, particularly at large values of I_{arc} and Φ_{arc}. This is provided within the disclosure by arc-enhancing materials disposed upon electrode surfaces 221 and/or 231. It is believed that there is an approximately inverse relationship between V_{arc} and Φ_{arc}, when large Φ_{arc} is engendered by properties of desired arc-enhancing materials. This postulated relationship has not been explored and mapped fully, as far as the inventors know, for any arcing materials and arc gap geometries and particularly not for the recently recognized arc-enhancing materials in arc gap geometries for switching of the present disclosure. Nevertheless, it is believed that when arc-enhancing materials are employed to reach Φ_{arc} values near 1000 MA/m², that V_{arc} may decrease to near 5 volts, when I_{arc} is also at high values>>I_{arc,min}. Stated in other terms, as increasingly aggressive arc-enhancing materials are deployed onto electrode surfaces 221 and/or 231 and V_{arc} is reduced toward ˜5 volts (known from FIG. 7), it is believed that Φ_{arc} can be chosen to be increasingly nearer to 1000 MA/m² or more. There are a number of reasons to expect such a trend, including the lower power needed per spot to sustain cathode spots on arc-enhancing materials, the consequently lower current per spot and lower self-current magnetic repulsion between spots and the resulting higher density of spots achievable. Another set of supporting reasons pertains to a high-density metal plasma in the arc gap, such as observations of V_{discharge}<2 volts for alkali metal arcs when the metal vapor is provided independently of arc evaporation via thermal evaporation, and quite low electron and ion temperatures. At some high Φ_{arc} and with arc-enhancing materials having high-vapor pressure, it is further expected that a predominant arcing mode may change from cold-cathode arcing to thermal metal vapor arcing based substantially upon a temperature of the electrodes being high enough to create vapor of the arc-enhancing material without need of cold-cathode arc spot evaporation. In that case, V_{arc} may decrease to low values near the ˜2 volts observed for thermal alkali-metal-vapor arcs. Thus in the electrical performance calculations for the switch implementation of FIG. 8A herein, we present results for both known-achievable V_{arc}≈10 volts and expected-achievable V_{arc} tending toward 5 volts with advanced arc-enhancing materials. We expect that from Φ_{arc}≧50 MA/m² to ≧1000 MA/m² it may be desirable to use advanced arc-enhancing materials to achieve lower V_{arc}. Lower V_{arc} beneficially reduces at least a power dissipated in switch 200.

As depicted in FIG. 8A, inner electrode 220 is connected as the cathode of the arc gap, so its arcing surface 221 area of ˜0.0027 m²=27 cm² limits the arc current carried by the switch according to the designed Φ_{arc}. The I_{arc} results are listed in the second column of TABLE 3 and range from 2.7 kA to 2.7 MA. These results are for 100% filling of arc gap 210 as depicted in the right-most panel of FIG. 8B. The disclosure may readily be used with less than 100% filling of the arc gap, however.

TABLE 3

| | | Known Arc-Enhancing Material | | | Advanced Arc-Enhancing Material | | |
|---|---|---|---|---|---|---|---|
| | Max. | | Δtₚᵤₗₛₑ [ms] | E_{load} [MJ] | | Δtₚᵤₗₛₑ [ms] for | E_{load} [MJ] |
| Φ_{arc} | I_{arc} | V_{arc}, | for ΔT_{switch} = | for | V_{arc}, | ΔT_{switch} = | for |
| [MA/m²] | [kA] | [V] | 260° C. | V_{circuit} = 10 kV | [V] | 260° C. | V_{circuit} = 10 kV |
| 1 | 2.7 | 10 | 2,000 | 53.2 | 5 | 4,000 | 106.5 |
| 10 | 27 | 10 | 200 | 53.2 | 5 | 400 | 106.5 |
| 30 | 80 | 10 | 66 | 53.2 | 5 | 132 | 106.5 |
| 100 | 270 | 10 | 20 | 53.2 | 5 | 40 | 106.5 |
| 300 | 800 | 10 | 6.6 | 53.2 | 5 | 13.2 | 106.5 |
| 1000 | 2,700 | 10 | 2.0 | 53.2 | 5 | 4.0 | 106.5 |

An approximate heat-absorbing mass of the implementation of FIG. 8A is 0.53 kg if the electrode material is copper. Only the mass of the anode or outer electrode 230 was counted in this mass, since it is known that about 65-80% of dissipated heat in a cold-cathode arc gap ends up in the anode; since the calculation assigns 100% of liberated heat to the anode, this is a low or conservative mass value with which to calculate a thermal limit of the switch. With a heat capacity of copper C_{P}=0.385 J/g-° C., the temperature may rise ˜0.00488° C./J per joule of Eₕₑₐₜ lost to the arc apparatus. For the sake of a very conservative example, if the temperature rise per switch conduction event is wished to be ≦260° C., then the switch can absorb Eₕₑₐₜ≦53,250 J of heat during one such event. The electrical power P_{arc} consumed by and liberated in the arc is given by Eqn. 8 and we used, for TABLE 3, two different values for V_{arc}, 10 volts for a known arc-enhancing material and 5 volts for an advanced arc-enhancing material. Multiplying P_{arc} by an effective time duration of the conduction event, Δtₚᵤₗₛₑ, yields Eₕₑₐₜ. For TABLE 3, we have actually solved for a maximum value of Δtₚᵤₗₛₑ given a desired maximum Eₕₑₐₜ=53,250 J acceptable given the apparatus construction of the switch implementation of FIG. 8A.

Referring now to the results of TABLE 3 for electrical performance of the arc switch of FIG. 8A, it is evident that beneficially large electrical energies E_{load} can be transferred through the switch to a load quickly. E_{load} was calculated from the apparatus-limited conduction event durations Δtₚᵤₗₛₑ multiplied by P_{load} obtained using Eqn. 11 with V_{circuit}=10,000 volts. The TABLE values are for an idealized square-wave pulse, but, as mentioned relative to Eqn. 12, a time dependence of I_{arc}(t) and/or V_{load}(t) may need to be taken into account, depending upon the nature of the source and load in the external circuit. The results in TABLE 3 were calculated for a purely resistive load whose resistance was adapted for each row of TABLE 3 to draw the maximum I_{arc} current at the fixed V_{load} value. This was done to elucidate an assessment of the thermally-limited performance of the arc switch of FIG. 8A. Of course, the switch may be operated at less than its thermally-limited performance. In fact, the results of TABLE 3 are for operation well below any destructive thermal limit. The temperature rise ΔT_{switch}=260° C. could be compounded at least three times (total ΔT_{switch}=780° C.) by tripling Δtₚᵤₗₛₑ or triggering three conduction events in rapid succession; provided the switch started at near room temperature (<100° C.), its final temperature may still be well below the copper melting temperature of 1083° C. However, the very conservative ΔT_{switch}=260° C. may be chosen because a) some arc-enhancing materials that may reside in gap 210 do have low melting temperatures and b) mounting arrangements for electrodes 220 and 230 may be simplified. Even with the conservative ΔT_{switch}=260° C., the E_{load} energy transfer capabilities of the switch are large considering the size of the switch. For perspective, 53.2 MJ≈15 kW·hours may power a mid-size passenger automobile approximately 110 km or 70 miles using known arc-enhancing materials and twice that using advanced arc-enhancing materials. Scaling up the switch from ˜2 inches diameter to ˜3 inches diameter, all added to the diameter of outer electrode 230, may increase the mass of the outer electrode from 0.53 kg to ˜2.5 kg and increase the acceptable Eₕₑₐₜ from 53,250 J to ˜252,000 J. E_{load} could increase almost a factor of five (4.735) to 252 MJ and 504 MJ using arc-enhancing materials, respectively. Thus a 50% increase in size (volume) of the switch beneficially gives almost a 500% increase in energy transfer capability. Energy loss fractions in the switch, Eₕₑₐₜ/E_{load}, are relatively small at 0.1% and 0.05% using known arc-enhancing materials and advanced arc-enhancing materials, respectively. Substantially as indicated in Eqn. 13, energy loss fractions in a switch with a given V_{arc} are dependent only upon V_{circuit} and independent of I_{arc} and duration Δtₚᵤₗₛₑ of conduction event.

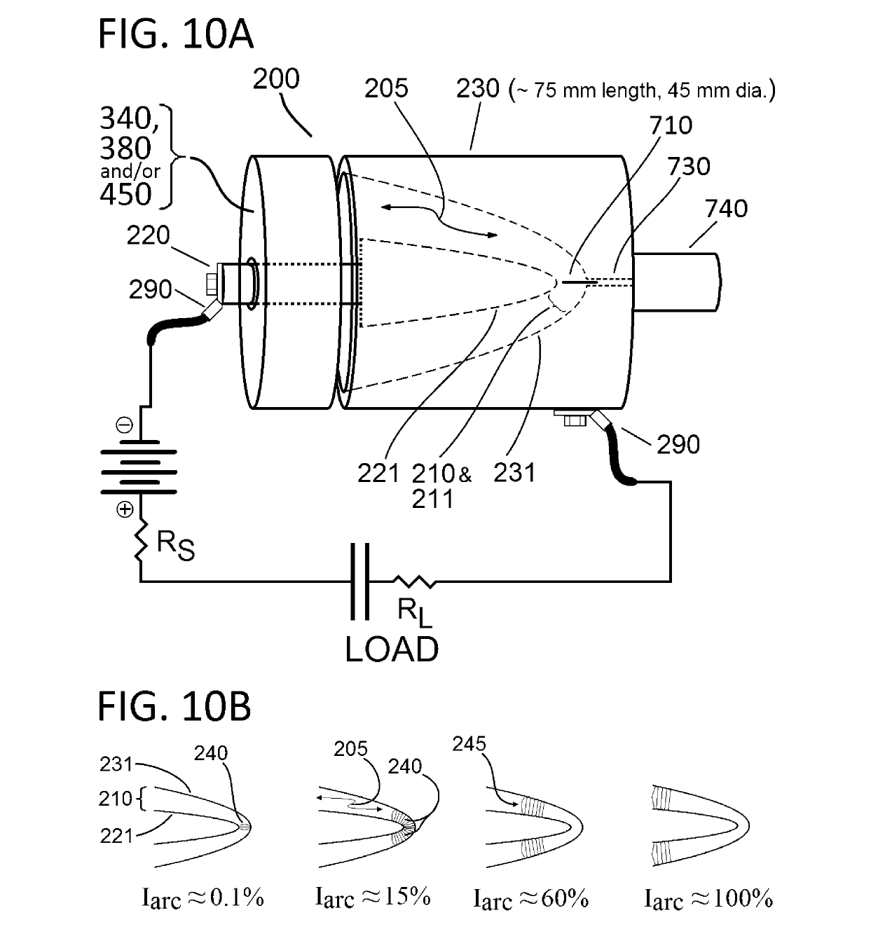

In some implementations, the conducted electric current between the first and second electrode may be configured to decrease towards zero in response to the moving arc column being expelled from the arc gap. For example, FIG. 10A shows an implementation in which a plasma quenching baffle structure 380 (similar to 340 and/or 450 elsewhere herein) has been introduced to quench arc plasma in response to the expanding arc column being expelled from the arc gap. It is intended to provide for decrease or reduction to zero of the current conducted by the arc conductor, by action of the arc conductor. If the arc conductor is used as a switch, the switch can be opened by action of the switch after a certain amount of electric charge or electric current has been conducted by the switch. The concept of the self-opening arc switch or self-circuit-interrupting arc conductor is that the arc footprint and the arc column expands as conducted current increases, as in one or more implementations of the disclosure disclosed herein, but the expanding arc footprint and arc column is configured to move completely out from arc gap 210 between the first and second electrode, 220 and 230. As the arc plasma column moves out of the arc gap, it is intercepted by plasma quenching baffle structure 380 which may destroy the plasma by commonly known means. These commonly known means include at least one of recombining ions and electrons, neutralizing ions on solid, gaseous or liquid substances, absorbing or capturing electrons on solid, gaseous or liquid substances, cooling the plasma, blowing or displacing the plasma away from electrodes 220 and 230, magnetically separating electrons from ions in the plasma, electrostatically separating electrons from ions in the plasma and other means. All such means and others of destroying a plasma are loosely defined herein as “quenching” the plasma. Structure 380 carries out this plasma quenching by components, materials, geometries and methods known to those skilled in the art, appropriately for the quenching means chosen.

In some implementations, it may be desirable to assure that substantially all of the plasma footprint and the plasma column are expelled from the arc gap between the first and second electrode, as the plasma expands and moves away from the location of first arc ignition 730 toward the open end or edge of the gap (depicted on the left of FIG. 10A, as drawn). The speed of motion of the expanding arc plasma column may be rapid, such as 1 to 1000 m/s, without limitation. Thus the gaseous plasma fluid and particles possess a momentum promoting expulsion from the gap. It is further necessary that the size of the arc switch be small enough in relation to the peak current driven through the arc conductor by the external circuit, shown for example in FIG. 8A, so that the plasma column overfills the gap and “spills over” (is expelled) from the open end of the arc gap 210.

The arc column in arc gap 210 may be configured to be compact, continuous and dense as provided in many implementations disclosed herein, but further configured to not fully fill the parabolic, cylindrically-symmetric gap 210 but rather to form a circular band-shaped footprint on each of first and second electrode and form an annular “dough-nut”-shaped plasma column. This plasma column is still continuous and dense but departs the location 730 of first arc ignition and leaves behind a void of plasma and a region in which the arc no longer burns. This expansion and shape of the arc plasma column is depicted in 2-dimensions in a time-progression in FIG. 10B, which is similar to FIG. 8B, wherein most of the explanation given for FIG. 8B applies to FIG. 10B. Thus is the form and action of the annular arc as an expanding arc footprint and arc column which may move within the arc gap and may create one or more regions which formerly had plasma and then lack plasma, and within which the arc is no longer burning. This form and motion promotes the desired decrease in arc conducted current as the arc column is expelled from the arc gap, because after the arc column departs, no plasma remains in the arc gap.

In one or more implementations, this desired form and motion of the arc column may be accomplished by choosing arc igniter material 710 to be a relatively volatile arc enhancing material while constructing arc electrodes 220 and 230 out of relatively arc limiting materials. In this way, the volatile arc enhancing material gets driven by the heat and expanding motion of the arc away from first arc ignition location 730 out towards open ends of gap 210; the arc footprint follows the migrating arc enhancing material because the lowest impedance arc may exist wherever the arc enhancing material dwells on the surfaces of electrodes 220 and 230. As drawn in FIG. 10A, this heat-driven migration of arc enhancing material may be promoted by fabricating electrodes 220 and 230 from relatively low thermal conductivity material, so that the surfaces of those electrodes heat up rapidly near location 730 where the arc is first ignited. Other techniques may include varying a wall thickness of electrodes 220 and 230 to be thinner and thus hotter near location 730, which further drives the volatile arc enhancing material by sublimation and desorption toward the open end of gap 210. This then leads the arc footprint in the same direction but also discourages arc plasma in the region behind the moving arc front.

While at least one of the above-noted implementations of FIG. 8 above, with fixed, cylindrically symmetric parabolic electrodes incorporates and illustrates many principles and aspects of the arc switch disclosure, an additional/alternative implementation described below may show alternate useful ways the disclosure may be implemented. The above-noted implementation of at least FIG. 8 may conduct extremely large currents and transfer high quantities of energy for its size, but it lacks an evident means to terminate arc conduction if the load continues to draw current after an initial surge and lacks an evident means to protect a conventional, prior art, commercial off the shelf (COTS) switch, with which it is in parallel, during opening of the already-conducting COTS switch. In this latter case, the arc gap may be short-circuited by the COTS switch to approximately zero volts, so it may be impossible to strike an arc. As defined herein, “switch” means either mechanical switch or semiconductor switch, so one exception to this inability to strike an arc in parallel with a closed switch is when said switch is a semiconductor.

For some types of semiconductor devices, the voltage across the arc gap may be increased (to 20, 30, 50 volts or thereabouts) by putting the semiconductor junction into a state of partial conduction, after which an arc can be ignited and established in the arc gap and after which the semiconductor switch may be fully opened. In some implementations, in its various optional configurations, may solve those possible end-use needs for almost any type of switch and additionally employs an alternate first arc ignition means which may be more suitable for some end uses. In some implementations, selectable variability of the arc gap length may be offered.

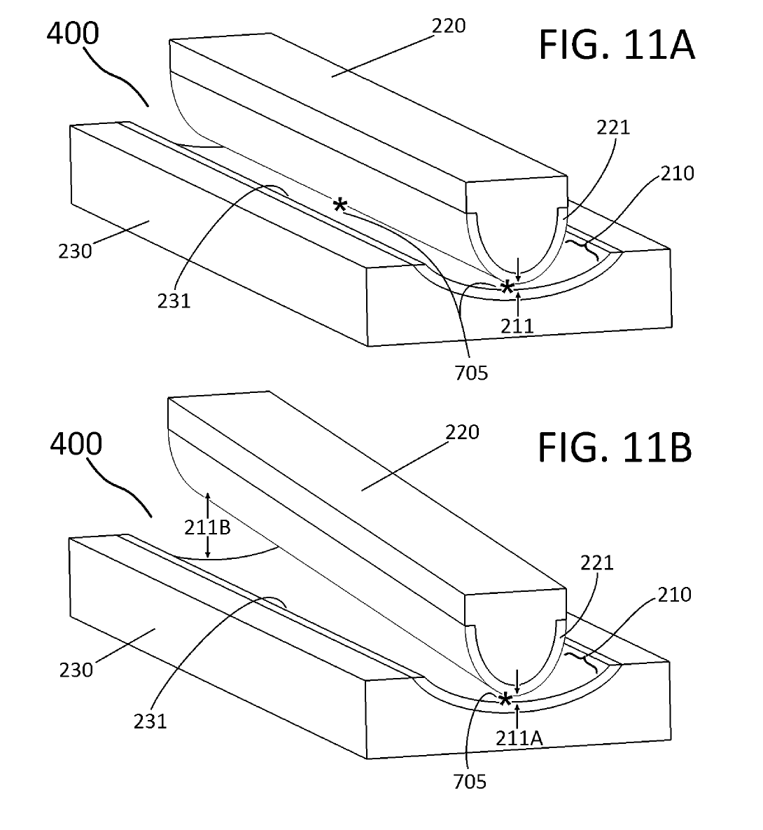

FIG. 11 depicts some aspects of one or more implementations 400. Arc electrodes 220 and 230 are elongated in one direction or axis but have curved arcing surfaces 221 and 231 forming arc gap 210. According to a principle of the disclosure, arc gap 210 has variable length or lengths 211 between the electrodes at different locations along at least one axis or in at least one direction. As with some implementations, smoothly-varying curved electrode shapes allow minimum electrode separation (gap length) for a given stand-off voltage, and first arc ignition may preferably be done at a location of minimum gap length.

These combine (along with other features and aspects) to provide both a broad arc plasma column or footprint and an orderly expansion (defined above) of an area or width of the arc plasma column as I_{arc} increases as well as an orderly contraction of the arc plasma column as I_{arc} decreases. All of these features and others promote broad, low-impedance, high-current, low arc voltage plasma columns, which in turn reduce power and energy dissipation in the arc switch and avoid high-voltage arc instabilities, all according to principles of the disclosure. As depicted in FIG. 11, surfaces 221 and 231 comprise relatively thick layers of 0.1 to several mm thickness, without limitation, of arc-enhancing material. In FIG. 11A, electrodes 220 and 230 are configured with their apex lines parallel and equally spaced along a line of closest approach of one to the other; gap 210 has the same length 211 all along the length of the two electrodes in their elongated direction. Because of this constant longitudinal gap length, several locations of first arc ignition 705 may be chosen, and, as mentioned, it may be preferred but is not limiting to chose these at regions of shortest arc gap length. Two such locations 705 are indicated by asterisks. Once an arc is initiated near the apexes of the electrodes, the disclosure provides that a low-voltage, cold-cathodic arc column or channel forms substantially between the apexes and subsequently expands or broadens to more fully fill arc gap 210. In some implementations with the option shown in FIG. 11A, however, the initial broadening of the arc column may be chosen or urged to occur along a line or plane of closest approach of electrodes 220 and 230, that is, longitudinally along their apexes. Then, from there, as I_{arc} increases still further, column broadening can occur perpendicular to the plane of the apexes and up (as drawn) and laterally (transversely) into regions of longer gap length. Note that the term “column” for the arc column or channel is generalized herein to include a sheet or plate-like slab of plasma and does not retain the usual architectural significance of the word. The choice of locations 705 of ignition of the arc may determine, in part, an initial rate-of-rise of I₇₀₅(t) through the switch. If one of the locations 705 is chosen that is not at the end or edge of the gap, then initial propagation of an arc front can go in two directions simultaneously, so initial current rate-of-rise may be twice as fast. Alternatively, in FIG. 11B, electrodes 220 and 230 are configured with their apex lines not parallel but canted at a slight angle, 0.1 to 10°, without limitation, along a line of closest approach of one to the other; gap 210 length increases from 211A at one end to 211B at the other end along the elongated direction of the two electrodes. In this FIG. 11B configuration, location of first arc ignition 705 is preferably chosen, but without limitation, to be at the location of overall shortest gap length, as shown. As with the FIG. 11A configuration, the initial broadening of the arc column of the FIG. 11B apparatus may occur longitudinally along a line or plane of the apexes of the electrodes 220 and 230 and, then, from there, perpendicular to the plane of the apexes and up (as drawn) and transversely into regions of longer gap length as increases further.

However, as a design option, the off-parallel angle of the apex lines may be made larger, so that apex-to-apex gap length becomes larger than the off-apex transverse gap length, which may urge plasma to expand laterally before a plasma front in the plane of the apexes reaches the longitudinal end of electrodes 220 and 230 away from the location of ignition 705. Moreover, a degree of transverse curvature or generalized “radius” of curvature of electrode 220 or 230 (or both) may be varied along the length of these electrodes, not shown, which can further control a transverse-to-longitudinal gap length and thus control a longitudinal and transverse arc front propagation pattern in gap 210. Varying such arc propagation patterns may again at least affect a rate-of-rise of I_{arc}. Desirable variability of longitudinal versus transverse gap length may be implemented in many other ways without departing from the spirit of the disclosure. For example, elongated electrodes 220 and 230 need not be generally or grossly straight “bars” but may be curved in various circle-sections or crescent shapes, which may include curvature along the elongated direction of an electrode and in planes that change gap length at the apexes as a function of length along the electrode(s). For example, alternate arcing surface profile 222 of electrode 220 in the device of FIG. 13 provides a smoothly-varying arc gap length as a function of length along an apex of 220.

Magnetic constriction of arc columns may also be mitigated in the implementation of FIG. 11 and in other similar longitudinally-extended-electrode instances. Longitudinal electrode and arc gap geometries similar to that of the implementation of FIG. 11 may not provide cancellation of fluxes for 360° around an axis as does the implementation of FIG. 8, but the aspect that the self-current magnetic fields do not vector sum in the same plane is still provided. Additionally, the line-growth or expansion along a line of the initial arc column along the apexes spreads out and dramatically increases a volume and a cross-sectional area of space through which lines of magnetic flux pass. This in turn severely decreases B, which is a vector flux density. Thus an arc gap with an enforced linear spreading of arc plasma may conduct to much higher total I_{arc} before magnetic constriction becomes important; an estimate is at least a factor-of-ten higher I_{arc} before magnetic constriction matters. Longer electrodes provide a way to carry higher absolute I_{arc} at lower Φ_{arc}, as well. Moreover, the above-mentioned design option to control a longitudinal and transverse arc front propagation pattern in gap 210 gives a way to introduce out-of-plane B field vector components before the arc front has propagated longitudinally to the end of the electrodes. The self-current magnetic aspects of some implementations may provide advantageous design options for arc conductors.

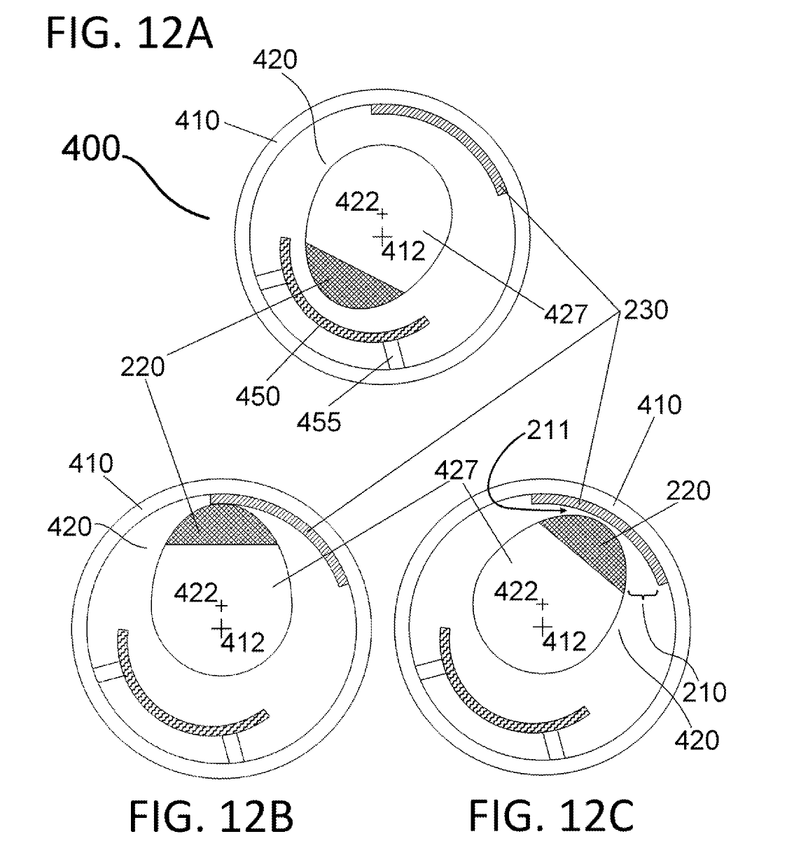

Some implementations may be advantageously configured with mechanically movable arc gap structures. FIG. 12 depicts three end-views of an elongated arc electrode-pair assembly 400 in which the longitudinal dimension of configuration FIG. 11A extends perpendicular to the plane of the page, as drawn. The curvature of the electrodes in FIG. 12 are from a different “family” than the curvature of the FIG. 11 electrodes, but are favorable to implement the disclosure. Cylindrical version 400 of arc switch 200 comprises an outer structural cylinder 410 for support and protection. Arc electrode 230 is attached to support 410 as shown. Optionally circularly-curved electrode 230 has center of curvature 412 which is also the principal axis of cylinder 410. Inner longitudinally-extended structure 420 comprises arc electrode 220 supported by rotating insulating support structure 427. Inner electrode assembly 420 rotates via support structure 427 around axis 422, which is offset from principal axis 412 of outer cylinder 410. Electrode 220 forms a “lobe” at the farthest extension off of axis 412, as supported by lobe support structure 427 of inner electrode assembly 420. Electrode assembly 420 is supported by a shaft (425, not shown) driven by external means (not shown). As 420 rotates about axis 422, farthest-extending tip of electrode 220 may touch electrode 230 or move away from 230. FIG. 12A depicts a rotary angle of inner electrode assembly 420 defined as the switch-open position, that is, a non-conductive state, which may be one of several such angular positions. FIG. 12B depicts a rotary angle of inner electrode assembly 420 defined as the arc striking position. FIG. 12C depicts a rotary angle of inner electrode assembly 420 defined as an arc burning position, which may be one of several such angular positions. Rotary angle of inner electrode assembly 420 may preferably be changed at some user-selectable angular velocity and, because of the mass and moment arm of 420, achieve a desired angular momentum. Also, angular velocity of inner electrode assembly 420 may preferably be stopped at predetermined angular locations with selectable deceleration rate and held in place by conventional means. In one mode of switching operation, the switch closing starts from a non-conducting state similar to that depicted in FIG. 12A, then inner electrode assembly 420 is accelerated clockwise to a desired angular velocity through a position approximately depicted in FIG. 12B and decelerated to rest at a position approximately depicted in FIG. 12C. While passing through the arc striking position (12B) at substantial angular momentum, tip of electrode 220 moves along a path to collide with an edge or a face portion of stationary electrode 230, then shifts inward, generally toward axes 412 or 422, from said collision path along provided means (not shown) enough to scrape against and pass over face of 230 and continue rotating at substantially undiminished angular velocity. Before collision, tip of electrode 220 may be urged outward toward said collision path by a spring, by centripetal/centrifugal force or by other means. If electrodes 220 and 230 are electrically energized by an external circuit, such as depicted in FIG. 8, the 220-to-230 electrode collision event and subsequent separation of the electrodes may draw an arc between electrodes 220 and 230. When inner electrode assembly 420 stops rotating at a position near that depicted in FIG. 12C, an arc gap 210 may have been created, with an arc burning in it. Note that, due to the distance offset of axis 422 from axis 412, electrode 220 tip moves in an eccentric relationship to cylindrically curved face of electrode 230, where a length 211 of arc gap 210 may be set or changed by setting or changing an angle of inner electrode assembly 420 about axis 422. Generally, gap 210 length 211 increases as said angle increases in a clockwise direction, as depicted, from the arc striking angle of FIG. 12B toward the starting angle of FIG. 12A.

When inner electrode assembly 420 is stopped at an angular position near that depicted in FIG. 12C, with an arc gap length 211 set by that angle and an arc burning, the physics and behavior of the arc conductor may be substantially as described with respect to FIG. 11A above. In addition, however, the end-user has the benefit of being able to change gap length 211 as desired during a switch conduction event. When it is desired to terminate an arc conduction event, the angle of inner electrode assembly 420 may be accelerated toward a position near that of FIG. 12A. This motion drastically increases electrode separation and gap length, thereby increasing arc plasma impedance, and may extinguish the burning arc. Optionally, an arc quenching baffle, shield, chute or other structure 450 may be configured to function when angle of inner electrode assembly 420 approaches or reaches a position near that of FIG. 12A. Support or actuator(s) 455 may position arc quenching aid 450 as required.

Functional and operational characteristics of an arc switch of type depicted in FIG. 12 include, as mentioned, means of adjusting certain properties of an arc gap and means of terminating arc conduction. Arc-enhancing material may be disposed on arcing surfaces of electrodes 220 and 230 much as shown in FIG. 11 by original fabrication, though not shown explicitly in FIG. 12. Replenishing of arc-enhancing material is not provided by the arc striking means, so other means may be used or electrodes 220 and/or 230 may be replaced from time to time as a maintenance operation. Arc-enhancing materials as identified above herein are very favorable for arc ignition by electrode-touching drawing of an arc. In addition to exhibiting desirable arcing and arc-expansion characteristics, these materials are relatively soft and malleable and form relatively weak weld bonds which are easily broken. This latter property may significantly reduce an angular momentum or motive power required to strike an arc by rotation of inner electrode assembly 420. The particular type of mechanical-touching striking of the arc at least potentially allows contact along the full length of electrodes 220 and 230. This is superb for actually triggering an arc, because inevitably one or only a few last-contacting points along the length may concentrate “draw-away” current to produce a quite intense spark(s). However, the relatively long length of electrode contact before draw-away may conduct more current from the external circuit than minimally necessary to reliably strike the arc. Electrode 220 or its moving assembly 420 may be tapered or tilted, respectively, to give a geometry similar to that of FIG. 11B, which may create striking contact at only one end of electrodes 220 and 230. In some implementations, either electrode 220 or 230 arc surface may be curved so as to make striking contact at only a limited length along the apex of the electrode, as depicted in FIG. 13 as optional electrode surface profile 222.

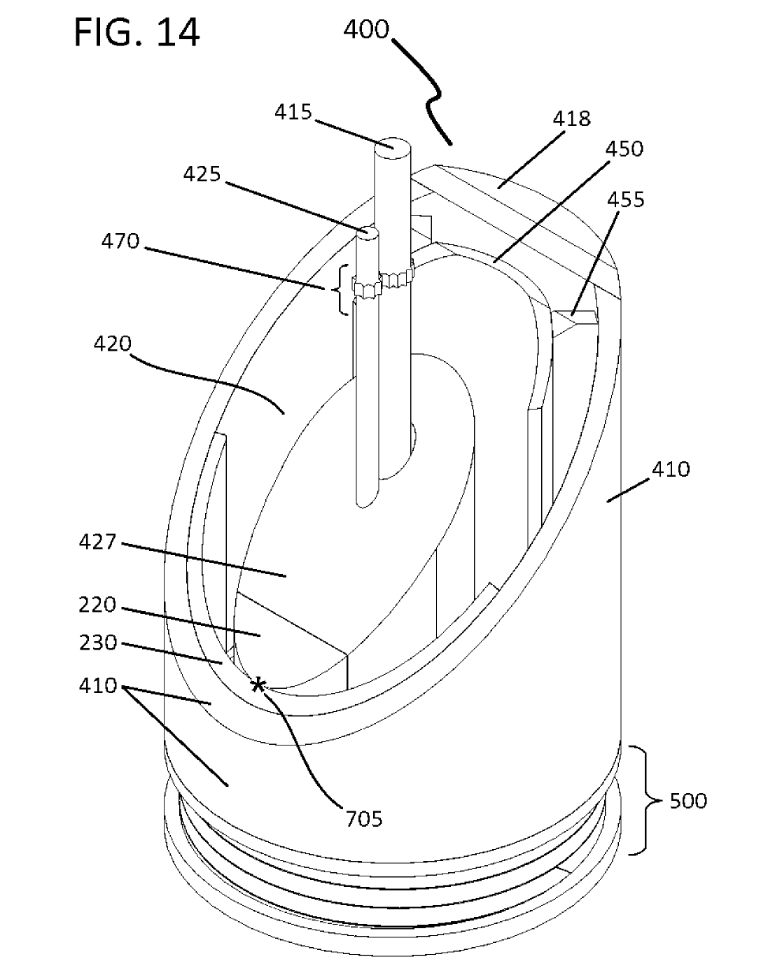

In some implementations incorporating elongated arc electrodes as in FIG. 11 in a cylindrical, rotary housing and mechanism, as in FIG. 12, may be implemented to practice several aspects of the disclosure. FIG. 13 depicts such a cylindrical implementation 400 of arc switch 200 connected to an external electrical circuit, schematically and functionally, and FIG. 14 shows a computer-aided design 45°-cut-away perspective of a device. Referring to both for better understanding, the circuit topology of FIG. 13 may be similar to that in FIG. 8, except that the external load additionally comprises a resistive element. The resistive load R_{L} may cause a continuous draw of current after any circuit-closing surge, which, if of great enough magnitude, may prevent an arc in arc conductor 400 from self-extinguishing. Series resistances R_{S} and Rᵢₙₜ are internal or inherent to the source and load, respectively, and are not explicitly added components. FIG. 13 shows switch 400 in roughly an arc-conductive rotary position of inner electrode assembly 420, similar to as in FIG. 12C, while FIG. 14 shows switch 400 in roughly arc striking rotary position of inner electrode assembly 420, similar to as in FIG. 12B. Note arc gap 210 location in FIG. 13 and first arc ignition location 705 in FIG. 14. The benefit of some implementations being able to break a burning arc is implemented at least by increasing arc electrode 220-to-230 separation distance (gap length) by eccentrically rotating inner electrode assembly 420 to an angle approaching that shown in FIG. 12A. This is accomplished by rotating shaft 425, which is fixedly attached to electrode support structure 427 and electrode 220 of assembly 420; shaft 425, in turn is rotated via rotary coupler 470 by shaft 415, which is in turn rotated by motor 460, which is fixed to cylindrical support structures 410 and 418 by bracket 461. The other electrode 230 and arc quenching aid 450 are angularly positioned relative to structure 410/418, if not rigidly fixed to it. Support/actuator 455 serves 450 in this way. As an aid to cooling (spreading of arc-dissipated heat), electrode 230 may be preferred as an anode for the conduction event, may be thermally bonded to structure 410/418 and may be over-sized relative to its active arcing surface region. Electrode 230 is over-sized as depicted in FIG. 14. Cooling may also be provided to electrode 220 via electrode support structure 427; water flow, forced air or other heat removal agency may be fed to 427 using substantially rigid tubes as shafts 415 and 425, or by other means.

Electrically, an external circuit may be connected to apparatus 400 as shown in FIG. 13 by terminals 440, which are analogous to connections 290 in FIG. 8. Connection of positive pole of the power source, as depicted in FIG. 13, may be made directly if at least a portion of electrode 230 is exposed on an outer cylindrical wall 410. In some implementations, e.g., in FIG. 14, connection to 230 may be made through one of the two end-plates 418. One or more vent ports 419 in plate(s) 418 or elsewhere allow pressure release of medium 205 which may become heated due to action of an arc in gap 210. FIGS. 13 and 14 illustrate at least two different construction principles. In FIG. 13, electrode material 230 can be made accessible, for example for quick change-out, from outside of cylinder 410. Also, cylinder 410 is fabricated of substantially insulating material, and electrode 230 can optionally be cooled from outside of wall 410 and be made as small as possible in angular width, as measured by an angle swept by rotation of inner electrode assembly 420. This mode of implementation is favored for high voltage power sources in the external circuit and in applications in which circuit currents may be low or added external cooling is available for electrode 230. By contrast, FIG. 14 shows cylinder 410 fabricated of metallic and thermally conductive material and electrode 230 being oversized and thermally bonded to wall 410. This mode of implementation is favored for low voltage (for example, <500 V) power sources in the external circuit and in applications in which circuit currents may be high and added external cooling is not available for electrode 230.

Breaking or disrupting an arc that may be driven by a high open-circuit-voltage power source may be difficult, and this must be done with stringent attention to all possible stray arc conduction paths. In the implementation of FIG. 14, with a high voltage external source, metallic wall 410 itself may become a stray arcing electrode as assembly 420 swings electrode 220 toward the arc extinguishing angle indicated in FIG. 12A. This may likely defeat quenching of the arc. The negative pole, as depicted in FIG. 13, of the external power source and load is connected to moving electrode 220 by standard means. The other terminal 440 may be connected at terminal block 434 on apparatus 400, and current flow from there through conductor 432 and through rotary electrical connection or feedthrough 430 to attachment 431 at electrode 220. Item 500 is a variable resistor not needed for the function of circuit in FIG. 13 and is described below.

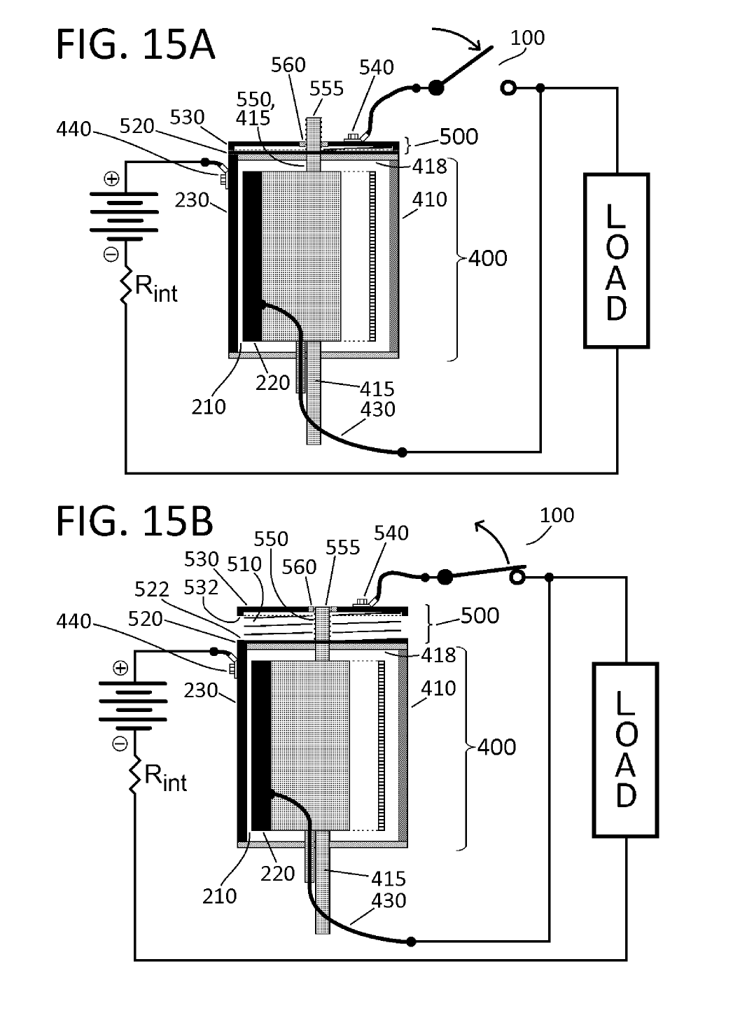

Construction details of elongated-electrode cylindrical arc switch 400 of FIG. 13, and example variants using it such as in FIG. 15, are as follows. Outer arc electrode 230 is the anode electrode of the arc gap (not limiting). This is chosen because 55% to 80% of dissipated heat in a cold-cathode arc typically ends up in the anode, and the outer electrode and/or its heat sink can be can be made larger in size and thermal mass without changing any other component of the switch. In some implementations, shown in inset FIG. 13B, which is a section view along main axis 412, electrode 230 has been bonded to heat sink 235 using braze joint 236. This assembly may be attached to outer support cylinder 410 by appropriate fasteners, for easy replacement. Based upon a desired current impulse(s) expected from the external circuit through switch 400, and the consequent amount of heat energy to be released in switch 400, Eqns. 7-13 may be used to calculate a needed thermal mass for the 230-236 assembly. Given materials selection for 230 and 235, and heat capacities for those materials, a mass of the 230 and 235 materials may be determined, and shapes for these parts designed accordingly. Support cylinder 410 may be fabricated from an electrically insulating material, such as a glass fiber reinforced plastic or a ceramic. Optionally, grooves 411, ridges or other features are provided to shadow selected surfaces of 410 from metal vapor deposition and preserve or prolong an insulating condition along inner walls of 410. This practice, or similar ones, may be useful because arcs may liberate stray metal vapor routinely during arcing which may deposit and create electrical conduction paths or arc-prone surfaces on formerly insulating materials; these conduction paths may defeat terminating a burning arc by electrode separation, as desired when opening arc switch 400.

Grooves 411 are depicted only on one quadrant of cylinder 410 but may be provided everywhere on the interior. Likewise, similar structures to break up surface conduction paths may be provided on most surfaces of rotating electrode support 427 and on cylinder end closures 418, suitable shapes and placement of which may be known to those familiar with the art. Inner electrode 220, its rotating support 427 and its rotational drive shaft 425 may be considered a single assembly (420) and may be designed for easy replacement and low cost. Electrode body 220 may entirely comprise arc-enhancing material such as Sn, Pb or Bi, which are soft, low-melting metals. They may be hammered, pressed, forged, injected, cast or formed by other known operation into a mold to produce a desired shape. The shape may comprise an arcing surface profile similar to that depicted in FIG. 12, a rear “key” or retention feature and a socket or alignment feature for shaft 425. The remainder of electrode support 427 may be cast or injected of glass fiber-filled electrical grade epoxy, such as Bakelite EP 8414 resin. Rear key and shaft 425 can be embedded in and locked into place with respect to electrode 220, substantially as shown, by the epoxy. Shaft 425 may be fabricated of metal and itself may be conductor 430 of FIG. 13, or a separate wire or other conductor 432 may be fastened at 431 to the back of electrode 220 before potting or casting in resin, substantially as shown. Shaft 415 preferably comprises insulating material such as fiber-reinforced plastic, many of which are available. Shaft 415 is inserted into a clearance hole cast into or drilled through electrode support 427, substantially as indicated in FIGS. 12 through 14. The fit of shaft 415 in said hole is relied upon for alignment, rotational bearing and side thrust for arc striking, so appropriate lubrication or bushing may be added. The remaining features of apparatus 400 are substantially as depicted in FIGS. 12 through 14, with added information given in the descriptions of operation and performance. Several design choices may be available to provide a working implementation, all of which may be known to those skilled in the art.

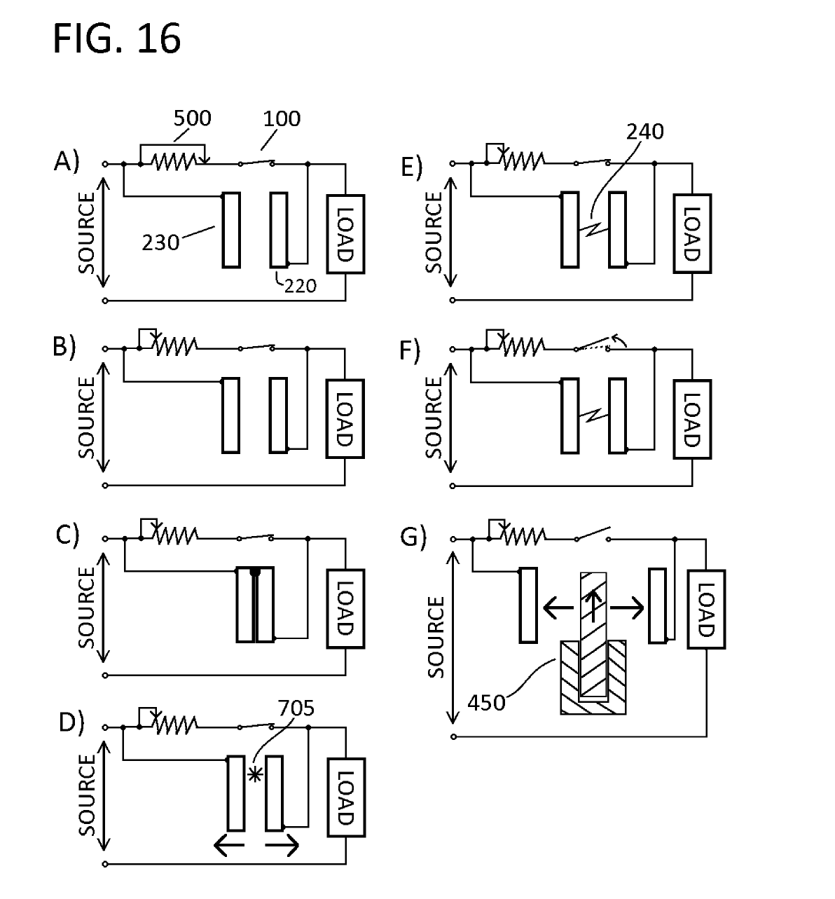

A rotary cylindrical implementation 400 of an arc switch 200 can also be configured as a switch assistor. As mentioned, an arc conductor switch 200 can solve the problem of surge currents and voltage transients causing damage to commercial-off-the-shelf (COTS) conventional, prior art metallic-contact or semiconductor-junction switchgear, in which case the arc switch may be termed a “switch assistor”. FIG. 15 shows a simplified representation of the switch 400 of FIGS. 13 and 14 in a power circuit with COTS switch 100. As defined herein throughout, known switch 100 may comprise a mechanical solid-solid contact switch device (relay, contactor, hand-operated knife switch and the like) or a solid-state, semiconductor junction switching device. Apparatus components and functions already described with respect to FIGS. 13 and 14 are the same for corresponding apparatus elements and operations appearing in FIG. 15. The electrical load represented in FIG. 15 may be substantially as depicted in FIG. 13, but in any case may draw an in-rush current, indicated by a capacitor though it may be due to field build-up in an inductor, and may draw an on-going lower level of current sufficient that an arc in an arc switch may not self-extinguish, indicated by a resistor in the load. FIG. 16 gives simplified electrical schematic diagrams and symbolically depicts mechanical operations or steps, and may be referred to especially to understand FIG. 15B. In FIG. 16, arc electrodes and their arc gap are symbolized by stylized open rectangles and whitespace between them away from the circuit current connections. These generically represent any shape of arc electrodes and gap of the disclosure, even parabolic ones of FIG. 8.

FIG. 15 shows two example cases, FIG. 15A and FIG. 15B, with the same general circuit topology. A power source, a “switch” and a load all are in series in a single current loop or circuit. However, the “switch” is a compound switch comprising prior art COTS switch 100 and arc switch 400 in electrical parallel relation with each other. Either 100 or 400 may close the circuit and connect current through the load. Moreover, device 500, a variable resistor operable in conjunction with arc switch 400, is also inserted in series electrical relation with COTS switch 100, and both the switch 100 and the variable resistor are placed in electrical parallel relation with arc gap 210 formed by electrodes 220 and 230 of arc switch 400. In FIG. 15A, variable resistor 500 is in a low-resistance state, which is close to zero resistance or a short-circuit. If arc switch 400 is non-conducting and switch 100 is closed, the state of the circuit is represented in FIG. 16A. If the same state existed in FIG. 15A, current may flow, entering terminal 440, passing through electrode 230 to base plate 520 of resistor 500, then enter cap plate 530 of resistor 500 and flow out through terminal 540 to switch 100 and on through the load and back to the negative terminal of the power source. However, as depicted in FIG. 15A, switch 100 is open and no current flows.

A switch-closing operation utilizing switch assistor 400/500 starts from the state depicted in FIG. 15A. Arc switch 400 is operated substantially as described with respect to FIGS. 12 and 13 to strike an arc in gap 210 of switch 400. This action bypasses still-open switch 100 and passes current through the load. Any circuit-closing current surges or transients are conducted or otherwise borne by arc switch 400. After a period of time sufficient to allow any surge currents to subside, switch 100 may be closed. Closure of switch 100 substantially short-circuits arc gap 210 to very low voltage differential, thus extinguishing any arc in gap 210. Note that it was not necessary to extinguish the arc using any operation of arc switch 400, such as separating electrodes 220 and 230, as described above.

A switch-opening operation utilizing switch assistor 400/500 of the present disclosure provides arc conduction in parallel with COTS switch 100 before opening 100, which may protect switch 100 from, by way of example and not limitation, inductive forward voltage spikes when a large motor or transformer is cut off. FIG. 16 gives the step-by-step process in symbolic format. With current flowing through closed switch 100 and the load, resistor 500 is operated to increase its resistance. This state is shown in FIG. 15B. The resistance creates a V=IR voltage drop across the resistor, which also appears across arc gap 210. If the current through the load is sufficient, a voltage difference of 100, 50, 30 or 20 volts or thereabouts may be present across gap 210, which may be sufficient to allow an arc to be ignited and established in arc assistor 400. The arc is ignited in substantially as described with respect to FIGS. 12 and 13, and this is represented as sequential steps C through E in FIG. 16. After a period of arc settling time (milliseconds to tenths of seconds), switch 100 may be opened, as indicated in step F of FIG. 16. While switch 100 opens, it is shunted by an extremely low-impedance arc burning at desirably near 10 volts, but most likely between 2 to 50 volts. Thus switch 100 may be protected from surge current and high-voltage transients. After switch 100 is open, all load current flows through arc gap 210 of assistor 400. The arc may be extinguished when desired as in step G of FIG. 16, that is, using electrode separation, obstruction of the arc plume with baffles, quenching in an arc chute, deflecting with magnetic fields and other known methods. For the elongated rotary electrode type, the arc extinguishing action has been described above with reference to FIGS. 12 and 13.

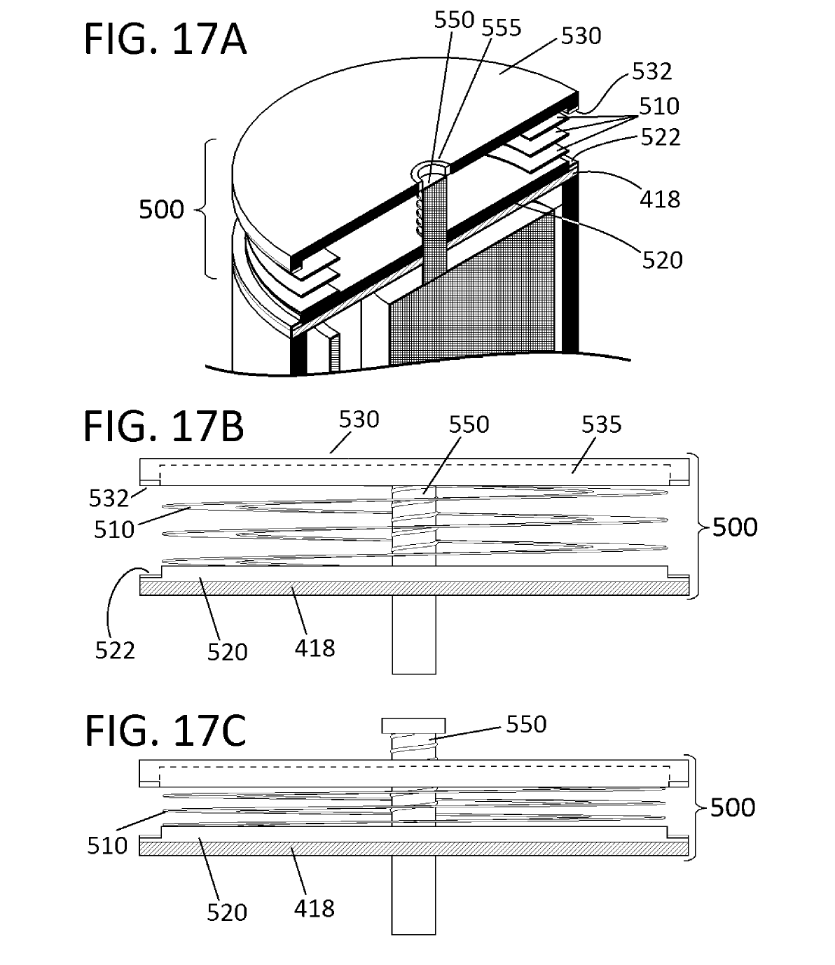

Construction features and operation of variable resistor 500 may be explained with respect to FIG. 15, which gives example electrical connections and integration with arc switch 400, and FIG. 17, which gives example mechanical detail of the resistive structure. Resistor 500 may include two separable, electrically-conductive plates 520 and 530 with resistive element 510 disposed between them. Plate 530 is movable relative to 520 by action of arc switch 400, specifically rotation of shaft 415, which may be rotatably connected to shaft and lead-screw 550. In conjunction with threaded bushing 555, rotation of 550 forces together plates 520 and 530, as shown in FIG. 15A, or separates them, as shown in FIG. 15B, FIG. 17A and FIG. 17B. FIG. 17C shows an intermediate degree of separation. When plates 520 and 530 are forced tightly together, resistive element 510 collapses into recess 535 of plate 530, so that special raised lands or other mating features near the rims of plates 520 and 530 touch. As indicated in FIG. 17, prepared surface 522 of plate 520 is configured to make substantially flat, face-to-face and intimate mechanical contact with prepared surface 532 of plate 530. This junction at surfaces 522-to-532 is an electrical contact allowing electrical current to flow between 520 and 530 substantially without passing through resistive element 510. Prepared surfaces 522 and/or 532 may optionally comprise separate layers of contact junction material such as Ag—Cd, without limitation. Shaft 550 may also be actuated to separate plates 520 and 530, thereby breaking electrical contact between 522 and 532. Electrical isolation of 520 from 530 may be assured by fabricating shaft 550, bushing 555 or friction ring/slip clutch 560 (see FIG. 15) of insulating material, as design options. When plates 520 and 530 are electrically isolated, current between must flow through resistive element 510, if circuit connections are made as indicated in FIG. 15B. Resistive element 510 may be formed as a flat ribbon of sheet metal wound in a helical fashion substantially as depicted in FIGS. 17A-C. One end of flat ribbon 510 is mechanically and electrically fastened to plate 520 and the other end is similarly attached to plate 530. Means of attachment may be brazing, welding, spot-welding, screws, clamps and many other configurations, as a design choice. The shape of resistive material and its winding or folding pattern are a matter of design choice and are not limiting. For example, wire forms or woven mesh sheets could be used instead of flat metal foil/sheet stock. For example, rectangular “accordion folds” could be used instead of a flat helix coil. Likewise, resistor materials are a matter of choice. As depicted, 510 is suitably fabricated from “Nichrome” or nickel-chromium alloy foil; however, tantalum, stainless steel, Hastalloy, Invar, graphite-impregnated fabric or other conducive sheet may be used. Generally, a suitable material is tolerant of exposure to air while at high temperature, has a high melting temperature, retains mechanical flexibility without work-hardening, is easy to make electrical connection to and is not costly. Using such options and choices of design, a principle of invented resistor 500 selects at least a length, a cross-sectional area and a material resistivity to provide a resistance value to electrical current that is suitable for the magnitude of current expected in an external circuit, such as that of FIG. 15, being served by switch 100 and switch-assistor 400/500. As mentioned, a voltage drop across resistive element 510 may be sufficient to allow an arc to be ignited in arc switch 400; if a voltage developed across resistive element 510 is greater than a minimum needed to sustain an arc, arc switch 400 is tolerant of such a condition and may function nonetheless. Thus a designer has wide latitude of choices and/or a single Ohm-value of resistor 500 may serve many different circuits, both of which are economic benefits.

In operation, variable resistor 500 may change state from a low resistance (˜zero) state to a high resistance state in coordination with arc switch 400 to create switch-assistor 400/500. Generally, resistor 500 need be in a high resistance state only shortly before, during and shortly after ignition of an arc in 400 during a switch-100 opening operation; during a switch-100 closing operation, resistor 500 may stay in a low resistance state. Generally, resistor 500 may be in a low resistance state as a default, since especially if switch 100 is closed and load current is flowing, current may be flowing through 500 and power dissipated as I_{load}²·R₅₀₀ in resistor 500 may normally be unwanted waste heat. Variable resistor 500 could be configured as a separate, stand-alone device, but a preferred implementation couples resistor actuator shaft 550 with arc switch shaft 415 to effect the aforementioned coordination of resistance state changes of resistor 500. Referring now to FIGS. 13 and 14, rotary coupler 470 between shaft 415 and shaft 425 determine a set of rotational or angular states of shaft 415 at which rotating electrode assembly 420 strikes an arc in switch 400. As mentioned and drawn, shaft 415 may also be coupled to actuator shaft 550 of resistor 500. Several adjustments of the relative phase of the arc striking motion with the resistor motion to mate/separate plates 520 and 530 are possible. In a simple configuration, rotary coupler 470 is a pair of engaged gears, as depicted in FIG. 14, with gear ratio and phasing set to mate or close together plates 520 and 530 twice during a 360° rotation of rotatable electrode assembly 420, once at the arc off/extinguish angle (shown in FIG. 12A) and once at the arc burning angle (shown in FIG. 12C). These angles may be approximately 180° apart from each other. At other angular positions, particularly the striking angle (shown in FIG. 12B) and a range of angles near it, plates 520 and 530 may be separated and resistor 500 may be in a high resistance state. Several ways of implementing such a motion are known, including configuring previously mentioned shaft 550, bushing 555 or friction ring/slip clutch 560 to be an auto-reversing (at end of travel) ball-screw and ball-nut mechanism instead.

In some implementations, much more adaptable and capable drive systems can be implemented. For example, rotary coupler 470 may also comprise a clutch, so that shaft 550 of resistor 500 may be rotated without moving rotatable electrode assembly 420, and friction ring/slip clutch 560 may allow rotatable electrode assembly 420 to move even though shaft 550 is at end-of-travel. Motive may mean completely different from motor-driven lead-screw or ball-screw may be used, such as pneumatic cylinder stroke, electromagnetic linear solenoid and numerous others. Since default or at-rest positions can be defined for both resistor 500 and rotatable electrode assembly 420, spring-loaded return to a standard position may be implemented, or a detent or latch can be provided to retain the moving component in an expected position. Such design may be beneficial in case of loss of information of the state of switch assistor 400/500.

A controller or operational/step sequencer means may be interfaced to switch assistor 400/500 and any appropriate sensors. Sensors for electrical current, temperature of resistive element 510 or electrodes 220/230, certain mechanical positions and other data may be useful for rapid operation and safe response in exception conditions. Though some step sequences can be mechanically, internally programmed as described above, an operation with several states and steps, such as the switch-opening operation of FIG. 16, may benefit from additional sensing and control. In any case, coordination of switch assistor 400/500 with external switch 100, and control of both by a higher-level system controller, may warrant interfacing switch assistor 400/500 to an electronic or other controller. It is believed that switch assistor 400/500 may beneficially comprise a small, rugged and low-cost controller proximate to (“local” to) assistor 400/500 as part of an integrated package sold to end-users. A user signal that formerly controlled, for example, the actuator coil of relay or contactor 100 may instead be routed to or through the local controller. This controller may drive switch 100's actuator coil and switch assistor 400/500's action in appropriate time sequence to protect switch 100 upon closing or opening. Such a method may minimize or eliminate changes to existing wiring and control systems upon introduction of switch assistors of the present disclosure.

An example implementation, e.g., of the metal-arc-based switch and moving electrical contact, may be used for charging and discharging high-energy (MJ, GJ and higher) capacitors capable of high power. Capacitor power refers to the speed of charging or discharging, which if taken as 0.1 second through a low-impedance load, may mean a power level of 10 MW, 10 GW and higher. A practical example of this preferred implementation is transfer of electrical energy quickly to capacitors in a locomotive of a moving electric train. The disclosure resides in apparatus components located both in the charging station and in the locomotive, as well as methods of their interaction to transfer motive energy to the locomotive. This implementation is by no means limiting, since many other types of vehicles other than trains, as well as many other devices and systems, may use the present disclosure for transfer of electric energy.

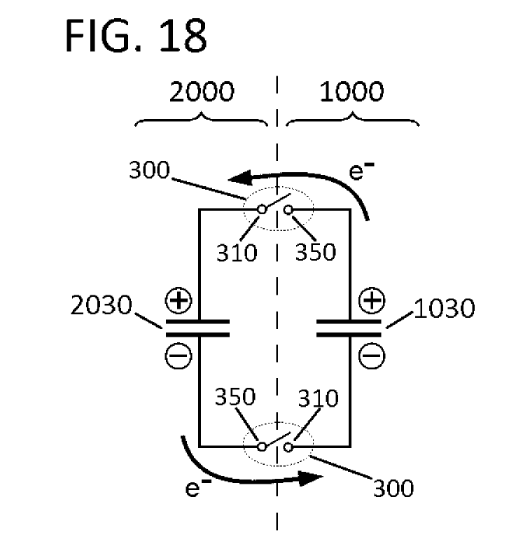

The general idea and nomenclature of rapid capacitor charging may be defined in the situation in which one energy storage capacitor charges another energy storage capacitor. FIG. 18 shows the conceptual situation. Inside a device or vehicle to be charged 1000 is capacitor 1030, which may actually be a bank of multiple capacitors in various series-parallel interconnected topologies. Inside charging station or energy source 2000 is capacitor 2030, which likewise may be a plurality of capacitors. Capacitor 2030 begins with a large degree of charge separation on its internal plates or electrodes having positive and negative polarities as designated. When metal-vapor arc switches 300 of the present disclosure close or become conductive, capacitor 1030, which is less charged than 2030, may acquire an increased charge separation on its internal plates with polarities designated. The degree of charge separation for each capacitor 1030 or 2030 is measured by the voltage across the capacitor plates, V=Q/C, where Q is charge disparity or quantity of charge of opposite polarities each plate has above or below the equilibrium (equal) charge state, measured in Coulombs [C]. C is the capacitance of each of 1030 or 2030 measured in Farads [F]. It may be that C₂₀₃₀≠C₁₀₃₀. An electron flow, and possibly, in some situations, a positive ion flow in the opposite direction, mediates the change in charge separation of the two capacitors 1030 and 2030 and is indicated in FIG. 18 by heavy arrows. V₂₀₃₀ decreases while V₁₀₃₀ increases, and, if switches 300 were ideal, charge may flow until V₁₀₃₀=V₂₀₃₀. In that final state, it can be shown that Q_{2030,final}=Qₜₒₜₐₗ·(C₂₀₃₀/(C₂₀₃₀+C₁₀₃₀)) and Q_{1030,final}=Qₜₒₜₐₗ·(C₁₀₃₀/(C₂₀₃₀+C₁₀₃₀)), where Qₜₒₜₐₗ=Q_{2030,initial}+Q_{1030,initial}=Q_{2030,final}+Q_{1030,final}, so the final voltage can be calculated from V₁₀₃₀=Q₁₀₃₀/C₁₀₃₀ and likewise for V₂₀₃₀. A key aspect of the present disclosure is that a switch 300 comprises two or more arc electrodes, at least one anode 310 and at least one cathode 350. A closed or electrically conducting mode of switch 300 comprises a cold-cathode arc conductive plasma column between at least 310 and 350. The conventional switch symbol used in FIG. 18, with its implied knife-switch shorting bar, is purely symbolic and does not accurately depict a means of electric conduction according to the present disclosure. Each switch 300 may be polarized, as defined in more detail later herein, in the sense that the one or more cathodes 350 may be optimized or better suited for emission of electrons into an arc plasma, while the one or more anodes 310 may be optimized or better suited for collection of electrons from an arc plasma. Note the orientation of polarities in switches 300 relative to the polarities of the two capacitors 2030 and 1030. The terms “anode” and “cathode” refer mainly to each electrode's function regarding arc or plasma conduction and do not fully describe the potential at which such an electrode sits within an overall circuit. Another difference between the metal-arc-based switch of the present disclosure and many other types of switches and contactors is that switches 300 may automatically open circuit when charge flow driven by the external circuitry ceases. The arc plasma (the conductor) in a closed switch of type 300 may die out and no longer conduct when the voltage between 310 and 350 becomes less than 2 to 15 volts, or a few tens of volts higher, depending upon many parameters. An arc conductor in switch 300 tends not to spontaneously reestablish itself after high voltage reappears across 310 and 350, in preferred but not limiting implementations of the disclosure, but awaits a controlled arc ignition event.

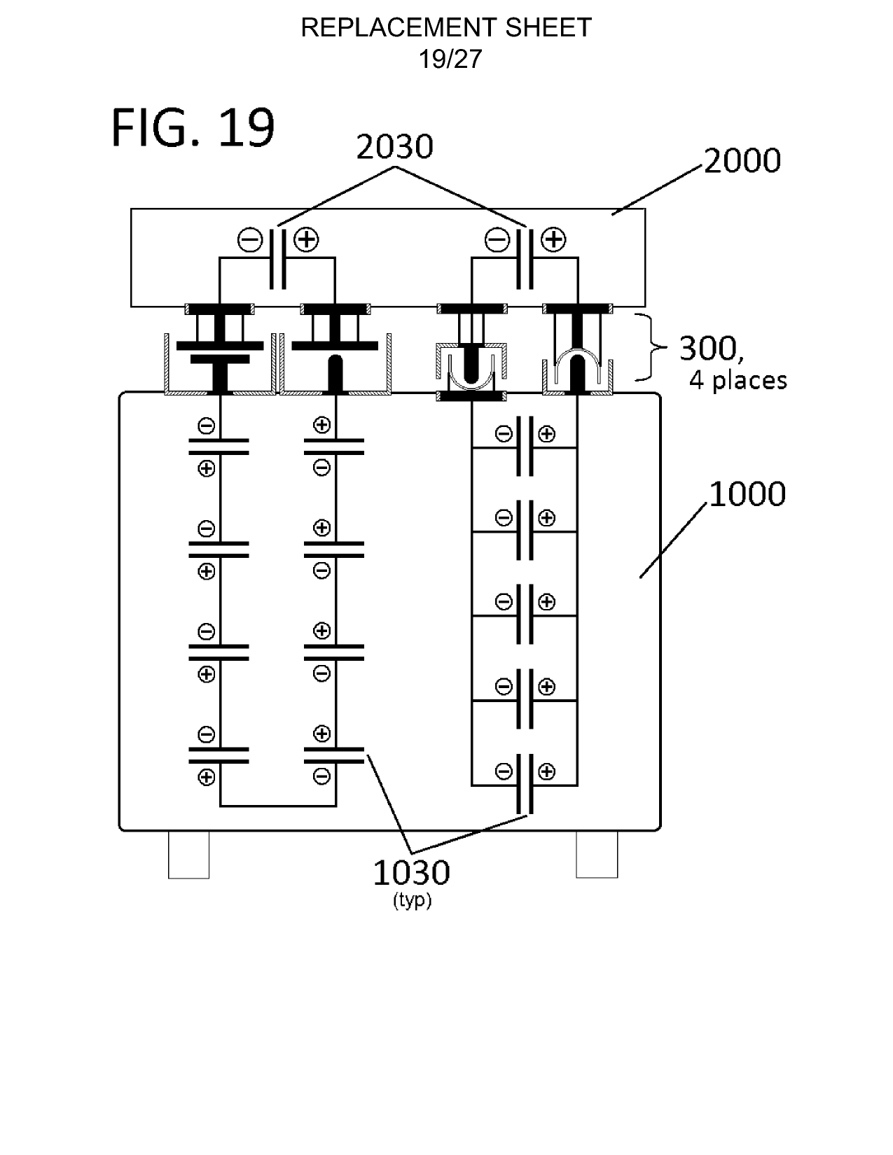

FIG. 19 shows an example implementation in more detail. A vehicle 1000 is shown in end-view in schematic cross-section having a plurality of internal capacitors 1030 for receiving, storing and dispensing of electrical energy used for vehicle operation. Not shown in vehicle 1000 are switches, regulators, sensors, motors and so forth that may be involved in using electrical energy that may be stored in capacitors 1030 for propulsion or other vehicle functions. Charging station or energy supply facility 2000 is depicted proximate to vehicle 1000 and comprises substantially-charged storage and dispensing capacitors 2030. Not shown in charging station 2000 are power sources, switches, regulators, sensors and so forth that may be involved in charging capacitors 2030. Four switches 300 of the present disclosure are shown interposed between 1000 and 2000 in a position to transfer electrical energy. Each of the four depicted switches is different in some attributes, which may be described in more detail below as aspects of the present disclosure. Similar among all the switches 300 depicted is that they comprise at least a portion associated with vehicle 1000 and at least another portion associated with charging station 2000. These switch-portions or sub-assemblies of switch 300 substantially do not make mechanical contact in an expected (preferred) mode of operation, though the present disclosure allows that they may come into contact in exception conditions or in alternate implementations and methods of the disclosure. The location of closest approach of conductors of these two portions of any switch 300 may be defined as the intended arc gap of that switch. Switches 300 are depicted in end-view, and some components thereof may be elongate in a direction perpendicular to the plane of the page, as drawn. As mentioned, some preferred implementations of the inventive switch 300 allow for translation of the non-contacting portions relative to each other, thus together comprising a moving electrical contact. In the case of FIG. 19, as drawn, a preferred direction of relative movement is perpendicular to the plane of the page. So, for example, vehicle 1000 and its associated portions of switch 300 may move into the page and/or charging station 2000 and its associated portions of switch 300 may move out of the page, both perpendicular to the plane of the page. The relative movement may occur before, during and/or after an arc-plasma conductor within switch 300 is operative to transfer electrical energy. For operation of an arc-plasma conductor within switch 300, a preferred path of relative movement of the portions of the switch brings them into a mutual position similar to that depicted in FIG. 19 and defined in full detail below. There is, however, no significance within the disclosure to the location near the top of vehicle 1000 for switches 300 and charging station 2000 depicted in FIG. 19. Switches 300 and charging station 2000 may be located proximate to the bottom of vehicle 1000, near either side or anywhere else convenient to a designer, including away from vehicle 1000 on a boom, trailer, pantograph, sidecar, pylon, towed cable and the like. The components depicted in FIG. 19 are not necessarily drawn to scale relative to each other.

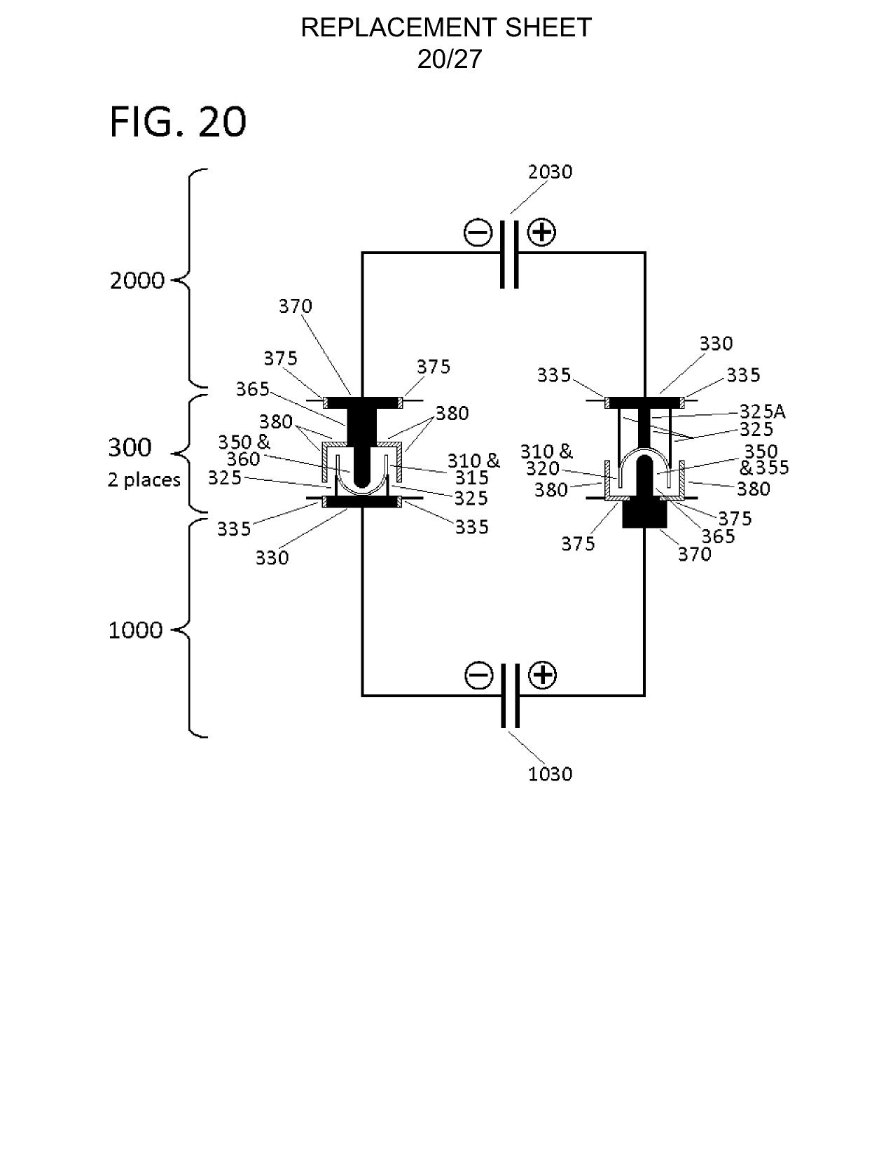

FIG. 20 shows in more detail components comprising typical switches 300 of the present disclosure in the an example implementation of a moving vehicle 1000 and fixed charging station 2000. In order to complete a desired circuit between charged capacitors 2030 in the charging station and capacitors needing charge 1030 in the vehicle, two switches 300 may desirably be used. Within switches 300 when in position to transfer charge or energy, anodes 310 may have two configurations, a shorter shoe or “slider” 315 associated with vehicle 1000 and a longer runner or rail 320 associated with station 2000. In both cases, the length is in the direction in and out of and substantially perpendicular to the page of FIG. 20, as drawn. Similarly, cathodes 350 may have a shorter shoe or slider 355 associated with vehicle 1000 and a longer runner or rail 360 associated with station 2000. Thus two reference numerals are used for each anode and cathode in FIG. 20. However, the present disclosure also includes implementations having no distinction in length between 315 versus 320 and between 355 versus 360. Note that each switch-temporary-assembly 300 is polarized according to the direction of electron flow, as explained relating to FIG. 18, rather than according to electric potential, and, in the preferred implementation, one switch 300 of each polarity for a total of two switches is desirably used for each pair of capacitors between which energy is to be exchanged. As may become evident, many pairs of capacitors similar to 1030 and 2030 and hence many pairs of polarized switches 300 may be present for numerous implementations falling under the scope of the present disclosure. In such cases with multiple capacitors, it is possible that some capacitors may share a common anode or cathode, and such configurations also fall under the scope of the present disclosure. In some implementations, switch 300 may be substantially non-polarized or bi-polar, such as the switch depicted left-most in FIG. 19. Such a switch may be non-polarized concerning its mechanical construction but may be polarized concerning electric current flow by external circuit elements during any one conduction cycle.

Further elements and functional aspects of switches 300 of the preferred implementation are depicted in FIG. 20. Anodes 310 and cathodes 350 may be shaped to form an arc gap of, e.g., 1 to 20 mm or larger when brought into desired proximity. As depicted, the intended arc gap may be identified as the location of closest approach of an anode 310 to its corresponding cathode 350. Anode and cathode shapes also provide a functional gap of similar spacing in spite of approximately ±10% or ±10 mm lateral or height (“lateral” meaning left/right and “height” meaning up/down, in FIG. 20, as drawn) proximity error. The degree of error given as ±10% or ±10 mm is not limiting but, percentage-wise, depends upon the overall size of the switch 300 and, as an absolute distance, depends upon the open-circuit voltage across the switch, the magnitude of the current to flow, the ambient pressure and a number of other parameters when the switch is closed. Anode and cathode electrodes are held in desired proximity by electrically conductive support brackets 325 and 365. Anode brackets 325 may be fabricated from thermally less-conductive and electrically more-resistive materials while cathode brackets 365 may be fabricated from thermally more-conductive and electrically less-resistive materials. As depicted in FIG. 20, anode brackets 325 may be formed to have smaller cross-sectional area perpendicular to the direction of heat flow, thus increasing their thermal impedance, while cathode brackets 365 may be formed to have larger cross-sectional area perpendicular to the direction of heat flow, thus decreasing their thermal impedance. The higher resistivity of anode brackets 325 may also generate heat due to Joule heating by an electrical current passing through them. These aspects allow an anode to retain more waste heat deposited from the arc plasma conductor of switch 300 during conduction events and therefore rise to a higher temperature than a cathode. Also, to promote the same outcome, anodes 310 may be fabricated of refractory materials (that is, able to retain their shape at higher temperatures such as 1000° C., 2000° C., 3000° C. and higher) and, as depicted in FIG. 20, be of thinner cross-section and lighter mass than the cathodes. Cathodes 350 may be of thicker cross-section and heavier mass than anodes 310. As described above, an aspect of the present disclosure associated with higher anode temperature is “recycling” or redistribution of arc-enhancing material off the anode and back onto the cathode, onto other portions of the anode and/or onto other surfaces of the switch. A further aspect of anode design is preferential removal of heat from the arc gap region of the anode electrode 310 relative to lesser heat removal from the extremities of the anode. As depicted in FIG. 20, this may be accomplished by, as an example but not limitation, forming portions of brackets 325 which support the outer extremities of anode 310 to have thinner cross-section and longer length to a heat sink, while forming portions of brackets 325 which support the arc gap-region of anode 310 to have thicker cross-section and shorter length to a heat sink. Thus thicker portion 325A of bracket 325 conducts more heat. Alternatively, in the switch depicted on the left-hand side of FIG. 20, thicker portion 325A of bracket 325 is not present, but enhanced heat flow is provided by directly contacting the arc gap region of anode 310 to a massive, cooler object 330 described below. The added cooling of anode 310 near the arc gap may permit the arc gap region of 310 to be cooler than the extremities of 310, or to achieve a desired temperature differential between the two regions. A relatively cooler temperature at the arc gap region of 310 may promote condensation and/or re-condensation of vaporous arc-enhancing material at the surface of arc gap region of anode 310. Relatively increased amounts of arc-enhancing material may be provided at a desired arc-plasma-contacting location on the surface of the anode. In some implementations, the arc-enhancing material present on the anode surface vaporizes and ionizes readily, thus enhancing the overall charged particle density of the arc plasma column and promoting lateral expansion of the cross-sectional area of the arc column, both of which may desirably reduce arc voltage V_{arc} and reduce waste heat and power deposited into switch 300. It may be noted that these same benefits of arc-enhancing material at the anode may be operative even if there is no substantial build-up of thickness of arc-enhancing material at the anode. The incoming flux to and out-going flux from the anode of arc-enhancing vapor may, on balance, result in a sub-mono-layer presence, or only a few monolayers, of arc-enhancing solid on the anode, but still the function claimed may be operative. The broadest-area arc attachment at an anode, a cathode or both, may be promoted which may provide a desirably lower arc impedance and lower V_{arc}, and methods of anode temperature management and related migration of arc-enhancing material, as well as other methods within this disclosure, promote broad area arc attachment. Remaining elements of switches 300 shown in FIG. 20 are electrical and thermal bus structures 330 and 370, as well as electrical and/or thermal insulators 335 and 375. Generally buses 330 and 370 are conductors of both electricity and heat and may be adapted by designers, within the present disclosure, to work with anode and cathode heat and temperature management methods described above. Electrical connections to circuits served by switch 300 may be made at buses 330 and 370. An additional function of buses 330 and 370 is to spread and ultimately dissipate heat that was deposited in electrodes 310 and 350 by transient (0.1 to 10 seconds or more periods) switch conduction events to surroundings outside of switch 300. Insulators 335 and 375 at least function to electrically isolate current-carrying or voltage-bearing members of switches 300 from other portions of vehicle 1000 and station 2000. Shields or baffles 340 associated with anode 310 (not shown in FIG. 20) and 380 associated with cathode 350 are provided to limit the influence of atmospheric air (or other ambient medium) upon the burning arc, to capture arc-enhancing material vapor for reclaiming, to retain heat from the arc discharge, to shield the surroundings from hot gases and radiation from the arc and to reduce acoustic noise from the arc escaping to the surroundings. Note that arc-enhancing material condensed upon shields 340 and 380 are unlikely to be recycled into switch 300 during operation but rather may be reclaimed as “scrap” during routine cleaning and maintenance of said shields. Whether reclaimed or not, there may be human or environmental health preferences to reduce dispersion of arc-enhancing material into the broader surroundings of equipment utilizing switches 300.

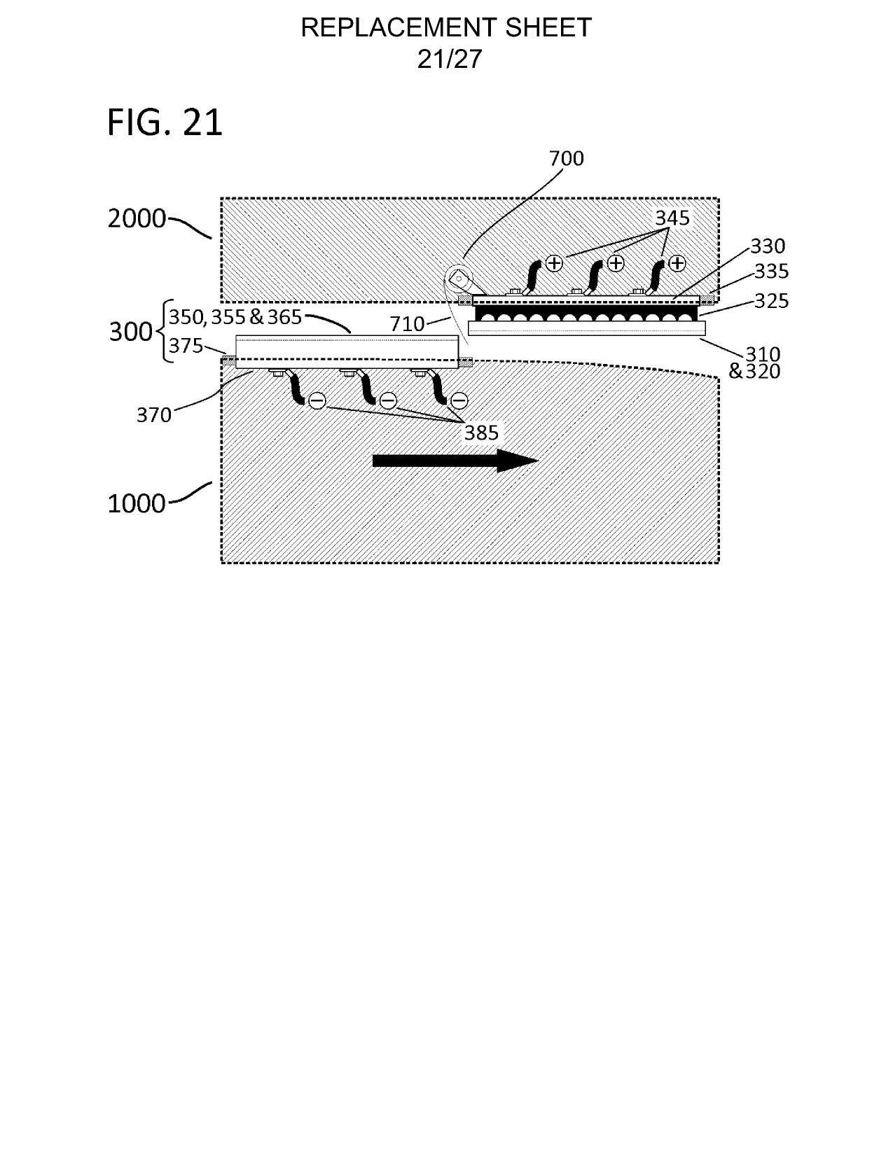

FIG. 21 shows a side view of one of the switches 300 of FIG. 20 as well as an arc initiator or striker 700. Baffles or shields 340 and 380 have been omitted for clarity of illustration. Stationary charging facility 2000 has anode 310 of the runner or rail 320 type. Moving vehicle 1000 has cathode 350 of the shoe or “slider” 355 type. Runner 320 and shoe 355 are depicted approximately equal in length, for artistic convenience, but runner 320 could be many times longer than shoe 355. Bracket 325 for anode runner 320 shows another aspect of thermal isolation anode 310. Bracket 325 is shown formed with cut-outs in the downward support which may reduce the cross-section of material available for thermal conduction. Anode bus 330 is electrically isolated from structures of charging station 2000 by insulator 335. Typical connections 345 with anode bus 330 conduct current to or from external circuits of 2000 which switch 300 serves. Cathode 350 is depicted, for example only and not by way of limitation, as one solid ingot including bracket 365 and bus 370. Such a version of sub-assembly 350, 355, 365 and 370 may be beneficially designed to conduct heat rapidly away from cathode 350. Typical connections 385 with cathode bus 370 conduct current to or from external circuits of 1000 which switch 300 serves. Striker assembly 700 is a preferred implementation of an arc initiator for switch 300. Striker 700 is indicated to be at anode electrical potential. Striker rod or wire 710 short-circuits anode 310 and cathode 350 as cathode 350 moves under anode 310, because wire 710 is arranged to interfere with free passage of or be struck by the relative motion of 310 and 350. When 710 conducts charge flow between 310 and 350, it melts or vaporizes because its cross-sectional area is sized to be unable to carry the electrical current. As described above, the destruction of 710 ignites and establishes an arc according to principles known in the art. Striker 700 may be placed so as to be activated as the two electrodes 310 and 350 first approach or initially overlap each other. Another design choice within the present disclosure is to place the striker at the other end of anode runner 320, so that the striker does not become activated until electrodes 310 and 350 have substantially fully overlapped. Various arrangement exist within the present disclosure, not shown in FIG. 21, to allow a striker or other arc-initiator to trigger switch 300's arc at any degree of electrode overlap. For example, striker rod 710 maybe inserted through a hole or notch in electrode 310. As another example, 700 and 710 may be located as shown in FIG. 21 but 710 be withdrawn from the arc gap and only inserted when desired to short-circuit electrodes 310 and 350. The degree of electrode overlap at which the arc is triggered, that is, the switch is closed, is chosen according to the principle of desirably achieving a broad cross-section of arc column and minimizing the arc voltage. A number of inter-related parameters determine the rate-of-rise of current flow through and the rate of cross-sectional area expansion of the arc plasma. As discussed above, at least a speed of sound in the medium and a speed of arc spot motion on the cathode influence the rate of cross-sectional area expansion of the arc column. If the rate of cross-section expansion is slow and the speed of relative motion of electrodes 310 and 350 is fast, a location of striker 700 similar to shown in FIG. 21 is suitable. If the rate of cross-section expansion is fast and the speed of relative motion of electrodes 310 and 350 is slow, a location of striker 700 at the opposite end of runner 320 from that shown in FIG. 21 may be used. A wide range of intermediate cases may occur, and other parameters such as the total amount of energy to be transferred, the open-circuit voltage of the circuit external to switch 300 and so forth may have a substantial influence on the optimal timing of arc triggering. As mentioned above, the material chosen for striker rod or wire 710 may be the same as the arc-enhancing material distributed within switch 300. Within the present disclosure, striker 700 may alternatively be held at cathode potential rather than anode potential, and multiple strikers or striker configurations with multiple strands 710 may be used. Striker conductor 710 may, in some implementations, be other than solid rod or wire, such as twisted or braided cable, chain, hollow tube, carbon fiber, string or cloth impregnated to render it conductive, a jet or stream of conductive liquid or solution and numerous other forms of substance that may cause dielectric breakdown of the non-contacting arc gap.

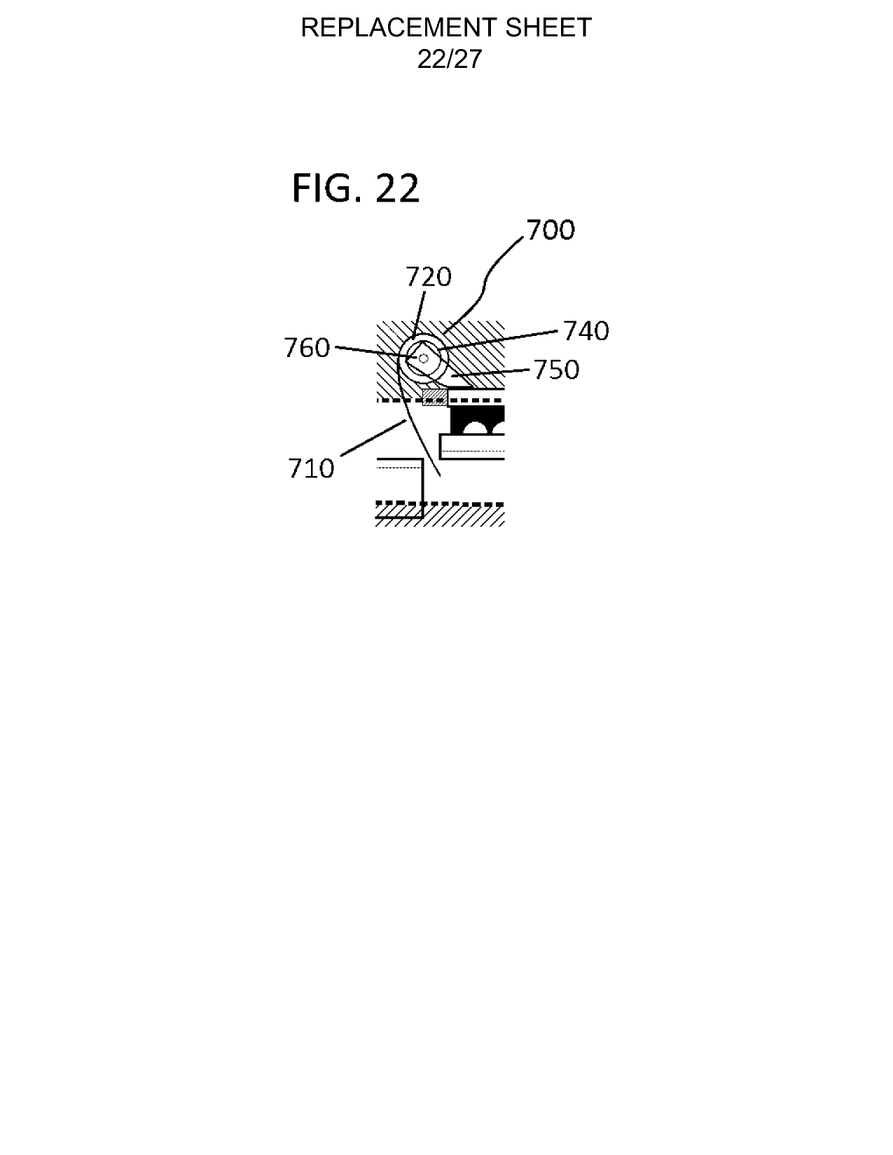

More detail of preferred striker assembly 700 is shown in FIG. 22. A supply of extra striker rod or wire 710 is stored on spool 720. A motor or other type of rotary actuator 740 can be activated by external controls and power source, not shown, to advance rod 710 into the arc gap of switch 300. Striker bracket 750 and connection to axle 760 may be electrically conductive so as to galvanically connect striker conductor 710 to anode, cathode or other electric potential.

An issue for dual-switch 300 charging of one capacitor by another capacitor, as depicted in FIGS. 18, 19 and 20, is the need for simultaneous burning of the arcs of the two switches in the circuit with each pair of capacitors. Two switch poles are required in most applications connecting circuit portions on separate moving platforms into one larger circuit. In topologies similar to those shown in FIGS. 18, 19 and 20, it may not be possible for just one arc to ignite, stabilize and burn at low arc voltage and low plasma impedance, because sustained high arc current is required to support low arc voltage and low plasma impedance, and both switches must be fully conducting in order to close the circuit and allow such high, sustained current to flow. Preferred implementation of striker 700 in FIG. 22 is designed to implement one way of reliably assuring that two arcs in two switches 300 in the same charging circuit get burning at low impedance simultaneously. Though strikers are not shown in FIGS. 18, 19 and 20, according to a method of the present disclosure, each switch 300 may have a striker similar to striker 700 of FIG. 22 and configured similarly as shown in FIG. 21. Then as vehicle 1000 moves its portions of two switches 300 into engagement with charging station 2000's portions of switches 300, it cannot be assumed that the two striker rods 710 may each make contact simultaneously (on a time-tolerance of microseconds) with its opposite-polarity electrode. What happens instead is that one or the other, it does not matter which, first striker rod 710 makes first shorting contact between its local anode and local cathode in first switch 300. This short-circuit contact does not strike an arc but merely loosely clamps the potential of its local anode and local cathode together at one voltage. The entire voltage of the capacitors 2030 and 1030 then appears across the anode-cathode gap of second switch 300. This behavior assumes that all four terminals of capacitors 2030 and 1030 are “floating” or fully electrically isolated and not held in reference to any outside potential. Then, as vehicle 1000 moves farther ahead, eventually second striker rod 710 may collide with and make shorting contact between its local anode and local cathode of second switch 300. At this time, significant current may flow through this second-made short-circuit striker rod 710, and the arc striking process in second switch 300 begins. A short time later, as determined by the resistor-capacitor (RC) time constant formed by the assemblage of capacitors 2030 and 1030, the resistances of their interconnecting conductors and the resistance of second striker rod 710 through which current first began to flow, current may also begin to flow through first striker rod 710 in first switch 300. The time constant given by 1/RC of the circuit is designed to be short enough, and the time taken to melt and destroy (open the circuit of the first striker rod 710) is designed to be long enough so that the two time periods overlap substantially. Thus current may flow through the entire closed circuit including both the first and second striker rods 710. From that point in time, both rods 710 heat up, melt or vaporize, create a drawn arc and trigger a main arc in their respective gaps of their respective switches 300. The time taken to melt and destroy first striker rod 710 may be adjusted by varying the cross-sectional area, the electrical resistivity and/or the thermal mass of both rods 710. According to this method, first striker rod 710 ideally is not destroyed before current begins to flow in second rod 710. It may be understood that straight conductors (no reference numerals) shown connecting capacitors 2030 and 1030 with switches 300 do have inductance, and, if the current drawn by first shorting rod 710 is large, then these inductances may need to be included in an L-R-C time constant calculated for the circuit. More generally and in some implementations, differing methods may be used for continuously or rapidly/repetitively exciting the media in both gaps of both switches 300 so as to get both arcs in both switches established. For example, a 1000 Hz pulsed laser method may be used.

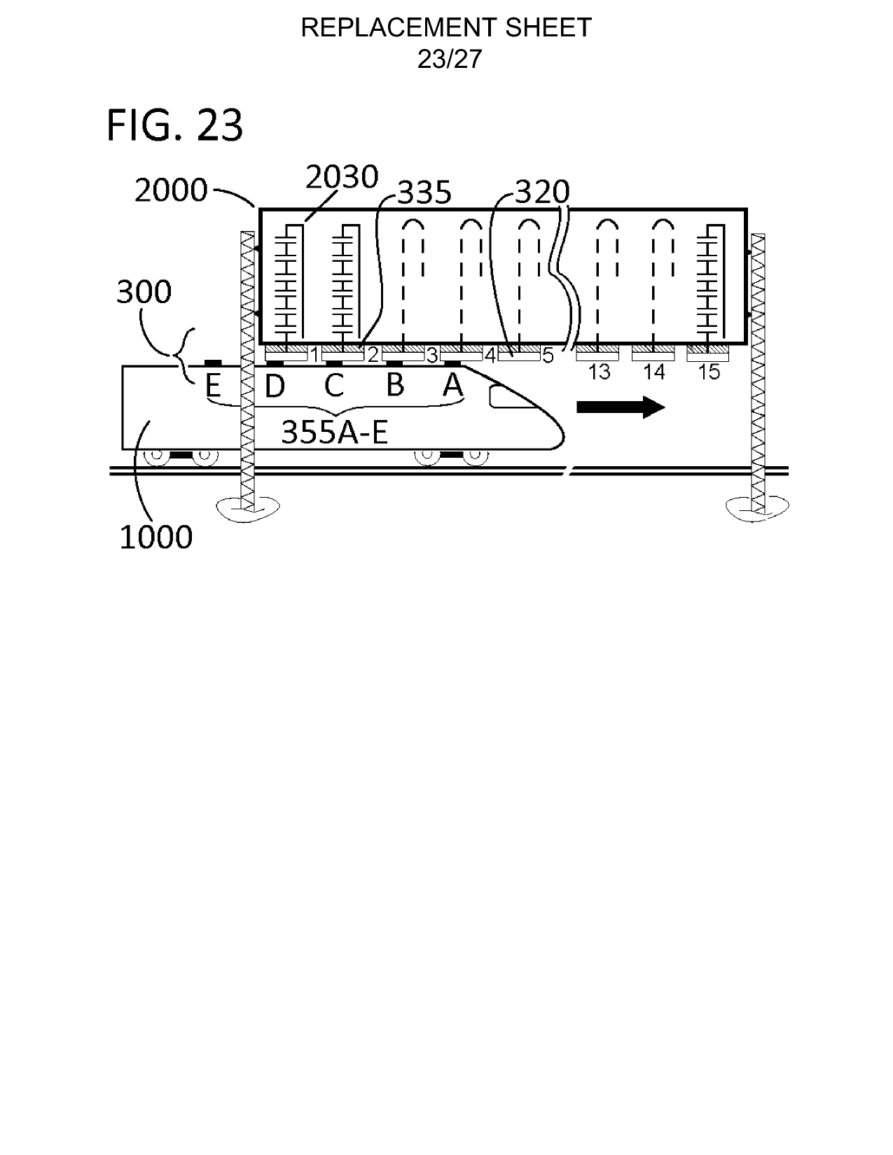

FIG. 23 shows an implementation in which vehicle 1000 is a locomotive of a train. From this side view, only one polarity of switches 300 may be depicted readily, but two poles are required to charge each capacitor bank, indicated by A through E (not shown in FIG. 23 but substantially similar to those depicted in FIG. 19), within locomotive 1000, and this second set of poles may be located behind the depicted switches, as drawn. Multiple anode runners 320, numbered 1 through 15, associated with charging station 2000 may be used to interact or participate in a switch closing event with a single cathode shoe or slider 355. As depicted in FIG. 23, a multiplicity of shoes 355 may also interact with a single runner or a multiplicity of runners 320. In this way, multiple capacitor banks 1030 in locomotive 1000 (not shown in FIG. 23 but substantially similar to those depicted in FIG. 19) may be charged separately. The row of switches 300 disposed on a line along the locomotive's path of motion may be triggered (strikers 700 omitted for clarity in FIG. 23) sequentially and repeatedly every time each shoe 355 is in proximity to any runner 320, which may allow partial transfers of energy in multiple steps and a gradual build-up of a desired charge on capacitors 1030 of locomotive 1000. Alternatively, only selected ones of the row of switches 300 may be triggered when only desired ones of shoes 355 are in proximity to desired ones of runners 320, which may allow variable charging of different capacitor banks A-E within locomotive 1000. As well, this latter method may provide an ability for multiple locomotives 1000 to pass through station 2000 in rapid succession and be charged, each locomotive drawing energy from different banks 1 through 15 or more of capacitors 2030.

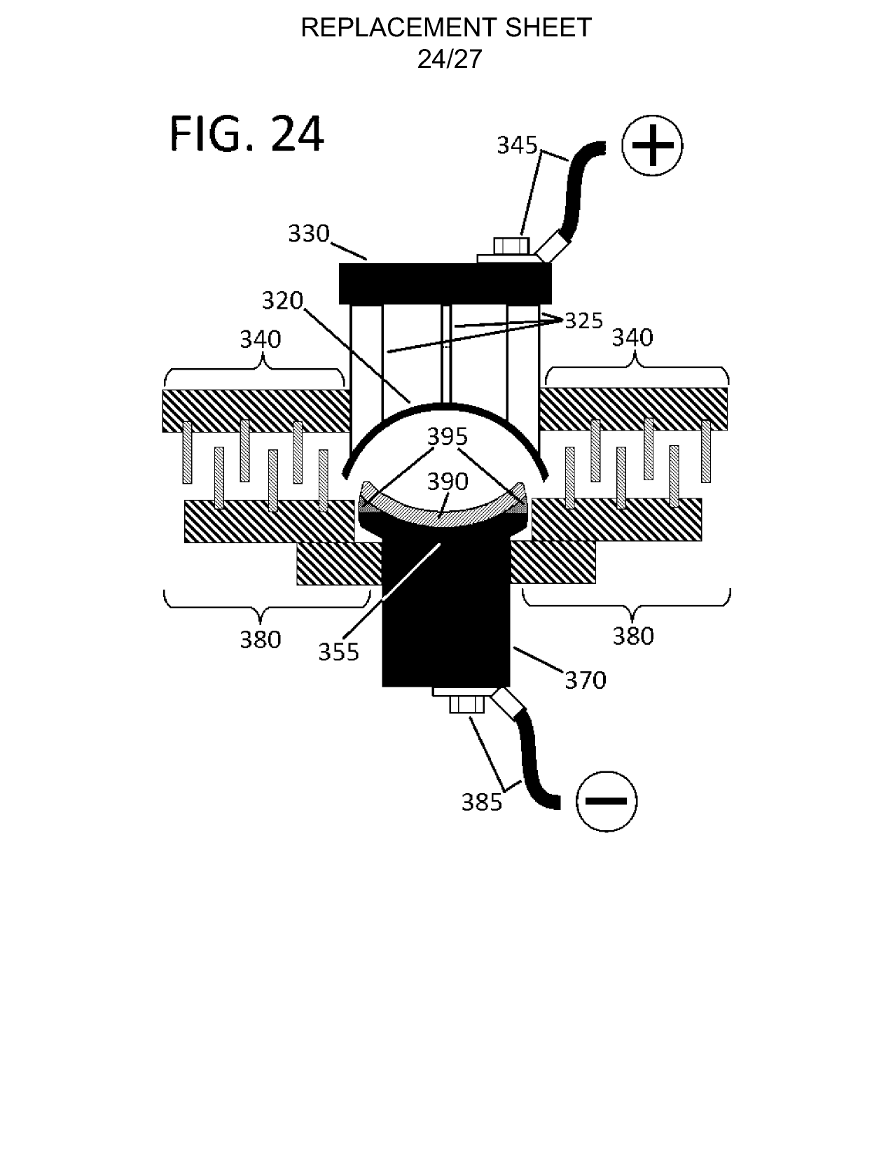

A preferred variant of electrode shapes within switches of the present disclosure may be desirable to transfer large amounts of energy to loads such as locomotives, and such shapes are shown in FIG. 24. A locomotive propelling a high-speed (300 km/hr) train over distances of 100 to 300 km may required approximately 5 GJ of energy. If stored by capacitors charged to 10 kV inside locomotive 1000, 5 GJ of energy requires a charge Q to be placed on the capacitor plates as determined by the formula E_{stored}=½QV, so Q=2E_{stored}/V=1.0×10⁶ C. If charging station 2000 of FIG. 23 is 100 meters long, trains moving at 300 km/hr may have only ˜1 second to charge, that is to transfer 1 MC, so average current may be ˜1 MA. Considerably higher currents may occur during early discharge/charge of each newly switched-in capacitor bank pair. In such cases it is very desirable to expand arc plasma across the largest practicable electrode surface area and to do so quickly (milliseconds), in keeping with principles of the present disclosure to develop maximum breadth of arc column cross-section and hence reduce arc voltage. Examining now the features of arc electrodes in FIG. 24 (which may be representative of similar components shown in FIG. 21), arc-enhancing material 390 is shown as a layer upon the arcing surface of cathode 355, in a state representative of as-manufactured or having sustained few arc burning events. Though not explicitly depicted in other figures, such a layer may be initially present on any or all cathode surfaces of the present disclosure. Anode 320 and cathode 355 in FIG. 24 have a generally concave shape on their arcing surfaces. This means that their outer “wings” or edges are closer together than are central portions of the electrodes, and these may be the locations of strongest initial arcing regardless of where the arc is initiated. Note that it may fall within the scope of the present disclosure to initiate arcs at several locations substantially simultaneously along the length of long electrodes such as shown in FIG. 21, and the arc dynamics discussed here relative to FIG. 24 may still occur. Strong initial arcing on these electrode wings promotes rapid spreading of the arc in both directions along a length of the electrodes. However, the cathode electrode is less well cooled at these wings than in the central portions. It is known in the art of cold-cathode arcing that the arc spots tend to favor and run to cooler surfaces. Possibly this is due to locally higher electrical resistance of the bulk metal of the cathode electrode at higher temperatures. Poorer cooling on the wings of cathode 355 is arranged for by thinner material of the main cathode structure out at the wings, thus giving less cross-sectional area for heat flow, and optionally by changing the material at the wing tips or edges with an insert 395 or alloy variation in the indicated region, material 395 having a lower thermal conductivity than the body of 355. For example, not limiting, 355 may be made of copper and 395 be made of tungsten. Arc-enhancing material 390 may also tend to migrate away from or less preferentially redeposit upon the hotter regions near 395, since low-cohesive-energy materials tend to have low melting points, low boiling points and high vapor pressure, as explained above and in reference to FIG. 7. A hotter anode surface tends to promote dense arc plasma by supplying neutral metal vapor which then becomes ionized, as seen in FIG. 3. Therefore anode 320 is only weakly cooled at its center and more strongly cooled at its wings by variations in the cross-sectional area of anode support brackets 325. Together these design features and physical effects may promote rapid expansion of arc column structures from initial locations near the wings of electrodes 320 and 355 to the longer gap of their central portions. Further, the dual-concave-facing geometry tends to trap heat and confine plasma particles in the gap. More elaborate shield or baffle structures 340 and 380 have a similar effect, though the specific shapes shown are suggestive and not limiting. The remaining components depicted in FIG. 24 have functions corresponding to the like-numbered components in earlier figures herein.

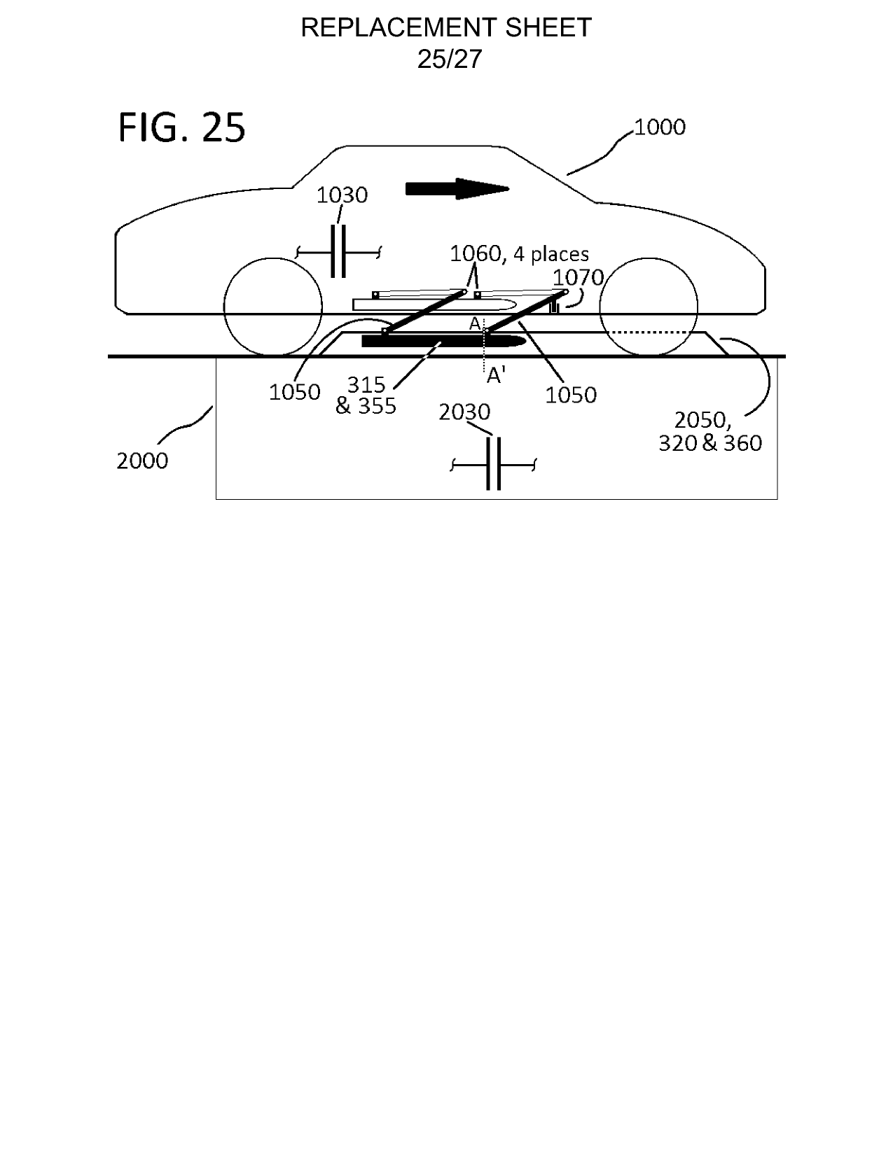

In some implementations, the present disclosure may be applied to other types of vehicles in addition to trains, such as automobiles and utility vehicles, as well as to portable, electric-cable-tethered and battery-operated appliances and tools. The case of the automobile benefits from an alternate implementation that combines anode and cathode runners or rails together and likewise combines anode and cathode shoes or sliders together. Such an arrangement is preferred for compactness and safety, and is feasible since the quantity of energy is considerably smaller than for a locomotive, for example. FIG. 25 depicts a car with such charging apparatus in side view. In addition, the car's charging apparatus is retractable, for ground-clearance and for aesthetics. Car 1000 drives over charging station 2000 at speed by straddling the electrodes of 2000 between its tires. As with other implementations, car 1000 contains capacitors 1030 for energy storage and station 2000 has at least one capacitor bank 2030 charged to an appropriate level for the approaching car 1000. Combined anode/cathode shoe 315/355 of car 1000 is normally tucked underneath the car's lower surfaces (position depicted in outline) but is lowered by swinging brackets or arms 1050 hinged on pivots 1060. The lowered position (depicted in solid color) interacts with station 2000's combined anode/cathode runner 320/360. Spring 1070 neutralizes the gravitational effect on the mass of shoe 315/355, as well as applies a small, constant upward force during charging. Clearly, sufficient sensors and controls are needed in order to lower runner 315/355 appropriately and align it closely enough with runner 320/360. These are a matter of design choice and not part of the present disclosure. Likewise, the details of mechanisms to raise, lower, stow and spring-load shoe 315/355 are design choices, as are many details of charging station 2000, guide structure 2050 and runner 320/360.

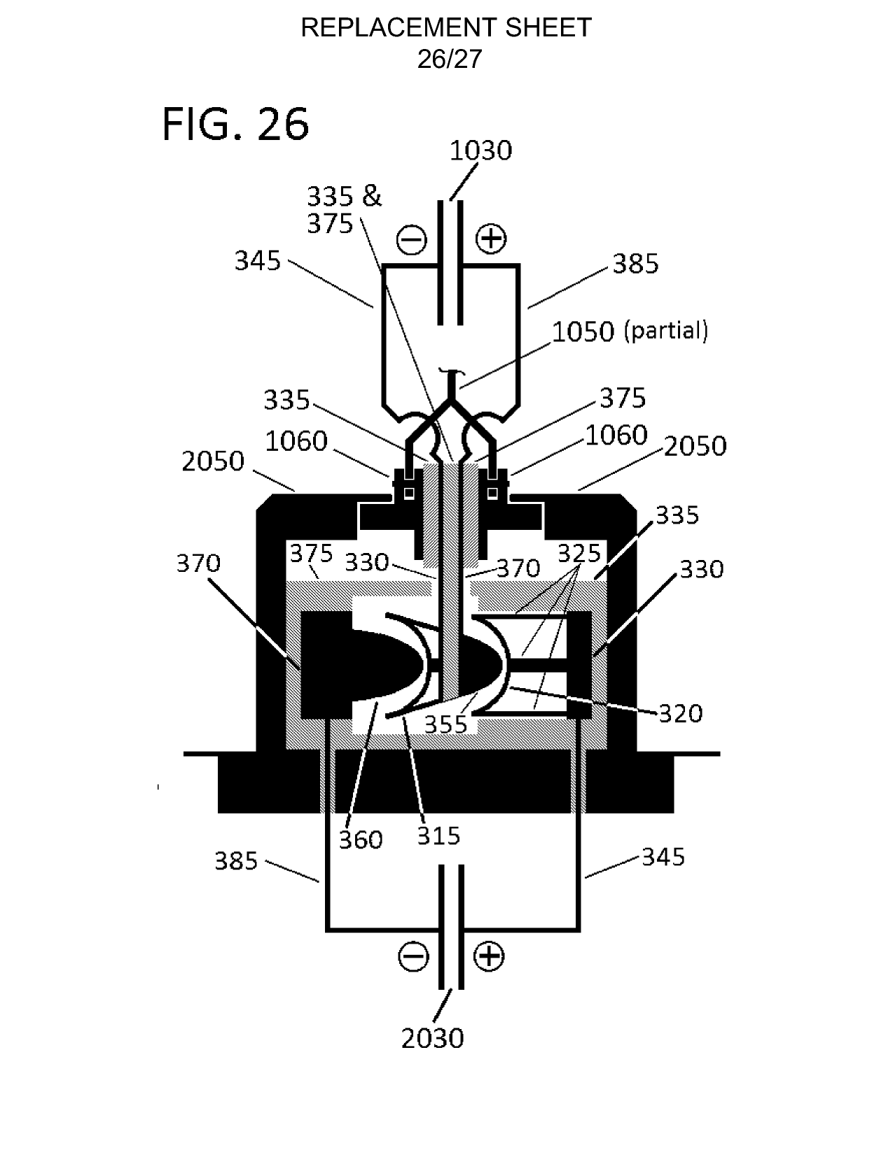

Section A-A′ of FIG. 25 is shown in FIG. 26 and depicts disclosure-relevant details. Seen in cross-section, guide structure 2050 houses fixed cathode runner 360, with its electrical bus 370, and fixed anode runner 320, with its brackets 325 and electrical bus 330. Electrical insulators 335 and 375 isolate these electrodes from 2050, which may be at “ground” or earth potential for safety. Station capacitor bank 2030 is depicted in electrical schematic with electrical isolation and properly polarized connections 345 and 385, only, and without indication of mechanical detail. From car 1000 a portion of bracket 1050 is shown, with split yoke, connected to pivots associated with two-piece lower hinge 1060. By alignment and feed-in structures at the entrance to guide structure 2050 (not shown), features on the sides of hinge 1060 engage under over-hanging lips on 2050, held up against the underside of said lips by spring 1070 shown in FIG. 25. It is proposed that at least two such engagements between one or more hinge 1060 and guide 2050 are present and spaced appropriately along the length of the combined anode/cathode shoe structure, as indicated in FIG. 25. Rollers, low-friction bearing surfaces or other means allow hinge 1060 to slide smoothly along 2050 in an appropriate alignment and guide slot or feature. As with other implementations, the electrodes of this alternate implementation of the present disclosure provide satisfactory electrical arcing performance even if substantial misalignment is present, even tolerating occasional, brief colliding of electrodes. Hanging from hinge 1060 is the assembly comprising combined anode/cathode shoe 315/355. Anode electrical bus 330 and cathode electrical bus 370 also serve as primary support plates. These are electrically isolated from hinge 1060 by anode insulator 335 and cathode insulator 375. Bus and support plates 330 and 370 are isolated from each other by one or more insulators “335 & 375”. Anode shoe electrode 315 is rigidly and electrically connected to bus and support plate 330 while cathode shoe electrode 355 is rigidly and electrically connected to bus and support plate 370. Held thus in mutual proximity, the two pairs of electrodes, 315/360 and 320/355, function much as described with reference to FIGS. 19, 20 and 21 above. Ignition of arcing substantially simultaneously in the two gaps of 315/360 and 320/355 can be performed by two fed wires associated with station 2000, similarly as described with reference to FIG. 22 (not shown) or by other means discussed above. Car capacitor bank 1030 is depicted in electrical schematic with electrical isolation and properly polarized connections 345 and 385, only, and without indication of mechanical detail. Note that connections 345 and 385 need not at all mechanically interfere with bracket 1050, as implied in FIG. 26, since these connections can be made elsewhere along the length of shoe 315/355 assembly.

Additional aspects of the disclosure may include apparatus and methods advantageous for alternating current (AC) circuits. These aspects can be added to or combined with other implementations or instantiations of the disclosure disclosed elsewhere herein. Each phase of an AC circuit has periodic-in-time “zero-crossings” of both the current and voltage signals, whereat each of these signals reverse direction or polarity. Circuits having non-unity power factor may exhibit a (variable) phase angle difference between voltage and current zeroes at an arc gap. During zero-crossings, an arc may extinguish. If the arc remains extinguished, the current shunt and voltage clamping function of an arc conductor may be lost. Even if the arc reignited after the circuit comes out of zero-crossing, potentially severe arc pulsation may occur related to arc extinguishing (“chopping”) and re-ignition, and this may cause conducted, radiated or induced electrical noise, if not direct damage, in other circuit elements. These problems are solved according to AC aspects of the disclosure described below. Another concern is arc ignition when there may be zero-crossing, whereby no arc may strike or establish into a full arc. An arc may be struck when there is at least about 20 volts across an arc gap, not at a zero-crossing. While it may be possible to practice the disclosure by detecting a zero-crossing and igniting the arc at a desired phase angle away from the zero-crossing time, this is not considered necessary. A first example reason it is not necessary is that a byproduct of using arc-enhancing materials, as identified above, is ease of, and wide parameter latitude (range) for, arc ignition and propagation. A second example reason it is not necessary pertains to the preferred mechanical striking of arcs in one or more previously discussed implementations. The mechanical striking means may be used for re-supply of arc-enhancing material or because mechanical motion may be required anyway to break an arc once burning. These mechanical striking means are also able to linger through a zero-crossing of even the slowest standard AC frequency, 50 Hz→10 ms between zero-crossings, and draw power from the external circuit to get an arc started.

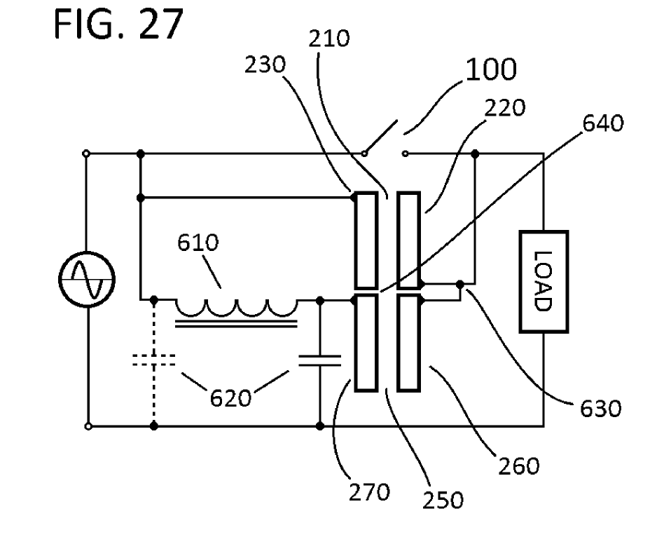

Referring now to FIG. 27, arc electrodes and their arc gaps are symbolized by stylized open rectangles and whitespace between them, as in FIG. 16, but these represent electrode and gap implementations discussed relative to FIG. 8, FIG. 11 and elsewhere herein. Keeping an arc burning smoothly through zero-crossings of an AC circuit may be accomplished by sending a first, main portion of an AC current signal from an AC power source through a first, main arc gap 210 of arc electrodes 220 and 2030, much as disclosed above herein. A second, minor portion of the AC current signal is tapped off from the same AC source and acted upon by a phase shift network comprising, for example, inductor 610 and capacitor(s) 620, before being sent through a second, minor arc gap 250 of arc electrodes 260 and 270. Load-side arc electrodes 220 and 260 may be electrically joined at junction 630 away from the arc electrode components or may include a single combined electrode. In some implementations, first arc gap 210 and second arc gap 250 are positioned in arc-transfer spatial proximity to one another. As explained below, this means that at least electrons, ions and neutral metal vapor from an arc plasma burning in either arc gap may migrate into the other arc gap. The second, minor portion of the AC signal acted upon by the phase shift network provides a voltage across second arc gap 250 that is out of phase by a selected phase angle relative to the voltage across first arc gap 210. A preferred phase angle is +90° for the minor arc gap ahead of the main arc gap, though a wide range of phase differences may work. In this way, as main arc gap 210 is emerging from its zero-crossing of voltage, minor gap 250 is in full conduction at the same gap electrode polarity, and arc transfer to reignite the main gap's arc is smoothly achieved. Similarly, the arc in main gap 210 reignites an arc in minor gap 250 as the minor gap comes out of zero-crossing, albeit while the two electrode sets are at opposite polarity. This is not a problem, as explained below. The second, minor AC signal need only be enough to sustain an arc under the lowest-energy desired conduction conditions. In practice, this means providing a minimum sustainable current I_{arc,min}, such as 10 A, for I_{arc}(t) during ranges of “t” values corresponding the desired range of phase angles of the AC cycle. To a first approximation, whenever I_{arc}(t)<I_{arc,min} in either arc gap, the arc in that gap may self-extinguish. If the second, minor portion of current is small relative to the first, main portion of the AC signal, then when the two split AC signals are recombined at 630 before passing to a load portion of the circuit, the two phases sum together to produce a phase shift of only a few degrees from the phase angle that the unshifted first, main portion of the AC signal may have had. The smallness of this phase shift is beneficial to the load in the external circuit, which upon arc-assisted switch-closing may have been powered by the slightly phase-shifted current through the arc gaps but upon closing of switch 100 may be powered by the unshifted phase of the AC source.

Arc transfer between arc gaps 210 and 250 is arranged, according to principles of the disclosure, by placing active arc electrodes 230 and 270 close together at gap 640. By active arc electrodes are meant the two electrodes not shorted together, 230 and 270 in FIG. 27, and which are thus at different phases, or phase-shifted off of the original phase of the AC power source. The length of gap 640 is chosen to everywhere be less than sufficient for sustaining cold-cathode arcing in gap 640. Such arcing may occur due to the instantaneous voltage difference across gap 640 due to the phase difference on 230 versus 270. An arc in gap 640 may partially short-circuit the AC source without providing any current to the load, so it may be detrimental. By placing arc electrodes 230 and 270 close together, cathode-spot-mediated arcing may not occur because a certain distance of arcing medium is needed above the arc cathode for set-up and functioning of cathode spot jets of atoms and ions, a cathode plasma sheath, a pre-sheath ionization zone and proper establishment of an anode plasma column. Distances of 0.1 to 1.5 mm are usually small enough to prevent most arcing in a gap like 640, but smaller distances may be even more effective at preventing occasional stray arc spots, if practical. Even though active arc electrodes 230 and 270 are each able to maintain their own independent arc gap at different instantaneous circuit-applied voltages, those skilled in the art may understand that there may be a tendency for all of the arc power to be routed through the arc gap presenting the lowest instantaneous plasma impedance to the upstream power network. The concern is that the arc in the stronger-burning gap may withdraw all of the plasma from the weaker-burning gap, and when the stronger-burning gap goes through its zero-crossing, all plasma may extinguish and that may be the end of conduction. This is overcome in the disclosure, firstly by use of arc-enhancing materials, which reduces or “collapses” this tendency; that is, both gaps are capable of sustaining an arc at very low V_{arc}, so any differences between the impedances of the two gaps is likewise reduced. Secondly, the curved electrodes and smoothly varying arc gap lengths of the disclosure provide a low-impedance location for the weaker (lower I_{arc}) arc to burn in its own arc gap, that is, at the location of shortest gap length. There may be a higher resultant impedance if the weaker arc burning in its short gap were to extinguish and add its electrical power to the stronger arc burning in the other gap, because at the higher currents burning in the stronger arc, any new current may have to added at a location of longer gap length. Thus, the short-gap regions of both arc gaps may tend to fill with plasma first before adding more current to one gap exclusively. Of course, this is not always possible because each gap in turn may go through its zero-crossing, but because of this short-gap-burning provision, and an ability to transfer plasma from short-gap to short-gap, at least a portion of the arc may hop back and forth between the two gaps. As discussed relative to FIG. 8B, due to the gradually varying arc gap length, a plasma filling of the gap is orderly, and when minimum arc current is present, it may tend to travel through a smaller cross-sectional-area arc plasma column substantially centered at (or at least including) the location of minimum gap length. So as the phase voltage in the stronger-burning arc gap reduces and approaches the zero-crossing, the arc current may decrease and the plasma column in that gap may contract into, for example, the apex region of the gap depicted in FIG. 8, where the gap length is shortest. According to the disclosure, this apex region (shortest-gap region) is placed adjacent to the apex region (shortest-gap region) of the other arc gap, separated only by small (non-arcing) gap 640.

Some implementations, without limitation, may be used by taking either electrode in FIG. 8 and sawing it in half, all the way through, wherein the plane of cut is parallel to the principal axis of the parabola and includes it. Then the two halves are re-assembled with insulators between them to define a (non-arcing) gap 640 of 1 mm distance and to form substantially the same shape, in outline, as before the saw cut. The assembled halves are each fitted with a terminal and connection to the external circuit, and mated and mounted with the other (un-cut) arc electrode substantially as depicted in FIG. 8A, in outline. In some implementations, the split electrode need not be cut precisely in half but could be cut into ¾ and ¼ sections as viewed looking along the principal axis of the parabola. From this perspective, the sections may appear, in projection, as slices of a round pie with wedge-like pie sections defined by cuts radiating from the center. In other words, the saw cuts in three dimensional (r, θ, z) coordinates are parallel to the principal axis of the parabola (z-axis) and include it but do not go all the way through; the two saw cuts to make ¾ and ¼ sections could be at θ=0° and θ=90° all the way from large “r” to “r”=0, that is, to the z-axis. Then these ¾ and ¼ sections are re-assembled with insulators between them to define a (non-arcing) gap 640 of 1 mm distance and to form substantially the same shape, in outline, as before the saw cuts. The assembled sections are each fitted with a terminal and connection to the external circuit, and mated and mounted with the other (un-cut) arc electrode substantially as depicted in FIG. 8A, in outline. As a matter of design choice, other section ratios besides ½:½ and ¾:¼ of the total 360° of the θ range could be chosen. Some implementations may be realized with elongated electrodes of other implementations discussed above. For example, without limitation, beginning with a configuration as depicted in FIG. 11B, with electrodes 220 and 230 having their apex lines not parallel but canted at a slight angle. Note that the angle depicted in FIG. 11B has been exaggerated for artistic clarity. Top electrode 220, as drawn, may be cut in half lengths near its center-of-length. The cuts are not 90°, that is, perpendicular to the length, but may be one cut of +89.5° and another cut of −89.5°, or at a slight bevel, with the longest remaining lengths being along the apex lines. These cut ends are re-assembled with insulators between them to define a (non-arcing) gap 640 of 1 mm distance. When this dual electrode is placed back in the trough of electrode 230, the locations of shortest gap length may be at the cut-and-rejoined ends, while the uncut ends may have the longest gap length to electrode 230's surface. By analogy with the angle-sections of the dual electrode from modification of the configuration of FIG. 8, the ½:½ length ratio could be ¾:¼ or other ratio. When split-electrode arc gaps of the disclosure are constructed according to the prescriptions above, and in like manner for other electrode shapes, arc transfer between neighboring gaps 210 and 250 may be quite facile. For example, in the implementation of an AC apparatus based upon sawing and reassembling of electrode sections similar to those of FIG. 8, the arc gap is 8 mm and longer lengths, while the arc transfer gap 640 is 1 mm. Copious spill-over of plasma and vapor from one arc gap to the other practically cannot be stopped, since it has the almost 8 mm long anode plasma column to supply such spill-over. The anode plasma column is relatively quiescent and at near anode potential. Especially when the neighboring gap is near its zero-crossing potentials, there is nothing to stop ambipolar diffusion of plasma into the other gap. Indeed, as discussed in the previous paragraph, the problem is the opposite one: how to keep one arc gap from “stealing” all of the plasma from the other one.

In operation, some implementations, with either parabolic or elongated electrode configuration, or other electrode shape, as constructed using the prescription above, may be energized in a single-phase AC circuit similar to that depicted in FIG. 27. Selection of proposed inductor 610 and capacitor(s) 620 may be driven by economic considerations. Above, it was proposed that one, non-phase-shifted leg of the AC input power carry most of the current, while the phase-shifted leg carry a minor amount of the current. Splitting the current equally between the two legs may be a reasonable and conservative way to practice the disclosure, but in circuits carrying high currents, components 610 and 620 may become disadvantageously heavy, large and/or expensive. Therefore it was proposed to calculate inductance and capacitance values for the components 610, 620 and any others desired, to partition only enough current portion through minor arc gap 250 to maintain conduction over a reasonably complete range of phase angles. This calculation takes into account the reactance values of the source and load in the circuit and therefore any phase difference between voltage and current signals in the arc conductor(s). The arc gaps may be treated as purely resistive (according to FIG. 4) until magnetic effects become important at currents>1,000 A. Magnetic effects may be unimportant to currents much larger than 10,000 A, as described. In deciding how to split the AC current between the arc gaps 210 and 250, the relative arc electrode surface area of the two gaps may be adjusted in the same proportion as the current splitting between the gaps, which may tend to give similar extents of plasma filling (in the sense of FIG. 8B) of the two arc gaps. The relative electrode surface areas may be set by the fabrication prescriptions given above. Similar extents of gap filling is not a prerequisite, but it may aid with heat spreading balance, economic use of materials and other considerations. As stated above, another consideration is net phase shift introduced into the summed output current signal to the load. A smaller portion of the current passing through the phase-shifted leg of the circuit of FIG. 27 gives a smaller resultant shift. Thus using orderly gap filling, the possible desires to optimize utilization of and heat distribution in electrode assembly materials and to minimize phase shift at the load may be to some extent both met.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. An apparatus comprising:
a first electrode and a second electrode, wherein the first and second electrode are configured to support an arc that conducts electric current between the first and second electrode; and
a shape of at least one of the first and second electrode, wherein the shape at least one of the first and second electrode is configured to, after an arc is established between the first and second electrode, expand at least one of an arc footprint of the arc on at least one of the first and second electrode and an arc column of the arc between the first and second electrode as the electric current between the first and second electrode increases.

2. The apparatus of claim 1 wherein the arc includes at least one of a non-thermionic cathode arc, a cold-cathode arc, a metal vapor arc, a cathodic arc, and an arc including at least 10% of atoms and ions originating from at least one of the first and second electrode.

3. The apparatus of claim 1 further comprising an arc gap between the first and second electrode, wherein the arc gap includes a location at which a length of the arc gap is shortest.

4. The apparatus of claim 1 wherein the shape of at least one of the first and second electrode is further configured to decrease a self-current magnetic constriction of the arc column.

5. The apparatus of claim 4 wherein the shape of at least one of the first and second electrode is further configured to change shape in one or more regions to modify a degree of the self-current magnetic constriction of the arc column.

6. The apparatus of claim 1 wherein the shape of at least one of the first and second electrode is further configured to contract the arc footprint of the arc and the arc column as the electric current between the first and second electrode decreases.

7. The apparatus of claim 1 further comprising an arc gap between the first and second electrode, wherein the arc gap between the first and second electrode includes the arc column, and wherein the arc column is at least one of completely-filled and densely-filled with plasma after the expansion of the arc footprint and the arc column.

8. The apparatus of claim 1 further comprising an arc gap between the first and second electrode, wherein the arc gap between the first and second electrode includes the arc column, and wherein the expanding arc footprint and arc column move within the arc gap and create one or more regions which formerly had plasma and then lack plasma, and within which the arc is no longer burning.

9. The apparatus of claim 8 wherein the electric current between the first and second electrode is configured to decrease towards zero in response to the moving arc column being expelled from the arc gap.

10. The apparatus of claim 1 wherein at least one of the first and second electrode is further configured to move within a predetermined proximity relative to one another to conduct electric current.

11. The apparatus of claim 1 wherein a position of at least one of the first and second electrode is fixed.

12. The apparatus of claim 1 wherein at least one of the first and second electrode includes an arc-enhancing material.

13. The apparatus of claim 12 wherein the arc-enhancing material is configured to burn one or more arc spots in one or more predetermined locations.

14. The apparatus of claim 12 wherein the shape of at least one of the first and second electrode is further configured to collect at least a first portion of the arc-enhancing material when vaporized, and further configured to re-apply at least a second portion of the arc-enhancing material back to at least one of the first and second electrode.

15. The apparatus of claim 12 further comprising at least one of an arc striker and an arc igniter configured to replenish the arc-enhancing material.

16. The apparatus of claim 1 further comprising one or more structures configured to at least one of limit influence of atmospheric air upon the arc, capture an arc burning material when vaporized, retain heat from arc discharge, shield one or more surroundings of the arc from gases and radiation generated from the arc, reduce acoustic noise from the arc, and quench arc plasma in response to the expanding arc column when the expanding arc column expels from the arc gap.

17. The apparatus of claim 1 further comprising one or more design parameters configured to adjust a rate-of-rise of the electric current between the first and second electrode after the arc is established between the first and second electrode.

18. The apparatus of claim 1 wherein the shape of least one of the first and second electrode is further configured to define an arc gap, at least in part, as including a ratio of an area of at least one of the first and second electrode to an average arc gap distance.

19. The apparatus of claim 1 wherein the shape of at least one of the first and second electrode, after the arc is established between the first and second electrode, is further configured to provide a voltage between the first and second electrode of less than or equal to 50 volts, when time-averaged over a period of time.

20. The apparatus of claim 1 wherein the shape of at least one of the first and second electrode is further configured to sustain continuously over a period of time, after the arc is established between the first and second electrode, the expansion of the arc footprint and arc column, wherein the expansion of the arc footprint and arc column excludes at least one of pulsation to zero current, chopping, flicker to zero current, spark instability, plasma extinction and re-ignition, fluctuation to zero current and any time-domain instability of the arc involving the electrical current between the first and second electrode becoming zero.

21. The apparatus of claim 1 wherein the shape of at least one of the first and second electrode is further configured to sustain continuously over a period of time, after the arc is established between the first and second electrode, contraction of the arc footprint and arc column, wherein the contraction of the arc footprint and arc column excludes at least one of pulsation to zero current, chopping, flicker to zero current, spark instability, plasma extinction and re-ignition, fluctuation to zero current and any time-domain instability of the arc involving the electrical current between the first and second electrode becoming zero.

22. The apparatus of claim 1 wherein the expansion includes at least one arc front of the arc column that propagates from a location of arc ignition in at least one direction into the arc gap and away from the location of arc ignition.

23. The apparatus of claim 1 further comprising an arc gap between the first and second electrode, wherein a length of the arc gap is shortest near a location of arc ignition and the length increases with lateral distance away from the location of arc ignition.

24. The apparatus of claim 17 wherein the design parameter of at least one of the first and second electrode includes an arc-enhancing material.

25. The apparatus of claim 1 wherein the shape of at least one of the first and second electrode is defined, at least in part, by an area of at least one of the first and second electrode upon which at least one of the first and second electrode supports the footprint of the arc column, wherein the area determines a maximum arc current of the electric current between the first and second electrode that at least one of the first and second electrode supports, and wherein the maximum arc current is determined, at least in part, by a ratio of the arc current to the area, wherein the ratio of the arc current to the area includes the arc current density Φ_{arc}.

26. The apparatus of claim 25 wherein the value of Φ_{arc} is adjusted by a design parameter of at least one of the first and second electrode, wherein the design parameter of at least one of the first and second electrode includes an arc-enhancing material.

27. The apparatus of claim 19 wherein the voltage between the first and second electrode is configured to decrease, at least in part, based upon a design parameter of at least one of the first and second electrode, wherein the design parameter of at least one of the first and second electrode includes an arc-enhancing material.

28. The apparatus of claim 12 wherein the arc enhancing material includes at least one of Mg, Se, Zn, Cd, In, Sn, Sb, Sm, Yb, Pb, Bi, Li, Na, K, Rb, and Cs.
